(19) United States
(12) Patent Application Publication
(10) Pub. No.: US 2022/0290031 A1
(43) Pub. Date: Sep. 15, 2022

(54) AQUEOUS FOAM COMPOSITIONS AND METHODS OF MAKING AND USING THEREOF

(71) Applicant: Chevron U.S.A. Inc., San Ramon, CA (US)

(72) Inventors: Ruth Ellen HAHN, San Ramon, CA (US); Varadarajan DWARAKANATH, San Ramon, CA (US); Kerry SPILKER, San Ramon, CA (US); Gregory A. WINSLOW, San Ramon, CA (US); Sophany THACH, San Ramon, CA (US); Gayani W. PINNAWALA, San Ramon, CA (US); Christopher GRIFFITH, San Ramon, CA (US); Harold Charles LINNEMEYER, San Ramon, CA (US); Robert Neil TROTTER, San Ramon, CA (US)

(21) Appl. No.: 17/635,222

(22) PCT Filed: Aug. 14, 2020
(86) PCT No.: PCT/US2020/046519

§ 371 Date: Feb. 14, 2022

Related U.S. Application Data
(60) Provisional application No. 62/887,578, filed on Aug. 15, 2019.
(60) Provisional application No. 62/984,202, filed on Mar. 2, 2020.

(51) Int. Cl. C09K 8/38; C09K 8/60; C09K 8/94; C09K 8/584

(52) U.S. Cl. CPC C09K 8/38; C09K 8/602; C09K 8/94; C09K 8/584

(57) ABSTRACT

Described herein are aqueous based foams for use in drilling operations. The foams can be used in below bubble point drilling operations to control the migration of reservoir gases (e.g., hydrogen sulfide) to the surface.

### CROSS-REFERENCE TO RELATED APPLICATIONS

This application claims the benefit of priority to 62/984,202 filed Mar. 2, 2020 and 62/887,578 filed Aug. 15, 2019, each of which is incorporated by reference in its entirety.

### BACKGROUND

To produce hydrocarbons from a subterranean formation, a drill string is typically used to drill a wellbore of a first depth into the formation. The drill string includes a tubular body having a drill bit attached to its lower end for drilling the hole into the formation to form the wellbore. Perforations are located through the drill bit to allow fluid flow therethrough.

During drilling, drilling fluid is circulated through the drill string, out through the perforations, and up through an annulus between the outer diameter of the drill string and a wall of the wellbore. Circulation of the drilling fluid within the wellbore can form a path within the formation for the drill string, wash cuttings obtained from the earth due to drilling to the surface, and cool the drill bit.

After the wellbore is drilled to the desired depth by the drill string, the drill string is removed from the wellbore. Sections or strings of casing are then inserted into the wellbore to line the wellbore. The casing is typically set within the wellbore by flowing cement into the annulus between the outer diameter of the casing and the wall of the wellbore. The drill string can then be lowered through the casing and into the formation to drill the wellbore to a second depth, and an additional section or string of casing is lowered into the wellbore and set therein. The wellbore is drilled to increasing depths and additional casings set therein to the desired depth of the wellbore.

During the drilling and casing process, it is important to control the pressure within the wellbore with respect to the pressure within the subterranean formation. A well is balanced when wellbore pressure is equal to the pressure within the subterranean formation. Problems can result when a well becomes significantly underbalanced (i.e., when the pressure within the subterranean formation becomes significantly greater than the wellbore pressure) or significantly overbalanced (i.e., when the pressure within the subterranean formation becomes significantly less than the wellbore pressure). There is a need to effectively and dynamically control pressure within the wellbore during drilling operations.

### SUMMARY

Described herein are aqueous foam precursor compositions. The aqueous foam precursor compositions can comprise a single-phase aqueous solution which can form an aqueous based foam upon combination with an expansion gas. The resulting foams can be stable for extended periods of time (e.g., at least 12 hours). In some embodiments, the resulting foams can be stable for extended periods of time (e.g., at least 12 hours) at elevated temperature (e.g., temperatures of at least 85° C., such as temperatures of 120° C.), elevated pressures (e.g., pressures of at least 1500 psi), in the presence of hydrogen sulfide (e.g., in the presence of 17 mol % of H₂S), or any combination thereof.

The foams provided herein can be used in oil and gas operations, including drilling operations. For example, the foams can be used in below bubble point drilling operations to control the migration of reservoir gases (e.g., hydrogen sulfide, methane, carbon dioxide, or any combination thereof) to the surface.

Additional advantages of the disclosed compositions, systems, and methods will be set forth in part in the description which follows, and in part will be obvious from the description. The advantages of the disclosed compositions, systems, and methods will be realized and attained by means of the elements and combinations particularly pointed out in the appended claims. It is to be understood that both the foregoing general description and the following detailed description are exemplary and explanatory only and are not restrictive of the disclosed compositions, systems, and methods, as claimed.

The details of one of more embodiments of the invention are set forth in the accompanying drawings and description below. Other features, objects, and advantages of the invention will be apparent form the description and drawings, and from the claims.

### BRIEF DESCRIPTION OF THE FIGURES

The accompanying figures, which are incorporated in and constitute a part of this specification, illustrate several aspects of the disclosure, and together with the description, serve to explain the principles of the disclosure.

FIG. 1. Photograph of various surfactants tested for stability for 7 days with 17% H₂S at 120° C.

FIG. 2. Photographs of cetyl betaine before testing (left), after aging for 7 days with 17% H₂S at 120° C. (middle), and after degassing (right).

FIG. 3. Photographs of a Cocoamidopropyl betaine before testing (left), after aging for 7 days with 17% H₂S at 120° C. (middle), and after degassing (right).

FIG. 4. HPLC data for AEC and disulfonate mixture with H₂S at 120° C. after 7 days relative to a control sample.

FIG. 5. HPLC data for AEC and disulfonate mixture at room temperature and at 120° C. after 5 months.

FIG. 6. HPLC for disulfonate at room temperature, at 120°, and with H₂S at 120° C.

FIG. 7. HPLC for IOS with H₂S exposure for 7 days at 120° C. compared to room temperature control.

FIG. 8. HPLC data for IOS at room temperature and 120° C. after 5 months.

FIG. 9. HPLC data for AOS with H₂S at 120° C.

FIG. 10. HPLC data for AOS at room temperature and 120° C. after 5 months.

FIG. 11. HPLC data for the branched ethoxylated alcohol with H₂S for 7 days at 120° C. relative to the control at room temperature.

FIG. 12. HPLC data for the branched ethoxylated alcohol at 120° C. for 5 months with no H₂S relative to the control at room temperature.

FIG. 13. HPLC data for the linear ethoxylated alcohol with H₂S for 7 days at 120° C. relative to the control at room temperature.

FIG. 14. A photograph of a foam at its initial height (h₀).

FIG. 15. A photograph of a foam with liquid drainage.

FIG. 16. Foam stability as a function of time for foam formulations with various anionic surfactants (S1-S6).

FIG. 17. Foam stability as a function of time for foam formulations with varying nonionic surfactants.

FIG. 18. Effect of solution viscosity on foam stability. The solution viscosity was increased by adding more polymer. Experiments were performed at ambient conditions.

FIG. 19. Foam stability as a function of time when varying fluorinated surfactants were added to a formulation including nonionic surfactant SA. Experiments were performed at ambient conditions.

FIG. 20. Foam stability as a function of time for foam formulations with bentonite added. Experiments were performed at ambient conditions.

FIG. 21. Photographs of a foam over time (increasing time left to right) showing increased drainage over time.

FIG. 22. Photographs of a foam over time (increasing time left to right) showing foam collapse over time. The experiments were performed at 5000 psi.

FIG. 23. Foam stability as a function of time for foam formulations including biopolymer at varying pressures. All experiments were performed at 85° C., except the 25° C. baseline sample.

FIG. 24. Foam stability as a function of pressure for foam formulations at 85° C.

FIG. 25. Foam stability as a function of time for foam formulations without biopolymer at varying pressures. All experiments were performed at 85° C., except the 25° C. baseline sample.

FIG. 26. Foam stability as a function of time for foam formulations at varying biopolymer concentrations. All experiments were performed at 85° C. and 1500 psi.

FIG. 27. Foam stability as a function of pressure for foam formulations at varying biopolymer concentrations at 85° C.

FIG. 28. Foam stability as a function of time for foam formulations including different fluorinated surfactant at 85° C. and 3500 psi.

FIG. 29. Foam stability as a function of time for foam formulations including different concentrations of a fluorinated surfactant at 110° C. and 3500 psi.

FIG. 30. Foam stability as a function of time for foam formulations including different fluorinated surfactant at 110° C. and 3500 psi.

FIG. 31. Foam stability as a function of time for foam formulations using fluorinated surfactant FS1 at 3500 psi different temperatures.

FIG. 32. Foam stability as a function of time for foam formulations using fluorinated surfactant FS2 at 3500 psi different temperatures.

FIG. 33. Foam stability as a function of solution viscosity at 85° C.

FIG. 34. Images of crosslinked foam after half a day (left), 1 day (middle), and 3 days (right).

FIG. 35. Photographs of a crosslinked foam at 110° C. over time from 1 hour to 24 hours.

FIG. 36. Foamed gel strength over time for crosslinked compositions including varying amount of fluorinated surfactant FS2 at 25° C.

FIG. 37. Foamed gel strength over time for crosslinked compositions including varying amount of fluorinated surfactant FS2 at 110° C.

FIG. 38. Foam stability as a function of time for crosslinked compositions including varying amounts of fluorinated surfactant FS2 at 110° C.

FIG. 39. Dynamic experiments on crosslinked foams at various temperatures.

FIG. 40. Foamed gel strength over time for various formulations without fluorinated surfactants at 25° C.

FIG. 41. Foamed gel strength over time for various formulations without fluorinated surfactants at 110° C.

FIG. 42. Foam stability over time for various formulations without fluorinated surfactants at 110° C.

FIG. 43. A schematic of the experimental setup for the foam stability testing using CT scanning.

FIG. 44. CT number profile of the testing cell with surfactant/polymer solution and N2 at 3500 psi.

FIG. 45. Density profile of the testing cell with surfactant/polymer solution and N2 at 3500 psi.

FIG. 46. Scout CT scanning at 3500 psi and ambient temperature of the generation of a 60% quality foam.

FIG. 47. Scout CT scanning at 3500 psi and ambient temperature of the foam stability/decay of the 60% quality foam.

FIG. 48. Scout CT scanning at 85° C. of the foam stability/decay of an 80% quality foam.

FIG. 49. Density profile of the Scout CT scans in FIG. 48.

FIG. 50. Density profile from Scout CT scans for a 60% quality foam.

FIG. 51. Density profile from Scout CT scans for an 80% quality foam at 120° C.

FIG. 52. Viscosity of a foam formulation of various qualities at 500 psi and various temperatures as a function of shear rate.

FIG. 53. Foam stability measured using Foam Stability Test Method 2 for a formulation including a fluorinated surfactant and biopolymer at various temperatures and 3500 psi as a function of time.

FIG. 54. Foam stability measured using Foam Stability Test Method 2 for two different formulations at two different temperatures and 3500 psi as function of time.

FIG. 55. Foam stability of an 80% quality foam at 120° C. and 3500 psi measured using the CT scanning method.

FIG. 56. Foam stability of a 67% quality foam measured using Foam Stability Test Method 2 at 3500 psi and 110° C.

FIG. 57. Foam stability of a 60% quality foam measured using the CT scanning method at 3500 psi and 110° C.

FIG. 58. Effect of foam quality on foam stability as a function of time.

FIG. 59. Foam stability as a function of time for formulations at various qualities and temperatures.

FIG. 60. Foam stability as a function of time for formulations with varying polymer components at 75° C. and ambient pressure.

FIG. 61. Foamability as a function of polymer concentration for formulations with varying polymer components.

FIG. 62 illustrates an example drilling system and method employing an aqueous based foam described herein.

FIG. 63 illustrates an example drilling system and method employing an aqueous based foam described herein.

FIG. 64 illustrates an example drilling system and method employing an aqueous based foam described herein.

FIG. 65 illustrates an example drilling system and method employing an aqueous based foam described herein.

FIG. 66 shows images of foam bubbles versus time in foam rheometer. The foam included a surfactant with no viscosifying polymer, no foam stabilizer, and 80% gas by volume. Test conditions were 3,600 psi and 116° C. This foam showed signs of destabilizing at 3 hours and complete destabilization after 4.25 hours.

FIG. 67 shows images of foam bubbles versus time in foam rheometer. The foam included a different surfactant from FIG. 66 and does not include a viscosifying polymer or a foam stabilizer. Test conditions were 3,600 psi and 116° C. The foam included 80% gas by volume. The foam showed signs of destabilizing at 6 hours and complete destabilization after 6.5 hours.

FIG. 68 shows images of foam bubbles versus time in foam rheometer. The foam included 0.4 wt % biopolymer and surfactant package (primary surfactant, foam stabilizer, viscosifying polymer, and water). The gas fraction of the foam was 30%. Test conditions were 2,500 psi and 60° C. Foam destabilized after 60 minutes (1 hour).

FIG. 69 shows initial and final images of a foam in foam rheometer. The foam included 1.5 wt % biopolymer, 2 wt % surfactant package, and 55% gas by volume. The test conditions were 2,500 psi and 85° C. The foam appears nearly identical after 21 hours of monitoring.

FIG. 70 shows images of foam bubbles versus time in foam rheometer. The foam included 2 wt % surfactant package (primary surfactant, foam stabilizer, viscosifying polymer, and water), and 55% gas by volume. The test conditions were 3,600 psi and 120° C. Images were taken at 0, 5, 11, and 16 hours. The foam showed no signs of degradation after 16 hours of monitoring.

FIG. 71 shows the results of a foam half-life experiment performed using a high-pressure view cell. The plot shows normalized foam height versus time. The foaming formulation tested included 1.5 wt % biopolymer and 2 wt % surfactant package. The system test conditions were 1,900 psi and 140° F.

FIG. 72 shows foam texture versus time. The foam was generated at pilot scale. The foam was made using surfactant package (primary foaming surfactant and foam stabilizerf) and 1.5 wt % viscosifying polymer (biopolymer). The test conditions were 2,500 psi and 180° F. The gas fraction in the foams was either 60% or 70%. The results from the images show little change in foam bubble size with time.

FIG. 73 shows large scale foam stability versus time. The foam was trapped in a 10 ft pipe with dimensions 6″ outer pipe and 4″ inner pipe. The foam was in the pipe for over 265 minutes. White regions in the plot indicate when the foam was ‘static’ and the shaded regions indicate when the 4″ inner pipe was rotated. The test conditions were 2,500 psi and 180° F. The foam was stabilized with a surfactant package (primary foaming surfactant and foam stabilizer) and a viscosifying polymer. The gas fraction of the foam was 60%. During the test, the foam showed little change in stability as measured by the change in foam quality with time. The foam quality was within ˜5% during the test.

FIG. 74 illustrates the test section A (200) including an inclinable test section (201), four differential pressure transmitters (202-205), two gamma ray densitometers (206 and 208), and a gas injection point (2009) used to create nitrogen gas bubbles.

FIG. 75 is a table showing the pilot-scale test facility operating parameters and ranges for testing. All of the test conditions are within the operating parameters of the PFTF.

### DETAILED DESCRIPTION

The compositions, systems, and methods described herein may be understood more readily by reference to the following detailed description of specific aspects of the disclosed subject matter and the Examples included herein.

### Definitions

Before the present compositions, systems, and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Unless otherwise defined, all technical and scientific terms used herein have the same meaning as commonly understood by one of ordinary skill in the art to which this invention belongs. Unless otherwise specified, all percentages are in weight percent and the pressure is in atmospheres.

The organic moieties mentioned when defining variable positions within the general formulae described herein (e.g., the term “halogen”) are collective terms for the individual substituents encompassed by the organic moiety. The prefix Cₙ-Cₘ preceding a group or moiety indicates, in each case, the possible number of carbon atoms in the group or moiety that follows.

References in the specification and concluding claims to parts by weight of a particular element or component in a composition denotes the weight relationship between the element or component and any other elements or components in the composition or article for which a part by weight is expressed at room temperature (e.g., ˜20° C.) and pressure (1 atm). Thus, in a compound containing 2 parts by weight of component X and 5 parts by weight component Y, X and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included at room temperature (e.g., ˜20° C.) and pressure (1 atm).

Also, throughout this specification, various publications are referenced. The disclosures of these publications in their entireties are hereby incorporated by reference into this application in order to more fully describe the state of the art to which the disclosed subject matter pertains. The references disclosed are also individually and specifically incorporated by reference herein for the material contained in them that is discussed in the sentence in which the reference is relied upon.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if an item is described herein as including a component of type A, a component of type B, a component of type C, or any combination thereof, it is understood that this phrase describes all of the various individual and collective combinations and permutations of these components. For example, in some embodiments, the item described by this phrase could include only a component of type A. In some embodiments, the item described by this phrase could include only a component of type B. In some embodiments, the item described by this phrase could include only a component of type C. In some embodiments, the item described by this phrase could include a component of type A and a component of type B. In some embodiments, the item described by this phrase could include a component of type A and a component of type C. In some embodiments, the item described by this phrase could include a component of type B and a component of type C. In some embodiments, the item described by this phrase could include a component of type A, a component of type B, and a component of type C. In some embodiments, the item described by this phrase could include two or more components of type A (e.g., A1 and A2). In some embodiments, the item described by this phrase could include two or more components of type B (e.g., B1 and B2). In some embodiments, the item described by this phrase could include two or more components of type C (e.g., C1 and C2). In some embodiments, the item described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the item described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the item described by this phrase could include two or more of a first component (e.g., two or more components of type C (C1 and C2)), optionally one or more of a second component (e.g., optionally one or more components of type A), and optionally one or more of a third component (e.g., optionally one or more components of type B).

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

In this specification and in the claims that follow, reference will be made to a number of terms, which shall be defined to have the following meanings.

As used in this specification and the following claims, the terms “comprise” (as well as forms, derivatives, or variations thereof, such as “comprising” and “comprises”) and “include” (as well as forms, derivatives, or variations thereof, such as “including” and “includes”) are inclusive (i.e., open-ended) and do not exclude additional elements or steps. For example, the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. Accordingly, these terms are intended to not only cover the recited element(s) or step(s), but may also include other elements or steps not expressly recited. Furthermore, as used herein, the use of the terms “a” or “an” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of +10 percent of the given numeric value provided such a deviation does not alter the end function or result of the value. Therefore, a value of about 1% can be construed to be a range from 0.9% to 1.1%. Furthermore, a range may be construed to include the start and the end of the range. For example, a range of 10% to 20% (i.e., range of 10%-20%) can includes 10% and also includes 20%, and includes percentages in between 10% and 20%, unless explicitly stated otherwise herein.

“Exemplary” means “an example of” and is not intended to convey an indication of a preferred or ideal embodiment. “Such as” is not used in a restrictive sense, but for explanatory purposes.

“Optional” or “optionally” means that the subsequently described event or circumstance occurs and instances where it does not.

“Hydrocarbon-bearing formation” or simply “formation” refers to practically any volume under a surface containing hydrocarbons therein. For example, the hydrocarbon-bearing formation may be practically anything under a terrestrial surface (e.g., a land surface), practically anything under a seafloor, etc. A water column may be above the hydrocarbon-bearing formation, such as in marine hydrocarbon exploration, in marine hydrocarbon recovery, etc. The hydrocarbon-bearing formation may be onshore. The hydrocarbon-bearing formation may be offshore with shallow water or deep water above the hydrocarbon-bearing formation. The hydrocarbon-bearing formation may include faults, fractures, vugs, overburdens, underburdens, salts, salt welds, rocks, sands, sediments, pore space, etc. The hydrocarbon-bearing formation may include practically any geologic point(s) or volume(s) of interest (such as a survey area) in some embodiments.

The hydrocarbon-bearing formation may also include at least one wellbore. For example, at least one wellbore may be drilled into the hydrocarbon-bearing formation in order to confirm the presence of the hydrocarbons. As another example, at least one wellbore may be drilled into the hydrocarbon-bearing formation in order to recover (also referred to as produce) the hydrocarbons such as crude oil. The hydrocarbons may be recovered from the entire hydrocarbon-bearing formation or from a portion of the hydrocarbon-bearing formation. For example, the hydrocarbon-bearing formation may be divided up into one or more hydrocarbon zones, and hydrocarbons may be recovered from each desired hydrocarbon zone. One or more of hydrocarbon zones may even be shut-in to increase hydrocarbon recovery from a hydrocarbon zone that is not shut-in. The hydrocarbon-bearing formation, the hydrocarbons, or any combination thereof may also include non-hydrocarbon items (e.g., H2S).

In short, each hydrocarbon-bearing formation may have a variety of characteristics, such as petrophysical rock properties, reservoir fluid properties, reservoir conditions, hydrocarbon properties, or any combination thereof. For example, each hydrocarbon-bearing formation (or even zone or portion of the hydrocarbon-bearing formation) may be associated with one or more of: temperature, porosity, salinity, permeability, water composition, mineralogy, hydrocarbon type, hydrocarbon quantity, reservoir location, pressure, etc. Those of ordinary skill in the art will appreciate that the characteristics are many, including, but not limited to: carbonate, vuggy carbonate, unconventional, conventional, etc.). Hydrocarbon-bearing formations can be “unconventional formations” or “conventional formations.”

“Unconventional formation” is a subterranean hydrocarbon-bearing formation that requires intervention in order to recover hydrocarbons from the reservoir at economic flow rates or volumes. For example, an unconventional formation includes reservoirs having an unconventional microstructure, such as having submicron pore size (a rock matrix with an average pore size less than 1 micrometer), in which fractures are used to recover hydrocarbons from the reservoir at sufficient flow rates or volumes (e.g., an unconventional reservoir must be fractured under pressure or have naturally occurring fractures in order to recover hydrocarbons from the reservoir at sufficient flow rates or volumes).

In some embodiments, the unconventional formation can include a reservoir having a permeability of less than 25 millidarcy (mD) (e.g., 20 mD or less, 15 mD or less, 10 mD or less, 5 mD or less, 1 mD or less, 0.5 mD or less, 0.1 mD or less, 0.05 mD or less, 0.01 mD or less, 0.005 mD or less, 0.001 mD or less, 0.0005 mD or less, 0.0001 mD or less, 0.00005 mD or less, 0.00001 mD or less, 0.000005 mD or less, 0.000001 mD or less, or less). In some embodiments, the unconventional formation can include a reservoir having a permeability of at least 0.000001 mD (e.g., at least 0.000005 mD, at least 0.00001 mD, 0.00005 mD, at least 0.0001 mD, 0.0005 mD, 0.001 mD, at least 0.005 mD, at least 0.01 mD, at least 0.05 mD, at least 0.1 mD, at least 0.5 mD, at least 1 mD, at least 5 mD, at least 10 mD, at least 15 mD, or at least 20 mD).

The unconventional formation can include a reservoir having a permeability ranging from any of the minimum values described above to any of the maximum values described above. For example, in some embodiments, the unconventional formation can include a reservoir having a permeability of from 0.000001 mD to 25 mD (e.g., from 0.001 mD to 25 mD, from 0.001 mD to 10 mD, from 0.01 mD to 10 mD, from 0.1 mD to 10 mD, from 0.001 mD to 5 mD, from 0.01 mD to 5 mD, or from 0.1 mD to 5 mD).

“Conventional formation” refers to a subterranean hydrocarbon-bearing formation having a higher permeability, such as a permeability of from 25 millidarcy to 40,000 millidarcy.

The term formation may be used synonymously with the term reservoir. Indeed, the terms “formation,” “reservoir,” “hydrocarbon,” and the like are not limited to any description or configuration described herein.

The wellbore may also include equipment to control fluid flow into the wellbore, control fluid flow out of the wellbore, or any combination thereof. For example, each wellbore may include a wellhead, a BOP, chokes, valves, or other control devices. These control devices may be located on the surface, under the surface (e.g., downhole in the wellbore), or any combination thereof. In some embodiments, the same control devices may be used to control fluid flow into and out of the wellbore. In some embodiments, different control devices may be used to control fluid flow into and out of the wellbore. In some embodiments, the rate of flow of fluids through the wellbore may depend on the fluid handling capacities of the surface facility that is in fluidic communication with the wellbore. The control devices may also be utilized to control the pressure profile of the wellbore. The equipment to be used in controlling fluid flow into and out of the wellbore may be dependent on the specifics of the wellbore, the hydrocarbon-bearing formation, the surface facility, etc.

The wellbore may be drilled into the hydrocarbon-bearing formation using practically any drilling technique and equipment known in the art, such as geosteering, directional drilling, etc. Drilling the wellbore may include using a tool, such as a drilling tool that includes a drill bit and a drill string. Drilling fluid, such as drilling mud, may be used while drilling in order to cool the drill tool and remove cuttings. Other tools may also be used while drilling or after drilling, such as measurement-while-drilling (MWD) tools, seismic-while-drilling (SWD) tools, wireline tools, logging-while-drilling (LWD) tools, or other downhole tools. After drilling to a predetermined depth, the drill string and the drill bit are removed, and then the casing, the tubing, etc. may be installed according to the design of the wellbore. The equipment to be used in drilling the wellbore may be dependent on the design of the wellbore, the hydrocarbon-bearing formation, the hydrocarbons, etc.

The term “wellbore” may be used synonymously with the terms “borehole,” “well,” or “well bore.” The term “wellbore” is not limited to any description or configuration described herein. The term wellbore is not limited to any description or configuration described herein.

The terms “unrefined petroleum” and “crude oil” are used interchangeably and in keeping with the plain ordinary usage of those terms. “Unrefined petroleum” and “crude oil” may be found in a variety of petroleum reservoirs (also referred to herein as a “reservoir,” “oil field deposit” “deposit” and the like) and in a variety of forms including oleaginous materials, oil shales (i.e., organic-rich fine-grained sedimentary rock), tar sands, light oil deposits, heavy oil deposits, and the like. “Crude oils” or “unrefined petroleums” generally refer to a mixture of naturally occurring hydrocarbons that may be refined into diesel, gasoline, heating oil, jet fuel, kerosene, and other products called fuels or petrochemicals. Crude oils or unrefined petroleums are named according to their contents and origins, and are classified according to their per unit weight (specific gravity). Heavier crudes generally yield more heat upon burning, but have lower gravity as defined by the American Petroleum Institute (API) (i.e., API gravity) and market price in comparison to light (or sweet) crude oils. Crude oil may also be characterized by its Equivalent Alkane Carbon Number (EACN). The term “API gravity” refers to the measure of how heavy or light a petroleum liquid is compared to water. If an oil's API gravity is greater than 10, it is lighter and floats on water, whereas if it is less than 10, it is heavier and sinks. API gravity is thus an inverse measure of the relative density of a petroleum liquid and the density of water. API gravity may also be used to compare the relative densities of petroleum liquids. For example, if one petroleum liquid floats on another and is therefore less dense, it has a greater API gravity.

Crude oils vary widely in appearance and viscosity from field to field. They range in color, odor, and in the properties they contain. While all crude oils are mostly hydrocarbons, the differences in properties, especially the variation in molecular structure, determine whether a crude oil is more or less easy to produce, pipeline, and refine. The variations may even influence its suitability for certain products and the quality of those products. Crude oils are roughly classified into three groups, according to the nature of the hydrocarbons they contain. (i) Paraffin-based crude oils contain higher molecular weight paraffins, which are solid at room temperature, but little or no asphaltic (bituminous) matter. They can produce high-grade lubricating oils. (ii) Asphaltene based crude oils contain large proportions of asphaltic matter, and little or no paraffin. Some are predominantly naphthenes and so yield lubricating oils that are sensitive to temperature changes than the paraffin-based crudes. (iii) Mixed based crude oils contain both paraffin and naphthenes, as well as aromatic hydrocarbons. Most crude oils fit this latter category.

The term “polymer” refers to a molecule having a structure that essentially includes the multiple repetitions of units derived, actually or conceptually, from molecules of low relative molecular mass. In some embodiments, the polymer is an oligomer.

The term “solubility” or “solubilization” in general refers to the property of a solute, which can be a solid, liquid or gas, to dissolve in a solid, liquid or gaseous solvent thereby forming a homogenous solution of the solute in the solvent. Solubility occurs under dynamic equilibrium, which means that solubility results from the simultaneous and opposing processes of dissolution and phase joining (e.g., precipitation of solids). The solubility equilibrium occurs when the two processes proceed at a constant rate. The solubility of a given solute in a given solvent typically depends on temperature. For many solids dissolved in liquid water, the solubility increases with temperature. In liquid water at high temperatures, the solubility of ionic solutes tends to decrease due to the change of properties and structure of liquid water. In more particular, solubility and solubilization as referred to herein is the property of oil to dissolve in water and vice versa.

“Viscosity” refers to a fluid's internal resistance to flow or being deformed by shear or tensile stress. In other words, viscosity may be defined as thickness or internal friction of a liquid. Thus, water is “thin”, having a lower viscosity, while oil is “thick”, having a higher viscosity. More generally, the less viscous a fluid is, the greater its ease of fluidity.

The term “salinity” as used herein, refers to concentration of salt dissolved in an aqueous phases. Examples for such salts are without limitation, sodium chloride, magnesium and calcium sulfates, and bicarbonates. In more particular, the term salinity as it pertains to the present invention refers to the concentration of salts in brine and surfactant solutions.

The term “co-solvent,” as used herein, refers to a compound having the ability to increase the solubility of a solute (e.g., a surfactant as disclosed herein), for example in the presence of an unrefined petroleum acid. In some embodiments, the co-solvents provided herein have a hydrophobic portion (alkyl or aryl chain), a hydrophilic portion (e.g., an alcohol) and optionally an alkoxy portion. Co-solvents as provided herein include alcohols (e.g., C₁-C₆ alcohols, C₁-C₆ diols), alkoxy alcohols (e.g., C₁-C₆ alkoxy alcohols, C₁-C₆ alkoxy diols, and phenyl alkoxy alcohols), glycol ether, glycol and glycerol. The term “alcohol” is used according to its ordinary meaning and refers to an organic compound containing an —OH groups attached to a carbon atom. The term “diol” is used according to its ordinary meaning and refers to an organic compound containing two —OH groups attached to two different carbon atoms. The term “alkoxy alcohol” is used according to its ordinary meaning and refers to an organic compound containing an alkoxy linker attached to a —OH group.

The term “water-soluble,” as used herein, refers to a solid or liquid solute that can dissolve in water to form a homogeneous solution to an extent of no less than one weight part of solute in every ten weight parts of water.

Reference will now be made in detail to specific aspects of the disclosed materials, compounds, compositions, articles, systems, and methods, examples of which are illustrated in the accompanying examples and figures.

Compositions

Described herein are aqueous foam precursor compositions. The aqueous foam precursor compositions can comprise a single-phase aqueous solution which can form an aqueous based foam upon combination with an expansion gas.

In some embodiments, the aqueous foam precursor compositions described herein can form an aqueous based foam that exhibits a foam half-life of 2 hours or more (e.g., 4 hours or more, 6 hours or more, 8 hours or more, 10 hours or more, 12 hours or more, 14 hours or more, 16 hours or more, 18 hours or more, 20 hours or more, 22 hours or more, 24 hours or more, or 36 hours or more) when foamed and measured using Foam Stability Test Method 1. In some embodiments, the aqueous foam precursor compositions described herein can form an aqueous based foam that exhibits a foam half-life of 48 hours or less (e.g., 36 hours or less, 24 hours or less, 22 hours or less, 20 hours or less, 18 hours or less, 16 hours or less, 14 hours or less, 12 hours or less, 10 hours or less, 8 hours or less, 6 hours or less, or 4 hours or less) when foamed and measured using Foam Stability Test Method 1.

The aqueous foam precursor compositions described herein can form an aqueous based foam that exhibits a foam half-life ranging from any of the minimum values described above to any of the maximum values described above when foamed and measured using Foam Stability Test Method 1. For example, in some embodiments, the aqueous foam precursor compositions described herein can form an aqueous based foam that exhibits a foam half-life of from 2 hours to 48 hours (e.g., from 2 hours to 24 hours, from 12 hours to 48 hours, or from 12 hours to 24 hours) when foamed and measured using Foam Stability Test Method 1. In certain examples, the aqueous foam precursor composition forms an aqueous based foam that exhibits a foam half-life of at least 12 hours, when foamed and measured using Foam Stability Test Method 1.

In some examples, the aqueous foam precursor compositions described herein can form an aqueous based foam that exhibits a foam half-life of 2 hours or more (e.g., 4 hours or more, 6 hours or more, 8 hours or more, 10 hours or more, 12 hours or more, 14 hours or more, 16 hours or more, 18 hours or more, 20 hours or more, 22 hours or more, 24 hours or more, or 36 hours or more), when foamed and measured using Foam Stability Test Method 2. In some embodiments, the aqueous foam precursor compositions described herein can form an aqueous based foam that exhibits a foam half-life of 48 hours or less (e.g., 36 hours or less, 24 hours or less, 22 hours or less, 20 hours or less, 18 hours or less, 16 hours or less, 14 hours or less, 12 hours or less, 10 hours or less, 8 hours or less, 6 hours or less, or 4 hours or less) when foamed and measured using Foam Stability Test Method 2.

The aqueous foam precursor compositions described herein can form an aqueous based foam that exhibits a foam half-life ranging from any of the minimum values described above to any of the maximum values described above when foamed and measured using Foam Stability Test Method 2. For example, in some embodiments, the aqueous foam precursor compositions described herein can form an aqueous based foam that exhibits a foam half-life of from 2 hours to 48 hours (e.g., from 2 hours to 24 hours, from 12 hours to 48 hours, or from 12 hours to 24 hours) when foamed and measured using Foam Stability Test Method 2. In certain examples, the aqueous foam precursor composition forms an aqueous based foam that exhibits a foam half-life of at least 12 hours, when foamed and measured using Foam Stability Test Method 2.

In some examples, the aqueous foam precursor compositions described herein can form an aqueous based foam that exhibits a foam half-life of 2 hours or more, when foamed and measured using Foam Stability Test Method 2 at elevated pressure. In some examples, the aqueous foam precursor compositions described herein can form an aqueous based foam that exhibits a foam half-life of 2 hours or more (e.g., 4 hours or more, 6 hours or more, 8 hours or more, 10 hours or more, 12 hours or more, 14 hours or more, 16 hours or more, 18 hours or more, 20 hours or more, 22 hours or more, 24 hours or more, or 36 hours or more), when foamed and measured using Foam Stability Test Method 2 performed at a pressure of 500 psi or more (e.g., 500 psi, 1000 psi, 1500 psi, 2000 psi, 2500 psi, 3000 psi, 3500 psi, 4000 psi, or 4500 psi). In some embodiments, the aqueous foam precursor compositions described herein can form an aqueous based foam that exhibits a foam half-life of 48 hours or less (e.g., 36 hours or less, 24 hours or less, 22 hours or less, 20 hours or less, 18 hours or less, 16 hours or less, 14 hours or less, 12 hours or less, 10 hours or less, 8 hours or less, 6 hours or less, or 4 hours or less) when foamed and measured using Foam Stability Test Method 2 performed at a pressure of 500 psi or more (e.g., 500 psi, 1000 psi, 1500 psi, 2000 psi, 2500 psi, 3000 psi, 3500 psi, 4000 psi, or 4500 psi).

The aqueous foam precursor compositions described herein can form an aqueous based foam that exhibits a foam half-life ranging from any of the minimum values described above to any of the maximum values described above when foamed and measured using Foam Stability Test Method 2 performed at a pressure of 500 psi or more (e.g., 500 psi, 1000 psi, 1500 psi, 2000 psi, 2500 psi, 3000 psi, 3500 psi, 4000 psi, or 4500 psi). For example, in some embodiments, the aqueous foam precursor compositions described herein can form an aqueous based foam that exhibits a foam half-life of from 2 hours to 48 hours (e.g., from 2 hours to 24 hours, from 12 hours to 48 hours, or from 12 hours to 24 hours) when foamed and measured using Foam Stability Test Method 2 performed at a pressure of 500 psi or more (e.g., 500 psi, 1000 psi, 1500 psi, 2000 psi, 2500 psi, 3000 psi, 3500 psi, 4000 psi, or 4500 psi). In certain examples, the aqueous foam precursor composition forms an aqueous based foam that exhibits a foam half-life of at least 12 hours, when foamed and measured using Foam Stability Test Method 2 performed at a pressure of 500 psi or more (e.g., 500 psi, 1000 psi, 1500 psi, 2000 psi, 2500 psi, 3000 psi, 3500 psi, 4000 psi, or 4500 psi).

In some examples, the aqueous foam precursor compositions described herein can form an aqueous based foam that exhibits a foam half life of 2 hours or more, when foamed and measured using Foam Stability Test Method 2 at elevated temperature. In some examples, the aqueous foam precursor compositions described herein can form an aqueous based foam that exhibits a foam half life of 2 hours or more (e.g., 4 hours or more, 6 hours or more, 8 hours or more, 10 hours or more, 12 hours or more, 14 hours or more, 16 hours or more, 18 hours or more, 20 hours or more, 22 hours or more, 24 hours or more, or 36 hours or more), when foamed and measured using Foam Stability Test Method 2 performed at a temperature of 40° C. or more (e.g., 40° C., 50° C., 60° C., 70° C., 80° C., 85° C., 90° C., 100° C., 110° C., or 120° C.). In some embodiments, the aqueous foam precursor compositions described herein can form an aqueous based foam that exhibits a foam half-life of 48 hours or less (e.g., 36 hours or less, 24 hours or less, 22 hours or less, 20 hours or less, 18 hours or less, 16 hours or less, 14 hours or less, 12 hours or less, 10 hours or less, 8 hours or less, 6 hours or less, or 4 hours or less) when foamed and measured using Foam Stability Test Method 2 performed at a temperature of 40° C. or more (e.g., 40° C., 50° C., 60° C., 70° C., 80° C., 85° C., 90° C., 100° C., 110° C., or 120° C.).

The aqueous foam precursor compositions described herein can form an aqueous based foam that exhibits a foam half-life ranging from any of the minimum values described above to any of the maximum values described above when foamed and measured using Foam Stability Test Method 2 performed at a temperature of 40° C. or more (e.g., 40° C., 50° C., 60° C., 70° C., 80° C., 85° C., 90° C., 100° C., 110° C., or 120° C.). For example, in some embodiments, the aqueous foam precursor compositions described herein can form an aqueous based foam that exhibits a foam half-life of from 2 hours to 48 hours (e.g., from 2 hours to 24 hours, from 12 hours to 48 hours, or from 12 hours to 24 hours) when foamed and measured using Foam Stability Test Method 2 performed at a temperature of 40° C. or more (e.g., 40° C., 50° C., 60° C., 70° C., 80° C., 85° C., 90° C., 100° C., 110° C., or 120° C.). In certain examples, the aqueous foam precursor composition forms an aqueous based foam that exhibits a foam half-life of at least 12 hours, when foamed and measured using Foam Stability Test Method 2 performed at a temperature of 40° C. or more (e.g., 40° C., 50° C., 60° C., 70° C., 80° C., 85° C., 90° C., 100° C., 110° C., or 120° C.).

In some examples, the aqueous foam precursor compositions described herein can form an aqueous based foam that exhibits a foam half life of 2 hours or more, when foamed and measured using Foam Stability Test Method 2 at elevated temperature and pressure. In some examples, the aqueous foam precursor compositions described herein can form an aqueous based foam that exhibits a foam half life of 2 hours or more, when foamed and measured using Foam Stability Test Method 2 at elevated temperature and elevated pressure. In some examples, the aqueous foam precursor compositions described herein can form an aqueous based foam that exhibits a foam half life of 2 hours or more (e.g., 4 hours or more, 6 hours or more, 8 hours or more, 10 hours or more, 12 hours or more, 14 hours or more, 16 hours or more, 18 hours or more, 20 hours or more, 22 hours or more, 24 hours or more, or 36 hours or more), when foamed and measured using Foam Stability Test Method 2 performed at a pressure of 500 psi or more (e.g., 500 psi, 1000 psi, 1500 psi, 2000 psi, 2500 psi, 3000 psi, 3500 psi, 4000 psi, or 4500 psi) and a temperature of 40° C. or more (e.g., 40° C., 50° C., 60° C., 70° C., 80° C., 85° C., 90° C., 100° C., 110° C., or 120° C.). In some embodiments, the aqueous foam precursor compositions described herein can form an aqueous based foam that exhibits a foam half-life of 48 hours or less (e.g., 36 hours or less, 24 hours or less, 22 hours or less, 20 hours or less, 18 hours or less, 16 hours or less, 14 hours or less, 12 hours or less, 10 hours or less, 8 hours or less, 6 hours or less, or 4 hours or less) when foamed and measured using Foam Stability Test Method 2 performed at a pressure of 500 psi or more (e.g., 500 psi, 1000 psi, 1500 psi, 2000 psi, 2500 psi, 3000 psi, 3500 psi, 4000 psi, or 4500 psi) and a temperature of 40° C. or more (e.g., 40° C., 50° C., 60° C., 70° C., 80° C., 85° C., 90° C., 100° C., 110° C., or 120° C.).

The aqueous foam precursor compositions described herein can form an aqueous based foam that exhibits a foam half-life ranging from any of the minimum values described above to any of the maximum values described above when foamed and measured using Foam Stability Test Method 2 performed at a pressure of 500 psi or more (e.g., 500 psi, 1000 psi, 1500 psi, 2000 psi, 2500 psi, 3000 psi, 3500 psi, 4000 psi, or 4500 psi) and a temperature of 40° C. or more (e.g., 40° C., 50° C., 60° C., 70° C., 80° C., 85° C., 90° C., 100° C., 110° C., or 120° C.). For example, in some embodiments, the aqueous foam precursor compositions described herein can form an aqueous based foam that exhibits a foam half-life of from 2 hours to 48 hours (e.g., from 2 hours to 24 hours, from 12 hours to 48 hours, or from 12 hours to 24 hours) when foamed and measured using Foam Stability Test Method 2 performed at a pressure of 500 psi or more (e.g., 500 psi, 1000 psi, 1500 psi, 2000 psi, 2500 psi, 3000 psi, 3500 psi, 4000 psi, or 4500 psi) and a temperature of 40° C. or more (e.g., 40° C., 50° C., 60° C., 70° C., 80° C., 85° C., 90° C., 100° C., 110° C., or 120° C.). In certain examples, the aqueous foam precursor composition forms an aqueous based foam that exhibits a foam half-life of at least 12 hours, when foamed and measured using Foam Stability Test Method 2 performed at a pressure of 500 psi or more (e.g., 500 psi, 1000 psi, 1500 psi, 2000 psi, 2500 psi, 3000 psi, 3500 psi, 4000 psi, or 4500 psi) and a temperature of 40° C. or more (e.g., 40° C., 50° C., 60° C., 70° C., 80° C., 85° C., 90° C., 100° C., 110° C., or 120° C.).

In certain examples, the aqueous foam precursor compositions described herein can form an aqueous based foam that exhibits a foam half life of 2 hours or more (e.g., 4 hours or more, 6 hours or more, 8 hours or more, 10 hours or more, 12 hours or more, 14 hours or more, 16 hours or more, 18 hours or more, 20 hours or more, 22 hours or more, 24 hours or more, or 36 hours or more), when foamed and measured using Foam Stability Test Method 2 performed at a pressure of 1500 psi and a temperature of 85° C. In some embodiments, the aqueous foam precursor compositions described herein can form an aqueous based foam that exhibits a foam half-life of 48 hours or less (e.g., 36 hours or less, 24 hours or less, 22 hours or less, 20 hours or less, 18 hours or less, 16 hours or less, 14 hours or less, 12 hours or less, 10 hours or less, 8 hours or less, 6 hours or less, or 4 hours or less) when foamed and measured using Foam Stability Test Method 2 performed at a pressure of 1500 psi and a temperature of 85° C.

The aqueous foam precursor compositions described herein can form an aqueous based foam that exhibits a foam half-life ranging from any of the minimum values described above to any of the maximum values described above when foamed and measured using Foam Stability Test Method 2 performed at a pressure of 1500 psi and a temperature of 85° C. For example, in some embodiments, the aqueous foam precursor compositions described herein can form an aqueous based foam that exhibits a foam half-life of from 2 hours to 48 hours (e.g., from 2 hours to 24 hours, from 12 hours to 48 hours, or from 12 hours to 24 hours) when foamed and measured using Foam Stability Test Method 2 performed at a pressure of 1500 psi and a temperature of 85° C. In certain examples, the aqueous foam precursor composition forms an aqueous based foam that exhibits a foam half-life of at least 12 hours, when foamed and measured using Foam Stability Test Method 2 performed at a pressure of 1500 psi and a temperature of 85° C.

In some examples, the aqueous foam precursor compositions described herein can form an aqueous based foam that exhibits a foam half life of 2 hours or more, when foamed and measured using Foam Stability Test Method 2 in the presence of hydrogen sulfide (H₂S). In some examples, the aqueous foam precursor compositions described herein can form an aqueous based foam that exhibits a foam half life of 2 hours or more (e.g., 4 hours or more, 6 hours or more, 8 hours or more, 10 hours or more, 12 hours or more, 14 hours or more, 16 hours or more, 18 hours or more, 20 hours or more, 22 hours or more, 24 hours or more, or 36 hours or more), when foamed and measured using Foam Stability Test Method 2 performed in the presence of 10 mol % or more of H₂S (e.g., 10 mol % H₂S, 15 mol % H₂S, 17 mol % H₂S, 20 mol % H₂S, or 25 mol % H₂S). In some embodiments, the aqueous foam precursor compositions described herein can form an aqueous based foam that exhibits a foam half-life of 48 hours or less (e.g., 36 hours or less, 24 hours or less, 22 hours or less, 20 hours or less, 18 hours or less, 16 hours or less, 14 hours or less, 12 hours or less, 10 hours or less, 8 hours or less, 6 hours or less, or 4 hours or less) when foamed and measured using Foam Stability Test Method 2 performed in the presence of 10 mol % or more of H₂S (e.g., 10 mol % H₂S, 15 mol % H₂S, 17 mol % H₂S, 20 mol % H₂S, or 25 mol % H₂S).

The aqueous foam precursor compositions described herein can form an aqueous based foam that exhibits a foam half-life ranging from any of the minimum values described above to any of the maximum values described above when foamed and measured using Foam Stability Test Method 2 performed in the presence of 10 mol % or more of H₂S (e.g., 10 mol % H₂S, 15 mol % H₂S, 17 mol % H₂S, 20 mol % H₂S, or 25 mol % H₂S). For example, in some embodiments, the aqueous foam precursor compositions described herein can form an aqueous based foam that exhibits a foam half-life of from 2 hours to 48 hours (e.g., from 2 hours to 24 hours, from 12 hours to 48 hours, or from 12 hours to 24 hours) when foamed and measured using Foam Stability Test Method 2 performed in the presence of 10 mol % or more of H₂S (e.g., 10 mol % H₂S, 15 mol % H₂S, 17 mol % H₂S, 20 mol % H₂S, or 25 mol % H₂S). In certain examples, the aqueous foam precursor composition forms an aqueous based foam that exhibits a foam half-life of at least 12 hours, when foamed and measured using Foam Stability Test Method 2 performed in the presence of 10 mol % or more of H₂S (e.g., 10 mol % H₂S, 15 mol % H₂S, 17 mol % H₂S, 20 mol % H₂S, or 25 mol % H₂S).

In some examples, the aqueous foam precursor compositions described herein can form an aqueous based foam that exhibits a foam half-life of 2 hours or more (e.g., 4 hours or more, 6 hours or more, 8 hours or more, 10 hours or more, 12 hours or more, 14 hours or more, 16 hours or more, 18 hours or more, 20 hours or more, 22 hours or more, 24 hours or more, or 36 hours or more), when foamed and measured using Foam Stability Test Method 2 performed in the presence of 17 mol % of H₂S. In some embodiments, the aqueous foam precursor compositions described herein can form an aqueous based foam that exhibits a foam half-life of 48 hours or less (e.g., 36 hours or less, 24 hours or less, 22 hours or less, 20 hours or less, 18 hours or less, 16 hours or less, 14 hours or less, 12 hours or less, 10 hours or less, 8 hours or less, 6 hours or less, or 4 hours or less) when foamed and measured using Foam Stability Test Method 2 performed in the presence of 17 mol % of H₂S.

The aqueous foam precursor compositions described herein can form an aqueous based foam that exhibits a foam half-life ranging from any of the minimum values described above to any of the maximum values described above when foamed and measured using Foam Stability Test Method 2 performed in the presence of 17 mol % of H₂S. For example, in some embodiments, the aqueous foam precursor compositions described herein can form an aqueous based foam that exhibits a foam half-life of from 2 hours to 48 hours (e.g., from 2 hours to 24 hours, from 12 hours to 48 hours, or from 12 hours to 24 hours) when foamed and measured using Foam Stability Test Method 2 performed in the presence of 17 mol % of H₂S. In certain examples, the aqueous foam precursor composition forms an aqueous based foam that exhibits a foam half-life of at least 12 hours, when foamed and measured using Foam Stability Test Method 2 performed in the presence of 17 mol % of H₂S.

In some examples, the aqueous foam precursor compositions described herein can form an aqueous based foam that exhibits a foam half-life of 2 hours or more, when foamed and measured using Foam Stability Test Method 2 at elevated temperature in the presence of hydrogen sulfide. In some examples, the aqueous foam precursor compositions described herein can form an aqueous based foam that exhibits a foam half-life of 2 hours or more, when foamed and measured using Foam Stability Test Method 2 at elevated temperature. In some examples, the aqueous foam precursor compositions described herein can form an aqueous based foam that exhibits a foam half-life of 2 hours or more (e.g., 4 hours or more, 6 hours or more, 8 hours or more, 10 hours or more, 12 hours or more, 14 hours or more, 16 hours or more, 18 hours or more, 20 hours or more, 22 hours or more, 24 hours or more, or 36 hours or more), when foamed and measured using Foam Stability Test Method 2 performed at a temperature of 40° C. or more (e.g., 40° C., 50° C., 60° C., 70° C., 80° C., 85° C., 90° C., 100° C., 110° C., or 120° C.) in the presence of 10 mol % or more of H₂S (e.g., 10 mol % H₂S, 15 mol % H₂S, 17 mol % H₂S, 20 mol % H₂S, or 25 mol % H₂S). In some embodiments, the aqueous foam precursor compositions described herein can form an aqueous based foam that exhibits a foam half-life of 48 hours or less (e.g., 36 hours or less, 24 hours or less. 22 hours or less, 20 hours or less, 18 hours or less, 16 hours or less, 14 hours or less, 12 hours or less, 10 hours or less, 8 hours or less, 6 hours or less, or 4 hours or less) when foamed and measured using Foam Stability Test Method 2 performed at a temperature of 40° C. or more (e.g., 40° C., 50° C., 60° C., 70° C., 80° C., 85° C., 90° C., 100° C., 110° C., or 120° C.) in the presence of 10 mol % or more of H₂S (e.g., 10 mol % H₂S, 15 mol % H₂S, 17 mol % H₂S, 20 mol % H₂S, or 25 mol % H₂S).

The aqueous foam precursor compositions described herein can form an aqueous based foam that exhibits a foam half-life ranging from any of the minimum values described above to any of the maximum values described above when foamed and measured using Foam Stability Test Method 2 performed at a temperature of 40° C. or more (e.g., 40° C., 50° C., 60° C., 70° C., 80° C., 85° C., 90° C., 100° C., 110° C., or 120° C.) in the presence of 10 mol % or more of H₂S (e.g., 10 mol % H₂S, 15 mol % H₂S, 17 mol % H₂S, 20 mol % H₂S, or 25 mol % H₂S). For example, in some embodiments, the aqueous foam precursor compositions described herein can form an aqueous based foam that exhibits a foam half-life of from 2 hours to 48 hours (e.g., from 2 hours to 24 hours, from 12 hours to 48 hours, or from 12 hours to 24 hours) when foamed and measured using Foam Stability Test Method 2 performed at a temperature of 40° C. or more (e.g., 40° C., 50° C., 60° C., 70° C., 80° C., 85° C., 90° C., 100° C., 110° C., or 120° C.) in the presence of 10 mol % or more of H₂S (e.g., 10 mol % H₂S, 15 mol % H₂S, 17 mol % H₂S. 20 mol % H₂S, or 25 mol % H₂S). In certain examples, the aqueous foam precursor composition forms an aqueous based foam that exhibits a foam half-life of at least 12 hours, when foamed and measured using Foam Stability Test Method 2 performed at a temperature of 40° C. or more (e.g., 40° C., 50° C., 60° C., 70° C., 80° C., 85° C., 90° C., 100° C., 110° C., or 120° C.) in the presence of 10 mol % or more of H₂S (e.g., 10 mol % H₂S, 15 mol % H₂S, 17 mol % H₂S, 20 mol % H₂S, or 25 mol % H₂S).

In certain examples, the aqueous foam precursor compositions described herein can form an aqueous based foam that exhibits a foam half-life of 2 hours or more (e.g., 4 hours or more, 6 hours or more, 8 hours or more, 10 hours or more, 12 hours or more. 14 hours or more, 16 hours or more, 18 hours or more, 20 hours or more, 22 hours or more, 24 hours or more, or 36 hours or more), when foamed and measured using Foam Stability Test Method 2 performed at a temperature of 85° C. in the presence of 17 mol % of H₂S. In some embodiments, the aqueous foam precursor compositions described herein can form an aqueous based foam that exhibits a foam half-life of 48 hours or less (e.g., 36 hours or less, 24 hours or less, 22 hours or less, 20 hours or less, 18 hours or less, 16 hours or less; 14 hours or less, 12 hours or less, 10 hours or less, 8 hours or less, 6 hours or less, or 4 hours or less) when foamed and measured using Foam Stability Test Method 2 performed at a temperature of 85° C. in the presence of 17 mol % of H₂S.

The aqueous foam precursor compositions described herein can form an aqueous based foam that exhibits a foam half-life ranging from any of the minimum values described above to any of the maximum values described above when foamed and measured using Foam Stability Test Method 2 performed at a temperature of 85° C. in the presence of 17 mol % of H₂S. For example, in some embodiments, the aqueous foam precursor compositions described herein can form an aqueous based foam that exhibits a foam half-life of from 2 hours to 48 hours (e.g., from 2 hours to 24 hours, from 12 hours to 48 hours, or from 12 hours to 24 hours) when foamed and measured using Foam Stability Test Method 2 performed at a temperature of 85° C. in the presence of 17 mol % of H₂S. In certain examples, the aqueous foam precursor composition forms an aqueous based foam that exhibits a foam half-life of at least 12 hours, when foamed and measured using Foam Stability Test Method 2 performed at a temperature of 85° C. in the presence of 17 mol % of H₂S.

In some examples, the aqueous foam precursor compositions described herein can form an aqueous based foam that exhibits a foam half-life of 2 hours or more, when foamed and measured using Foam Stability Test Method 2 at elevated pressure in the presence of hydrogen sulfide. In some examples, the aqueous foam precursor compositions described herein can form an aqueous based foam that exhibits a foam half-life of 2 hours or more, when foamed and measured using Foam Stability Test Method 2 at elevated pressure. In some examples, the aqueous foam precursor compositions described herein can form an aqueous based foam that exhibits a foam half-life of 2 hours or more (e.g., 4 hours or more, 6 hours or more, 8 hours or more, 10 hours or more, 12 hours or more, 14 hours or more, 16 hours or more, 18 hours or more, 20 hours or more, 22 hours or more, 24 hours or more, or 36 hours or more), when foamed and measured using Foam Stability Test Method 2 performed at a pressure of 500 psi or more (e.g., 500 psi, 1000 psi, 1500 psi, 2000 psi, 2500 psi, 3000 psi, 3500 psi, 4000 psi, or 4500 psi) in the presence of 10 mol % or more of H₂S (e.g., 10 mol % H₂S, 15 mol % H₂S, 17 mol % H₂S, 20 mol % H₂S, or 25 mol % H₂S). In some embodiments, the aqueous foam precursor compositions described herein can form an aqueous based foam that exhibits a foam half-life of 48 hours or less (e.g., 36 hours or less, 24 hours or less, 22 hours or less, 20 hours or less, 18 hours or less, 16 hours or less, 14 hours or less, 12 hours or less, 10 hours or less, 8 hours or less, 6 hours or less, or 4 hours or less) when foamed and measured using Foam Stability Test Method 2 performed at a pressure of 500 psi or more (e.g., 500 psi, 1000 psi, 1500 psi. 2000 psi, 2500 psi, 3000 psi, 3500 psi, 4000 psi, or 4500 psi) in the presence of 10 mol % or more of H₂S (e.g., 10 mol % H₂S, 15 mol % H₂S, 17 mol % H₂S, 20 mol % H₂S, or 25 mol % H₂S).

The aqueous foam precursor compositions described herein can form an aqueous based foam that exhibits a foam half-life ranging from any of the minimum values described above to any of the maximum values described above when foamed and measured using Foam Stability Test Method 2 performed at a pressure of 500 psi or more (e.g., 500 psi, 1000 psi, 1500 psi, 2000 psi, 2500 psi, 3000 psi, 3500 psi, 4000 psi, or 4500 psi) in the presence of 10 mol % or more of H₂S (e.g., 10 mol % H₂S, 15 mol % H₂S, 17 mol % H₂S, 20 mol % H₂S, or 25 mol % H₂S). For example, in some embodiments, the aqueous foam precursor compositions described herein can form an aqueous based foam that exhibits a foam half-life of from 2 hours to 48 hours (e.g., from 2 hours to 24 hours, from 12 hours to 48 hours, or from 12 hours to 24 hours) when foamed and measured using Foam Stability Test Method 2 performed at a pressure of 500 psi or more (e.g., 500 psi, 1000 psi, 1500 psi, 2000 psi, 2500 psi, 3000 psi, 3500 psi, 4000 psi, or 4500 psi) in the presence of 10 mol % or more of H₂S (e.g., 10 mol % H₂S, 15 mol % H₂S, 17 mol % H₂S, 20 mol % H₂S, or 25 mol % H₂S). In certain examples, the aqueous foam precursor composition forms an aqueous based foam that exhibits a foam half-life of at least 12 hours, when foamed and measured using Foam Stability Test Method 2 performed at a pressure of 500 psi or more (e.g., 500 psi, 1000 psi, 1500 psi, 2000 psi, 2500 psi, 3000 psi, 3500 psi, 4000 psi, or 4500 psi) in the presence of 10 mol % or more of H₂S (e.g., 10 mol % H₂S, 15 mol % H₂S, 17 mol % H₂S, 20 mol % H₂S, or 25 mol % H₂S).

In certain examples, the aqueous foam precursor compositions described herein can form an aqueous based foam that exhibits a foam half-life of 2 hours or more (e.g., 4 hours or more, 6 hours or more, 8 hours or more, 10 hours or more, 12 hours or more, 14 hours or more, 16 hours or more, 18 hours or more, 20 hours or more, 22 hours or more, 24 hours or more, or 36 hours or more), when foamed and measured using Foam Stability Test Method 2 performed at a pressure of 1500 psi in the presence of 17 mol % of H₂S. In some embodiments, the aqueous foam precursor compositions described herein can form an aqueous based foam that exhibits a foam half-life of 48 hours or less (e.g., 36 hours or less, 24 hours or less, 22 hours or less, 20 hours or less, 18 hours or less, 16 hours or less, 14 hours or less, 12 hours or less, 10 hours or less, 8 hours or less, 6 hours or less, or 4 hours or less) when foamed and measured using Foam Stability Test Method 2 performed at a pressure of 1500 psi in the presence of 17 mol % of H₂S.

The aqueous foam precursor compositions described herein can form an aqueous based foam that exhibits a foam half-life ranging from any of the minimum values described above to any of the maximum values described above when foamed and measured using Foam Stability Test Method 2 performed at a pressure of 1500 psi in the presence of 17 mol % of H₂S. For example, in some embodiments, the aqueous foam precursor compositions described herein can form an aqueous based foam that exhibits a foam half-life of from 2 hours to 48 hours (e.g., from 2 hours to 24 hours, from 12 hours to 48 hours, or from 12 hours to 24 hours) when foamed and measured using Foam Stability Test Method 2 performed at a pressure of 1500 psi in the presence of 17 mol % of H₂S. In certain examples, the aqueous foam precursor composition forms an aqueous based foam that exhibits a foam half-life of at least 12 hours, when foamed and measured using Foam Stability Test Method 2 performed at a pressure of 1500 psi in the presence of 17 mol % of H₂S.

In some examples, the aqueous foam precursor compositions described herein can form an aqueous based foam that exhibits a foam half life of 2 hours or more, when foamed and measured using Foam Stability Test Method 2 at elevated temperature and pressure in the presence of hydrogen sulfide. In some examples, the aqueous foam precursor compositions described herein can form an aqueous based foam that exhibits a foam half life of 2 hours or more, when foamed and measured using Foam Stability Test Method 2 at elevated temperature and elevated pressure. In some examples, the aqueous foam precursor compositions described herein can form an aqueous based foam that exhibits a foam half life of 2 hours or more (e.g., 4 hours or more, 6 hours or more, 8 hours or more, 10 hours or more, 12 hours or more, 14 hours or more, 16 hours or more, 18 hours or more, 20 hours or more, 22 hours or more, 24 hours or more, or 36 hours or more), when foamed and measured using Foam Stability Test Method 2 performed at a pressure of 500 psi or more (e.g., 500 psi, 1000 psi, 1500 psi, 2000 psi, 2500 psi, 3000 psi, 3500 psi, 4000 psi, or 4500 psi) and a temperature of 40° C. or more (e.g., 40° C., 50° C., 60° C., 70° C., 80° C., 85° C., 90° C., 100° C., 110° C., or 120° C.) in the presence of 10 mol % or more of H₂S (e.g., 10 mol % H₂S, 15 mol % H₂S, 17 mol % H₂S, 20 mol % H₂S, or 25 mol % H₂S). In some embodiments, the aqueous foam precursor compositions described herein can form an aqueous based foam that exhibits a foam half-life of 48 hours or less (e.g., 36 hours or less, 24 hours or less, 22 hours or less, 20 hours or less, 18 hours or less, 16 hours or less, 14 hours or less, 12 hours or less, 10 hours or less, 8 hours or less, 6 hours or less, or 4 hours or less) when foamed and measured using Foam Stability Test Method 2 performed at a pressure of 500 psi or more (e.g., 500 psi, 1000 psi, 1500 psi, 2000 psi, 2500 psi, 3000 psi, 3500 psi, 4000 psi, or 4500 psi) and a temperature of 40° C. or more (e.g., 40° C., 50° C., 60° C., 70° C., 80° C., 85° C., 90° C., 100° C., 110° C., or 120° C.) in the presence of 10 mol % or more of H₂S (e.g., 10 mol % H₂S, 15 mol % H₂S, 17 mol % H₂S, 20 mol % H₂S, or 25 mol % H₂S).

The aqueous foam precursor compositions described herein can form an aqueous based foam that exhibits a foam half-life ranging from any of the minimum values described above to any of the maximum values described above when foamed and measured using Foam Stability Test Method 2 performed at a pressure of 500 psi or more (e.g., 500 psi, 1000 psi, 1500 psi, 2000 psi, 2500 psi, 3000 psi, 3500 psi, 4000 psi, or 4500 psi) and a temperature of 40° C. or more (e.g., 40° C., 50° C., 60° C., 70° C., 80° C., 85° C., 90° C., 100° C., 110° C., or 120° C.) in the presence of 10 mol % or more of H₂S (e.g., 10 mol % H₂S, 15 mol % H₂S, 17 mol % H₂S, 20 mol % H₂S, or 25 mol % H₂S). For example, in some embodiments, the aqueous foam precursor compositions described herein can form an aqueous based foam that exhibits a foam half-life of from 2 hours to 48 hours (e.g., from 2 hours to 24 hours, from 12 hours to 48 hours, or from 12 hours to 24 hours) when foamed and measured using Foam Stability Test Method 2 performed at a pressure of 500 psi or more (e.g., 500 psi, 1000 psi, 1500 psi, 2000 psi, 2500 psi, 3000 psi, 3500 psi, 4000 psi, or 4500 psi) and a temperature of 40° C. or more (e.g., 40° C., 50° C., 60° C., 70° C., 80° C., 85° C., 90° C., 100° C., 110° C., or 120° C.) in the presence of 10 mol % or more of H₂S (e.g., 10 mol % H₂S, 15 mol % H₂S, 17 mol % H₂S, 20 mol % H₂S, or 25 mol % H₂S). In certain examples, the aqueous foam precursor composition forms an aqueous based foam that exhibits a foam half-life of at least 12 hours, when foamed and measured using Foam Stability Test Method 2 performed at a pressure of 500 psi or more (e.g., 500 psi, 1000 psi, 1500 psi, 2000 psi, 2500 psi, 3000 psi, 3500 psi, 4000 psi, or 4500 psi) and a temperature of 40° C. or more (e.g., 40° C., 50° C., 60° C., 70° C., 80° C., 85° C., 90° C., 100° C., 110° C., or 120° C.) in the presence of 10 mol % or more of H₂S (e.g., 10 mol % H₂S, 15 mol % H₂S, 17 mol % H₂S, 20 mol % H₂S, or 25 mol % H₂S).

In certain examples, the aqueous foam precursor compositions described herein can form an aqueous based foam that exhibits a foam half life of 2 hours or more (e.g., 4 hours or more, 6 hours or more, 8 hours or more, 10 hours or more, 12 hours or more, 14 hours or more, 16 hours or more, 18 hours or more, 20 hours or more, 22 hours or more, 24 hours or more, or 36 hours or more), when foamed and measured using Foam Stability Test Method 2 performed at a pressure of 1500 psi and a temperature of 85° C. in the presence of 17 mol % of H₂S. In some embodiments, the aqueous foam precursor compositions described herein can form an aqueous based foam that exhibits a foam half-life of 48 hours or less (e.g., 36 hours or less, 24 hours or less, 22 hours or less, 20 hours or less, 18 hours or less, 16 hours or less, 14 hours or less, 12 hours or less, 10 hours or less, 8 hours or less, 6 hours or less, or 4 hours or less) when foamed and measured using Foam Stability Test Method 2 performed at a pressure of 1500 psi and a temperature of 85° C. in the presence of 17 mol % of H₂S.

The aqueous foam precursor compositions described herein can form an aqueous based foam that exhibits a foam half-life ranging from any of the minimum values described above to any of the maximum values described above when foamed and measured using Foam Stability Test Method 2 performed at a pressure of 1500 psi and a temperature of 85° C. in the presence of 17 mol % of H₂S. For example, in some embodiments, the aqueous foam precursor compositions described herein can form an aqueous based foam that exhibits a foam half-life of from 2 hours to 48 hours (e.g., from 2 hours to 24 hours, from 12 hours to 48 hours, or from 12 hours to 24 hours) when foamed and measured using Foam Stability Test Method 2 performed at a pressure of 1500 psi and a temperature of 85° C. in the presence of 17 mol % of H₂S. In certain examples, the aqueous foam precursor composition forms an aqueous based foam that exhibits a foam half-life of at least 12 hours, when foamed and measured using Foam Stability Test Method 2 performed at a pressure of 1500 psi and a temperature of 85° C. in the presence of 17 mol % of H₂S.

In some embodiments, the aqueous foam precursor composition can include: a primary foaming surfactant, wherein when measured according to Hydrogen Sulfide Stability Test Method 1, less than 20 mol % of the primary foaming surfactant degrades after aging for 7 days at 120° C. in the presence of 17% H₂S; a viscosity-modifying polymer; and water. In some embodiments, the composition can further include a foam stabilizer.

In some other embodiments, the aqueous foam precursor compositions can comprise: a primary foaming surfactant; a viscosity-modifying polymer; a foam stabilizer; and water.

In some embodiments, the aqueous foam precursor compositions can be substantially free (e.g., can include less than 1% by weight, less than 0.5% by weight, or less than 0.1% by weight) of proppant particles. In some examples, the aqueous foam precursor compositions can be substantially free (e.g., can include less than 5% by weight, less than 1% by weight, less than 0.5% by weight, or less than 0.1% by weight) of particles having a particle size of 5 micrometers (microns, μm) or more (e.g., 10 μm or more, 15 μm or more, 20 μm or more, 25 μm or more, 30 μm or more, 40 μm or more, 50 μm or more, 60 μm or more, 70 μm or more, 80 μm or more, 90 μm or more, 100 μm or more, 110 μm or more, 120 μm or more, 130 μm or more, 140 μm or more, 150 μm or more, 175 μm or more, 200 μm or more, 225 μm or more, 250 μm or more, 275 μm or more, 300 μm or more, 350 μm or more, 400 μm or more, or 450 μm or more).

Primary Foaming Surfactants

The primary foaming surfactant can, for example, comprise an anionic surfactant, a non-ionic surfactant, or any combination thereof. Suitable surfactants (and combinations of surfactants) are known in the art as discussed in more detail below.

In some embodiments, the primary foaming surfactant can be a water-soluble surfactant. Water-soluble surfactants can help solubilize compounds to form a clear, single-phase aqueous solution by lowering the interfacial surface tension between water and another liquid and/or between water and a solid.

In some embodiments, the primary foaming surfactant can be stable at reservoir conditions. In this way, foam stability at reservoir conditions can be enhanced. In some embodiments, the primary foaming surfactant can be stable at 120° C. in the presence of H₂S, as measured by Hydrogen Sulfide Stability Test Method 1.

The primary foaming surfactant can, for example, be present in an amount of 0.01% or more by weight, based on the total weight of the aqueous foam precursor composition (e.g., 0.05% or more, 0.1% or more, 0.15% or more, 0.2% or more, 0.25% or more, 0.3% or more, 0.4% or more, 0.5% or more, 0.75% or more, 1% or more, 1.25% or more, 1.5% or more, 1.75% or more, 2% or more, 2.5% or more, 3% or more, 3.5% or more, 4% or more, 4.5% or more, 5% or more, 5.5% or more, 6% or more, 6.5% or more, 7% or more, 7.5% or more, 8% or more, 8.5% or more, or 9% or more). In some examples, the primary foaming surfactant can be present in an amount of 10% or less by weight, based on the total weight of the aqueous foam precursor composition (e.g., 9.5% or less, 9% or less, 8.5% or less, 8% or less, 7.5% or less, 7% or less, 6.5% or less, 6% or less, 5.5% or less, 5% or less, 4.5% or less, 4% or less, 3.5% or less, 3% or less, 2.5% or less, 2% or less, 1.75% or less, 1.5% or less, 1.25% or less, 1% or less, 0.75% or less, 0.5% or less, 0.4% or less, 0.3% or less, 0.25% or less, 0.2% or less, 0.15% or less, or 0.1% or less).

The amount of primary surfactant present can range from any of the minimum values described above to any of the maximum values described above. For example, the primary foaming surfactant can be present in an amount of from 0.01% to 10% by weight, based on the total weight of the aqueous foam precursor composition (e.g., from 0.01% to 5%, from 5% to 10%, from 0.01% to 2%, from 2% to 4%, from 4% to 6%, from 6% to 8%, from 8% to 10%, from 0.01% to 8%, from 0.01% to 6%, from 0.01% to 4%, or from 0.1% to 2%).

In some examples, the primary foaming surfactant can comprise an anionic surfactant. Suitable anionic surfactants include a hydrophobic tail that comprises from 6 to 60 carbon atoms. In some embodiments, the anionic surfactant can include a hydrophobic tail that comprises at least 6 carbon atoms (e.g., at least 7 carbon atoms, at least 8 carbon atoms, at least 9 carbon atoms, at least 10 carbon atoms, at least 11 carbon atoms, at least 12 carbon atoms, at least 13 carbon atoms, at least 14 carbon atoms, at least 15 carbon atoms, at least 16 carbon atoms, at least 17 carbon atoms, at least 18 carbon atoms, at least 19 carbon atoms, at least 20 carbon atoms, at least 21 carbon atoms, at least 22 carbon atoms, at least 23 carbon atoms, at least 24 carbon atoms, at least 25 carbon atoms, at least 26 carbon atoms, at least 27 carbon atoms, at least 28 carbon atoms, at least 29 carbon atoms, at least 30 carbon atoms, at least 31 carbon atoms, at least 32 carbon atoms, at least 33 carbon atoms, at least 34 carbon atoms, at least 35 carbon atoms, at least 36 carbon atoms, at least 37 carbon atoms, at least 38 carbon atoms, at least 39 carbon atoms, at least 40 carbon atoms, at least 41 carbon atoms, at least 42 carbon atoms, at least 43 carbon atoms, at least 44 carbon atoms, at least 45 carbon atoms, at least 46 carbon atoms, at least 47 carbon atoms, at least 48 carbon atoms, at least 49 carbon atoms, at least 50 carbon atoms, at least 51 carbon atoms, at least 52 carbon atoms, at least 53 carbon atoms, at least 54 carbon atoms, at least 55 carbon atoms, at least 56 carbon atoms, at least 57 carbon atoms, at least 58 carbon atoms, or at least 59 carbon atoms). In some embodiments, the anionic surfactant can include a hydrophobic tail that comprises 60 carbon atoms or less (e.g.; 59 carbon atoms or less, 58 carbon atoms or less, 57 carbon atoms or less, 56 carbon atoms or less, 55 carbon atoms or less, 54 carbon atoms or less, 53 carbon atoms or less, 52 carbon atoms or less, 51 carbon atoms or less, 50 carbon atoms or less, 49 carbon atoms or less, 48 carbon atoms or less, 47 carbon atoms or less, 46 carbon atoms or less, 45 carbon atoms or less, 44 carbon atoms or less, 43 carbon atoms or less, 42 carbon atoms or less, 41 carbon atoms or less, 40 carbon atoms or less, 39 carbon atoms or less, 38 carbon atoms or less, 37 carbon atoms or less, 36 carbon atoms or less, 35 carbon atoms or less, 34 carbon atoms or less, 33 carbon atoms or less, 32 carbon atoms or less, 31 carbon atoms or less, 30 carbon atoms or less, 29 carbon atoms or less, 28 carbon atoms or less, 27 carbon atoms or less, 26 carbon atoms or less, 25 carbon atoms or less, 24 carbon atoms or less, 23 carbon atoms or less, 22 carbon atoms or less, 21 carbon atoms or less, 20 carbon atoms or less, 19 carbon atoms or less, 18 carbon atoms or less, 17 carbon atoms or less, 16 carbon atoms or less, 15 carbon atoms or less, 14 carbon atoms or less, 13 carbon atoms or less, 12 carbon atoms or less, 11 carbon atoms or less, 10 carbon atoms or less, 9 carbon atoms or less, 8 carbon atoms or less, or 7 carbon atoms or less).

The anionic surfactant can include a hydrophobic tail that comprises a number of carbon atoms ranging from any of the minimum values described above to any of the maximum values described above. For example, in some embodiments, the anionic surfactant can comprise a hydrophobic tail comprising from 6 to 15, from 16 to 30, from 31 to 45, from 46 to 60, from 6 to 25, from 26 to 60, from 6 to 30, from 31 to 60, from 6 to 32, from 33 to 60, from 6 to 12, from 13 to 22, from 23 to 32, from 33 to 42, from 43 to 52, from 53 to 60, from 6 to 10, from 10 to 15, from 16 to 25, from 26 to 35, or from 36 to 45 carbon atoms. The hydrophobic (lipophilic) carbon tail may be a straight chain, branched chain, and/or may comprise cyclic structures. The hydrophobic carbon tail may comprise single bonds, double bonds, triple bonds, or any combination thereof. In some embodiments, the anionic surfactant can include a branched hydrophobic tail derived from Guerbet alcohols. The hydrophilic portion of the anionic surfactant can comprise, for example, one or more sulfate moieties (e.g., one, two, or three sulfate moieties), one or more sulfonate moieties (e.g., one, two, or three sulfonate moieties), one or more sulfosuccinate moieties (e.g., one, two, or three sulfosuccinate moieties), one or more carboxylate moieties (e.g., one, two, or three carboxylate moieties), or any combination thereof.

In some embodiments, the anionic surfactant can comprise, for example a sulfonate, a disulfonate, a polysulfonate, a sulfate, a disulfate, a polysulfate, a sulfosuccinate, a disulfosuccinate, a polysulfosuccinate, a carboxylate, a dicarboxylate, a polycarboxylate, or any combination thereof. In some examples, the anionic surfactant can comprise an internal olefin sulfonate (IOS), an isomerized olefin sulfonate, an alfa olefin sulfonate (AOS), an alkyl aryl sulfonate (AAS), a xylene sulfonate, an alkane sulfonate, a petroleum sulfonate, an alkyl diphenyl oxide (di)sulfonate, an alcohol sulfate, an alkoxy sulfate, an alkoxy sulfonate, an alkoxy carboxylate, an alcohol phosphate, or an alkoxy phosphate. In some embodiments, the anionic surfactant can comprise an alkoxy carboxylate surfactant, an alkoxy sulfate surfactant, an alkoxy sulfonate surfactant, an alkyl sulfonate surfactant, an aryl sulfonate surfactant, or an olefin sulfonate surfactant. In some embodiments, the anionic surfactant can comprise an olefin sulfonate surfactant (e.g., internal olefin sulfonate, isomerized olefin sulfonate, or any combination thereof). In some embodiments, the anionic surfactant can comprise a C14-C16 olefin sulfonate surfactant. In some embodiments, the anionic surfactant can comprise an isomerized C14-C16 olefin sulfonate surfactant, isomerized C16-C18 olefin sulfonate surfactant, isomerized 20-24 olefin sulfonate surfactant or isomerized C23-C28 olefin sulfonate surfactant.

An “alkoxy carboxylate surfactant” or “alkoxy carboxylate” refers to a compound having an alkyl or aryl attached to one or more alkoxylene groups (typically —CH₂—CH(ethyl)-O—, —CH₂—CH(methyl)-O—, or —CH₂—CH₂—O—) which, in turn is attached to —COO⁻ or acid or salt thereof including metal cations such as sodium. In embodiments, the alkoxy carboxylate surfactant can be defined by the formulae below:

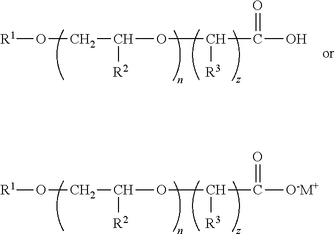

wherein R¹ is substituted or unsubstituted C6-C36 alkyl or substituted or unsubstituted aryl; R² is, independently for each occurrence within the compound, hydrogen or unsubstituted C1-C6 alkyl; R³ is independently hydrogen or unsubstituted C1-C6 alkyl, n is an integer from 0 to 175, z is an integer from 1 to 6 and M⁺ is a monovalent, divalent or trivalent cation. In some of these embodiments, R¹ can be an unsubstituted linear or branched C6-C36 alkyl.

In certain embodiments, the alkoxy carboxylate can be a C6-C32:PO(0-65):EO(0-100)-carboxylate (i.e., a C6-C32 hydrophobic tail, such as a branched or unbranched C6-C32 alkyl group, attached to from 0 to 65 propyleneoxy groups (—CH₂—CH(methyl)-O— linkers), attached in turn to from 0 to 100 ethyleneoxy groups (—CH₂—CH₂—O— linkers), attached in turn to —COO⁻ or an acid or salt thereof including metal cations such as sodium). In certain embodiments, the alkoxy carboxylate can be a branched or unbranched C6-C30:PO(30-40):EO(25-35)-carboxylate. In certain embodiments, the alkoxy carboxylate can be a branched or unbranched C6-C12:PO(30-40):EO(25-35)-carboxylate. In certain embodiments, the alkoxy carboxylate can be a branched or unbranched C6-C30:EO(8-30)-carboxylate.

An “alkoxy sulfate surfactant” or “alkoxy sulfate” refers to a surfactant having an alkyl or aryl attached to one or more alkoxylene groups (typically —CH₂—CH(ethyl)-O—, —CH₂—CH(methyl)-O—, or —CH₂—CH₂—O—) which, in turn is attached to —SO₃⁻ or acid or salt thereof including metal cations such as sodium. In some embodiment, the alkoxy sulfate surfactant has the formula R—(BO)ₑ—(PO)_{f}-(EO)_{g}—SO₃⁻ or acid or salt (including metal cations such as sodium) thereof, wherein R is C6-C32 alkyl, BO is —CH₂—CH(ethyl)-O—, PO is —CH₂—CH(methyl)-O—, and EO is —CH₂—CH₂—O—. The symbols e, f and g are integers from 0 to 50 wherein at least one is not zero.

In embodiments, the alkoxy sulfate surfactant can be an aryl alkoxy sulfate surfactant. The aryl alkoxy surfactant can be an alkoxy surfactant having an aryl attached to one or more alkoxylene groups (typically —CH₂—CH(ethyl)-O—, —CH₂—CH(methyl)-O—, or —CH₂—CH₂—O—) which, in turn is attached to —SO₃⁻ or acid or salt thereof including metal cations such as sodium.

An “alkyl sulfonate surfactant” or “alkyl sulfonate” refers to a compound that includes an alkyl group (e.g., a branched or unbranched C6-C32 alkyl group) attached to —SO₃⁻ or acid or salt thereof including metal cations such as sodium.

An “aryl sulfate surfactant” or “aryl sulfate” refers to a compound having an aryl group attached to —O—SO₃⁻ or acid or salt thereof including metal cations such as sodium. An “aryl sulfonate surfactant” or “aryl sulfonate” refers to a compound having an aryl group attached to —SO₃⁻ or acid or salt thereof including metal cations such as sodium. In some cases, the aryl group can be substituted, for example, with an alkyl group (an alkyl aryl sulfonate).

An “internal olefin sulfonate,” “isomerized olefin sulfonate,” or “IOS” refers to an unsaturated hydrocarbon compound comprising at least one carbon-carbon double bond and at least one SO₃⁻ group, or a salt thereof. As used herein, a “C20-C28 internal olefin sulfonate,” “a C20-C28 isomerized olefin sulfonate,” or “C20-C28 IOS” refers to an IOS, or a mixture of IOSs with an average carbon number of 20 to 28, or of 23 to 25. The C20-C28IOS may comprise at least 80% of IOS with carbon numbers of 20 to 28, at least 90% of IOS with carbon numbers of 20 to 28, or at least 99% of IOS with carbon numbers of 20 to 28. As used herein, a “C15-C18 internal olefin sulfonate,” “C15-C18 isomerized olefin sulfonate,” or “C15-C18 IOS” refers to an IOS or a mixture of IOSs with an average carbon number of 15 to 18, or of 16 to 17. The C15-C18IOS may comprise at least 80% of IOS with carbon numbers of 15 to 18, at least 90% of IOS with carbon numbers of 15 to 18, or at least 99% of IOS with carbon numbers of 15 to 18. The internal olefin sulfonates or isomerized olefin sulfonates may be alpha olefin sulfonates, such as an isomerized alpha olefin sulfonate. The internal olefin sulfonates or isomerized olefin sulfonates may also comprise branching. In certain embodiments, C15-18 IOS may be added to the single-phase liquid surfactant package when the LPS injection fluid is intended for use in high temperature unconventional subterranean formations, such as formations above 130° F. (approximately 55° C.). The IOS may be at least 20% branching, 30% branching, 40% branching, 50% branching, 60% branching, or 65% branching. In some embodiments, the branching is between 20-98%, 30-90%, 40-80%, or around 65%. Examples of internal olefin sulfonates and the methods to make them are found in U.S. Pat. No. 5,488,148, U.S. Patent Application Publication 2009/0112014, and SPE 129766, all incorporated herein by reference.

In embodiments, the anionic surfactant can be a disulfonate, alkyldiphenyloxide disulfonate, mono alkyldiphenyloxide disulfonate, di alkyldiphenyloxide disulfonate, or a di alkyldiphenyloxide monosulfonate, where the alkyl group can be a C6-C36 linear or branched alkyl group. In embodiments, the anionic surfactant can be an alkylbenzene sulfonate or a dibenzene disufonate. In embodiments, the anionic surfactant can be benzenesulfonic acid, decyl(sulfophenoxy)-disodium salt; linear or branched C6-C36 alkyl:PO(0-65):EO(0-100) sulfate; or linear or branched C6-C36 alkyl:PO(0-65):EO(0-100) carboxylate. In embodiments, the anionic surfactant is an isomerized olefin sulfonate (C6-C30), internal olefin sulfonate (C6-C30) or internal olefin disulfonate (C6-C30). In some embodiments, the anionic surfactant is a Guerbet-PO(0-65)-EO(0-100) sulfate (Guerbet portion can be C6-C36). In some embodiments, the anionic surfactant is a Guerbet-PO(0-65)-EO(0-100) carboxylate (Guerbet portion can be C6-C36). In some embodiments, the anionic surfactant is alkyl PO(0-65) and EO(0-100) sulfonate: where the alkyl group is linear or branched C6-C36. In some embodiments, the anionic surfactant is a sulfosuccinate, such as a dialkylsulfosuccinate. In some embodiments, the anionic surfactant is an alkyl aryl sulfonate (AAS) (e.g. an alkyl benzene sulfonate (ABS)), a C10-C30 internal olefin sulfate (IOS), a petroleum sulfonate, or an alkyl diphenyl oxide (di)sulfonate.

In some examples, the anionic surfactant can comprise a surfactant defined by the formula below:

R¹—R²—R³

wherein R¹ comprises a branched or unbranched, saturated or unsaturated, cyclic or non-cyclic, hydrophobic carbon chain having 6-32 carbon atoms and an oxygen atom linking R¹ and R²; R² comprises an alkoxylated chain comprising at least one oxide group selected from the group consisting of ethylene oxide, propylene oxide, butylene oxide, and any combination thereof; and R³ comprises a branched or unbranched hydrocarbon chain comprising 2-12 carbon atoms and from 2 to 5 carboxylate groups.

In some examples, the anionic surfactant can comprise a surfactant defined by the formula below:

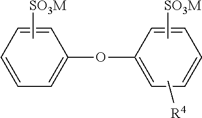

wherein R⁴ is a branched or unbranched, saturated or unsaturated, cyclic or non-cyclic, hydrophobic carbon chain having 6-32 carbon atoms; and M represents a counterion (e.g., Na⁺, K⁺). In some embodiments, R⁴ is a branched or unbranched, saturated or unsaturated, cyclic or non-cyclic, hydrophobic carbon chain having 6-16 carbon atoms.

In some examples, the primary foaming surfactant can comprise a non-ionic surfactant. Suitable non-ionic surfactants include compounds that can be added to increase wettability. In embodiments, the hydrophilic-lipophilic balance (HLB) of the non-ionic surfactant is greater than 10 (e.g., greater than 9, greater than 8, or greater than 7). In some embodiments, the HLB of the non-ionic surfactant is from 7 to 10.

The non-ionic surfactant can comprise a hydrophobic tail comprising from 6 to 60 carbon atoms. In some embodiments, the non-ionic surfactant can include a hydrophobic tail that comprises at least 6 carbon atoms (e.g., at least 7 carbon atoms, at least 8 carbon atoms, at least 9 carbon atoms, at least 10 carbon atoms, at least 11 carbon atoms, at least 12 carbon atoms, at least 13 carbon atoms, at least 14 carbon atoms, at least 15 carbon atoms, at least 16 carbon atoms, at least 17 carbon atoms, at least 18 carbon atoms, at least 19 carbon atoms, at least 20 carbon atoms, at least 21 carbon atoms, at least 22 carbon atoms, at least 23 carbon atoms, at least 24 carbon atoms, at least 25 carbon atoms, at least 26 carbon atoms, at least 27 carbon atoms, at least 28 carbon atoms, at least 29 carbon atoms, at least 30 carbon atoms, at least 31 carbon atoms, at least 32 carbon atoms, at least 33 carbon atoms, at least 34 carbon atoms, at least 35 carbon atoms, at least 36 carbon atoms, at least 37 carbon atoms, at least 38 carbon atoms, at least 39 carbon atoms, at least 40 carbon atoms, at least 41 carbon atoms, at least 42 carbon atoms, at least 43 carbon atoms, at least 44 carbon atoms, at least 45 carbon atoms, at least 46 carbon atoms, at least 47 carbon atoms, at least 48 carbon atoms, at least 49 carbon atoms, at least 50 carbon atoms, at least 51 carbon atoms, at least 52 carbon atoms, at least 53 carbon atoms, at least 54 carbon atoms, at least 55 carbon atoms, at least 56 carbon atoms, at least 57 carbon atoms, at least 58 carbon atoms, or at least 59 carbon atoms). In some embodiments, the non-ionic surfactant can include a hydrophobic tail that comprises 60 carbon atoms or less (e.g., 59 carbon atoms or less, 58 carbon atoms or less, 57 carbon atoms or less, 56 carbon atoms or less, 55 carbon atoms or less, 54 carbon atoms or less, 53 carbon atoms or less, 52 carbon atoms or less, 51 carbon atoms or less, 50 carbon atoms or less, 49 carbon atoms or less, 48 carbon atoms or less, 47 carbon atoms or less, 46 carbon atoms or less, 45 carbon atoms or less, 44 carbon atoms or less, 43 carbon atoms or less, 42 carbon atoms or less, 41 carbon atoms or less, 40 carbon atoms or less, 39 carbon atoms or less, 38 carbon atoms or less, 37 carbon atoms or less, 36 carbon atoms or less, 35 carbon atoms or less, 34 carbon atoms or less, 33 carbon atoms or less, 32 carbon atoms or less, 31 carbon atoms or less, 30 carbon atoms or less, 29 carbon atoms or less, 28 carbon atoms or less, 27 carbon atoms or less, 26 carbon atoms or less, 25 carbon atoms or less, 24 carbon atoms or less, 23 carbon atoms or less, 22 carbon atoms or less, 21 carbon atoms or less, 20 carbon atoms or less, 19 carbon atoms or less, 18 carbon atoms or less, 17 carbon atoms or less, 16 carbon atoms or less, 15 carbon atoms or less, 14 carbon atoms or less, 13 carbon atoms or less, 12 carbon atoms or less, 11 carbon atoms or less, 10 carbon atoms or less, 9 carbon atoms or less, 8 carbon atoms or less, or 7 carbon atoms or less).

The non-ionic surfactant can include a hydrophobic tail that comprises a number of carbon atoms ranging from any of the minimum values described above to any of the maximum values described above. For example, in some embodiments, the non-ionic surfactant can comprise a hydrophobic tail comprising from 6 to 15, from 16 to 30, from 31 to 45, from 46 to 60, from 6 to 25, from 26 to 60, from 6 to 30, from 31 to 60, from 6 to 32, from 33 to 60, from 6 to 12, from 13 to 22, from 23 to 32, from 33 to 42, from 43 to 52, from 53 to 60, from 6 to 10, from 10 to 15, from 16 to 25, from 26 to 35, or from 36 to 45 carbon atoms. In some cases, the hydrophobic tail may be a straight chain, branched chain, and/or may comprise cyclic structures. The hydrophobic carbon tail may comprise single bonds, double bonds, triple bonds, or any combination thereof. In some cases, the hydrophobic tail can comprise an alkyl group, with or without an aromatic ring (e.g., a phenyl ring) attached to it. In some embodiments, the hydrophobic tail can comprise a branched hydrophobic tail derived from Guerbet alcohols.

Example non-ionic surfactants include alkyl aryl alkoxy alcohols, alkyl alkoxy alcohols, or any combination thereof. In embodiments, the non-ionic surfactant may be a mix of surfactants with different length lipophilic tail chain lengths. For example, the non-ionic surfactant may be C9-C11:9EO, which indicates a mixture of non-ionic surfactants that have a lipophilic tail length of 9 carbon to 11 carbon, which is followed by a chain of 9 EOs. The hydrophilic moiety is an alkyleneoxy chain (e.g., an ethoxy (EO), butoxy (BO) and/or propoxy (PO) chain with two or more repeating units of EO, BO, and/or PO). In some embodiments, 1-100 repeating units of EO are present. In some embodiments, 0-65 repeating units of PO are present. In some embodiments, 0-25 repeating units of BO are present. For example, the non-ionic surfactant could comprise 10EO:5PO or 5EO. In embodiments, the non-ionic surfactant may be a mix of surfactants with different length lipophilic tail chain lengths. For example, the non-ionic surfactant may be C9-C11:PO9:EO2, which indicates a mixture of non-ionic surfactants that have a lipophilic tail length of 9 carbon to 11 carbon, which is followed by a chain of 9 POs and 2 EOs. In specific embodiments, the non-ionic surfactant is linear C9-C11:9EO. In some embodiments, the non-ionic surfactant is a Guerbet PO(0-65) and EO(0-100) (Guerbet can be C6-C36); or alkyl PO(0-65) and EO(0-100): where the alkyl group is linear or branched C1-C36. In some examples, the non-ionic surfactant can comprise a branched or unbranched C6-C32:PO(0-65):EO(0-100) (e.g., a branched or unbranched C6-C30:PO(30-40):EO(25-35), a branched or unbranched C6-C12:PO(30-40):EO(25-35), a branched or unbranched C6-30:EO(8-30), or any combination thereof). In some embodiments, the non-ionic surfactant is one or more alkyl polyglucosides.

Examples of suitable primary foaming surfactants are disclosed, for example, in U.S. Pat. Nos. 3,811,504, 3,811,505, 3,811,507, 3,890,239, 4,463,806, 6,022,843, 6,225,267, 7,629,299, 7,770,641, 9,976,072, 8,211, 837, 9,422,469, 9,605,198, and 9,617,464; WIPO Patent Application Nos. WO/2008/079855, WO/2012/027757 and WO/2011/094442; as well as U.S. Patent Application Nos. 2005/0199395, 2006/0185845, 2006/0189486, 2009/0270281, 2011/0046024, 2011/0100402, 2011/0190175, 2007/0191633, 2010/004843, 2011/0201531, 2011/0190174, 2011/0071057, 2011/0059873, 2011/0059872, 2011/0048721, 2010/0319920, 2010/0292110, and 2017/0198202, each of which is hereby incorporated by reference herein in its entirety for its description of example surfactants.

In some examples, the primary foaming surfactant can comprise an anionic surfactant, such as an internal olefin sulfonate, an alcohol ethoxycarboxylate, a disulfonate, an alkylbenzene sulfonate, and any combination thereof.

In some examples, the primary foaming surfactant can comprise a non-ionic surfactant, such as an ethoxylated alcohol. For example, the primary foaming surfactant can comprise an ethoxylated C₁₂-C₁₄ alcohol, such as an ethoxylated C₁₂-C₁₄ branched alcohol.

The ethoxylated C₁₂-C₁₄ alcohol can, for example, comprise 1 ethoxy group or more (e.g., 2 ethoxy groups or more, 3 ethoxy groups or more, 4 ethoxy groups or more, 5 ethoxy groups or more, 6 ethoxy groups or more, 7 ethoxy groups or more, 8 ethoxy groups or more, 9 ethoxy groups or more, 10 ethoxy groups or more, 11 ethoxy groups or more, 12 ethoxy groups or more, 13 ethoxy groups or more, 14 ethoxy groups or more, 15 ethoxy groups or more, 16 ethoxy groups or more, 17 ethoxy groups or more, 18 ethoxy groups or more, 19 ethoxy groups or more, 20 ethoxy groups or more, 21 ethoxy groups or more, 22 ethoxy groups or more, 23 ethoxy groups or more, 24 ethoxy groups or more, 25 ethoxy groups or more, 26 ethoxy groups or more, 27 ethoxy groups or more, or 28 ethoxy groups or more). In some examples, the ethoxylated C₁₂-C₁₄ alcohol can comprise 30 ethoxy groups or less (e.g., 29 ethoxy groups or less, 28 ethoxy groups or less, 27 ethoxy groups or less, 26 ethoxy groups or less, 25 ethoxy groups or less, 24 ethoxy groups or less, 23 ethoxy groups or less, 22 ethoxy groups or less, 21 ethoxy groups or less, 20 ethoxy groups or less, 19 ethoxy groups or less, 18 ethoxy groups or less, 17 ethoxy groups or less, 16 ethoxy groups or less, 15 ethoxy groups or less, 14 ethoxy groups or less, 13 ethoxy groups or less, 12 ethoxy groups or less, 11 ethoxy groups or less, 10 ethoxy groups or less, 9 ethoxy groups or less, 8 ethoxy groups or less, 7 ethoxy groups or less, 6 ethoxy groups or less, 5 ethoxy groups or less, 4 ethoxy groups or less, or 3 ethoxy groups or less).

The number of ethoxy groups in the ethoxylated C₁₂-C₁₄ alcohol can range from any of the minimum values described above to any of the maximum values described above. For example, the ethoxylated C₁₂-C₁₄ alcohol can comprise from 1 to 30 ethoxy groups (e.g., from 1 to 15 ethoxy groups, from 15 to 30 ethoxy groups, from 1 to 10 ethoxy groups, from 10 to 20 ethoxy groups, from 20 to 30 ethoxy groups, from 1 to 25 ethoxy groups, from 5 to 30 ethoxy groups, or from 5 to 25 ethoxy groups).

Viscosity-Modifying Polymers

The aqueous foam precursor compositions can comprise any suitable viscosity-modifying polymer. The viscosity-modifying polymer can comprise a synthetic polymer, a naturally occurring polymer (a biopolymer), or any combination thereof.

In some embodiments, the viscosity-modifying polymer can be stable at reservoir conditions. In this way, foam stability at reservoir conditions can be enhanced. In some embodiments, the viscosity-modifying polymer can be stable at 120° C. in the presence of H₂S, as measured by Hydrogen Sulfide Stability Test Method 1.

In some examples, the viscosity-modifying polymer can comprise a synthetic polymer. Examples of suitable synthetic polymers include polyacrylamides, such as partially hydrolyzed polyacrylamides (HPAMs or PHPAs), and hydrophobically-modified associative polymers (APs). Other examples include co-polymers of polyacrylamide (PAM) and one or both of 2-acrylamido 2-methylpropane sulfonic acid (and/or sodium salt) commonly referred to as AMPS (also more generally known as acrylamido tertiobutyl sulfonic acid or ATBS), N-vinyl pyrrolidone (NVP), and the NVP-based synthetic may be single-, co-, or ter-polymers. In one embodiment, the synthetic polymer is polyacrylic acid (PAA). In one embodiment, the synthetic polymer is polyvinyl alcohol (PVA). Copolymers may be made of any combination or mixture above, for example, a combination of NVP and ATBS.

In some examples, the viscosity-modifying polymer can comprise a synthetic polymer, such as hydrolyzed polyacrylamide (HPAM), N-vinylpyrrolidone (NVP), acrylamide tertiary butyl sulfonic acid (ATBS), 2-acrylamido-2-methylpropane sulfonic acid (AMPS), or any combination thereof. In some examples, the viscosity-modifying polymer can comprise a blend of a biopolymer and a synthetic polymer.

In some examples, the viscosity-modifying polymer can comprise a biopolymer, such as a triple-helix forming biopolymer. In some examples, the viscosity-modifying polymer comprises a polysaccharide. In some examples, the viscosity-modifying polymer can be selected from xanthan, guar, a scleroglucan, a schizophyllan, hydroxyethyl cellulose (HEC), or any combination thereof.

The viscosity-modifying polymer can, for example, be present in an amount of 0.01% or more by weight, based on the total weight of the aqueous foam precursor composition (e.g., 0.05% or more, 0.1% or more, 0.15% or more, 0.2% or more, 0.25% or more, 0.3% or more, 0.35% or more, 0.4% or more, 0.45% or more, 0.5% or more, 0.55% or more, 0.6% or more, 0.65% or more, 0.7% or more, 0.75% or more, 0.8% or more, 0.85% or more, or 0.9% or more). In some examples, the viscosity-modifying polymer can be present in an amount of 3% or less, 2% or less, 1% or less by weight, based on the total weight of the aqueous foam precursor composition (e.g., 2.95% or less, 2.5% or less, 2.25% or less, 1.75% or less, 1.5% or less, 1.25% or less, 0.95% or less, 0.9% or less, 0.85% or less, 0.8% or less, 0.75% or less, 0.7% or less, 0.65% or less, 0.6% or less, 0.55% or less, 0.5% or less, 0.45% or less, 0.4% or less, 0.35% or less, 0.3% or less, 0.25% or less, 0.2% or less, 0.15% or less, or 0.1% or less). The amount of the viscosity-modifying polymer present can range from any of the minimum values described above to any of the maximum values described above. For example, the viscosity-modifying polymer can be present in an amount of from 0.01% to 3% by weight based on the total weight of the aqueous foam precursor composition, from 0.1% to 2% by weight based on the total weight of the aqueous foam precursor composition, from 0.01% to 1% by weight, based on the total weight of the aqueous foam precursor composition (e.g., from 0.01% to 1.5%, from 0.01% to 1.75%, from 0.01% to 2.5%, from 0.01% to 2.75%, from 0.5% to 1.5%, from 0.5% to 1.75%, from 0.5% to 2.25%, from 0.5% to 2.5%, from 0.5% to 2.75%, from 1% to 1.5%, from 1% to 1.75%, from 1% to 2.25%, from 1% to 2.5%, from 1% to 2.75%, from 1.5% to 2.5%, from 1.5% to 2.75%, from 2% to 3%, from 0.01% to 0.5%, from 0.5% to 1%, from 0.01% to 0.2%, from 0.2% to 0.4%, from 0.4% to 0.6%, from 0.6% to 0.8%, from 0.8% to 1%, from 0.01% to 0.9%, from 0.1% to 1%, from 0.1% to 0.9%, or from 0.01% to 0.75%).

Foam Stabilizers

The aqueous foam precursor compositions can comprise any suitable foam stabilizer. Examples of suitable foam stabilizers can include, for example, fluorosurfactants, crosslinkers, particulate stabilizers, or any combination thereof.

In some embodiments, the aqueous foam precursor compositions can comprise a fluorosurfactant. Fluorosurfactants are surfactants that include at least one fluorine atom. Examples of fluorosurfactants include perfluoroalkylethyl phosphates, perfluoroalkylethyl betaines, fluoroaliphatic amine oxides, fluoroaliphatic sodium sulfosuccinates, fluoroaliphatic stearate esters, fluoroaliphatic phosphate esters, fluoroaliphatic quaternaries, fluoroaliphatic polyoxyethylenes, and the like, and mixtures thereof.

In some examples, the fluorosurfactant can comprise a charged species, i.e. the fluorosurfactant can be an anionic, cationic, or zwitterionic fluorosurfactant. Examples of fluorosurfactants containing a charged species include perfluoroalkylethyl phosphates, perfluoroalkylethyl betaines, fluoroaliphatic amine oxides, fluoroaliphatic sodium sulfosuccinates, fluoroaliphatic phosphate esters, and fluoroaliphatic quaternaries. Specific examples of fluorosurfactants include DEA-C8-18 perfluoroalkylethyl phosphate, TEA-C8-18 perfluoroalkylethyl phosphate, NH₄—C8-18 perfluoroalkylethyl phosphate, and C8-18 perfluoroalkylethyl betaine.

In some embodiments, the fluorosurfactant can be a compound the formula [F₃CF₂C— (CF₂CF₂)ₓ—CH₂CH₂—O—P₂O₃]⁻[R¹]⁺ where [R¹]⁺ includes DEA, TEA, NH₄, or betaine, and where x is an integer from about 4 to about 18.

In some embodiments, the fluorosurfactant can comprise a fluoroaliphatic sulfosuccinate, a fluoroaliphatic sulfonate, an ethoxylated fluorinated alcohol, or any combination thereof.

In some embodiments, the fluorosurfactant can be present in an amount of 0.01% or more by weight, based on the total weight of the aqueous foam precursor composition (e.g., 0.05% or more, 0.1% or more, 0.15% or more, 0.2% or more, 0.25% or more, 0.3% or more, 0.35% or more, 0.4% or more, 0.45% or more, 0.5% or more, 0.6% or more, 0.7% or more, 0.8% or more, 0.9% or more, 1% or more, 1.25% or more, 1.5% or more, 1.75% or more, 2% or more, 2.5% or more, 3% or more, 3.5% or more, 4% or more, 4.5% or more, 5% or more, 5.5% or more, 6% or more, 6.5% or more, 7% or more, 7.5% or more, 8% or more, 8.5% or more, or 9% or more). In embodiments examples, the fluorosurfactant can be present in in an amount of 10% or less by weight, based on the total weight of the aqueous foam precursor composition (e.g., 9.5% or less, 9% or less, 8.5% or less, 8% or less, 7.5% or less, 7% or less, 6.5% or less, 6% or less, 5.5% or less, 5% or less, 4.5% or less, 4% or less, 3.5% or less, 3% or less, 2.5% or less, 2% or less, 1.75% or less, 1.5% or less, 1.25% or less, 1% or less, 0.9% or less, 0.8% or less, 0.7% or less, 0.6% or less, 0.5% or less, 0.45% or less, 0.4% or less, 0.35% or less, 0.3% or less, 0.25% or less, 0.2% or less, 0.15% or less, or 0.1% or less).

The amount of fluorosurfactant present can range from any of the minimum values described above to any of the maximum values described above. For example, the fluorosurfactant can be present in an amount of from 0.01% to 10% by weight, based on the total weight of the aqueous foam precursor composition (e.g., from 0.01% to 5%, from 5% to 10%, from 0.01% to 2%, from 2% to 4%, from 4% to 6%, from 6% to 8%, from 8% to 10%, from 0.01% to 8%, from 0.01% to 6%, from 0.01% to 4%, from 0.01% to 1%, from 0.01% to 0.5%, or from 0.01% to 0.2%).

In some embodiments, the aqueous foam precursor compositions can comprise a crosslinker. Suitable crosslinkers are known in the art and can be selected based on a number of factors including the identity of the viscosity-modifying polymer. Examples of suitable crosslinking agents include borate crosslinking agents, Zr crosslinking agents, Ti crosslinking agents, Al crosslinking agents, organic crosslinkers (e.g., malonate, polyethyleneimine), and any combination thereof.

In some examples, the foam stabilizer can comprise a crosslinker and the viscosity-modifying polymer and the crosslinker can be present in a weight ratio of 10:1 or more (e.g., 15:1 or more, 20:1 or more, 25:1 or more, 30:1 or more, 35:1 or more, 40:1 or more, 45:1 or more, 50:1 or more, 55:1 or more, 60:1 or more, 65:1 or more, 70:1 or more, 75:1 or more, 80:1 or more, 85:1 or more, or 90:1 or more). In some examples, the viscosity-modifying polymer and the crosslinker can be present in a weight ratio of 100:1 or less (e.g., 95:1 or less, 90:1 or less, 85:1 or less, 80:1 or less, 75:1 or less, 70:1 or less, 65:1 or less, 60:1 or less, 55:1 or less, 50:1 or less, 45:1 or less, 40:1 or less, 35:1 or less, 30:1 or less, 25:1 or less, or 20:1 or less).

The weight ratio at which the viscosity-modifying polymer and the crosslinker are present can range from any of the minimum values described above to any of the maximum values described above. For example, the viscosity-modifying polymer and the crosslinker can be present in a weight ratio of from 10:1 to 100:1 (e.g., from 10:1 to 55:1, from 55:1 to 100:1, from 10:1 to 40:1, from 40:1 to 70:1, from 70:1 to 100:1, from 20:1 to 100:1, from 10:1 to 90:1, from 20:1 to 90:1, from 10:1 to 75:1, or from 25:1 to 50:1).

In some embodiments, the aqueous foam precursor compositions can comprise a particulate stabilizer (e.g., nanoparticles or microparticles). Examples of suitable nanoparticles and microparticles are known in the art, and include, for example, nickel oxide, alumina, silica (surface-modified), a silicate, iron oxide (Fe₃O₄), titanium oxide, impregnated nickel on alumina, synthetic clay, natural clay, iron zinc sulfide, magnetite, iron octanoate, or any combination thereof. In some examples, the foamed composition can further include a particulate stabilizer comprising a synthetic clay, a natural clay, or any combination thereof, such as attapulgite, bentonite, or any combination thereof.

Other examples of suitable nanoparticles are described, for example, in U.S. Pat. No. 10,266,750, which is hereby incorporated by reference in its entirety.

In some examples, the foamed composition can include a particulate stabilizer having an average particle size of 100 nanometers (nm) or more (e.g., 200 nm or more, 300 nm or more, 400 nm or more, 500 nm or more, 750 nm or more, 1 micrometer (micron, μm) or more, 2 μm or more, 3 μm or more, 4 μm or more, 5 μm or more, 10 μm or more, 15 μm or more, or 20 μm or more). In some examples, the particulate stabilizer can have an average particle size of 25 μm or less (e.g., 20 μm or less, 15 μm or less, 10 μm or less, 5 μm or less, 4 μm or less, 3 μm or less, 2 μm or less, 1 μm or less, 750 nm or less, 500 nm or less, 400 nm or less, or 300 nm or less). The average particle size of the particulate stabilizer can range from any of the minimum values described above to any of the maximum values described above. For example, the particulate stabilizer can have an average particle size of from 100 nm to 25 μm (e.g., from 100 nm to 10 μm, from 100 nm to 5 μm, from 100 nm to 100 μm, from 100 μm to 500 μm, from 100 nm to 200 μm, from 100 nm to 150 μm, from 100 nm to 100 μm, from 100 nm to 50 μm, or from 100 nm to 10 μm).

The foam stabilizer can, for example, be present in an amount of 0.01% or more by weight, based on the total weight of the aqueous foam precursor composition (e.g., 0.05% or more, 0.1% or more, 0.15% or more, 0.2% or more, 0.25% or more, 0.3% or more, 0.35% or more, 0.4% or more, 0.45% or more, 0.5% or more, 0.6% or more, 0.7% or more, 0.8% or more, 0.9% or more, 1% or more, 1.25% or more, 1.5% or more, 1.75% or more, 2% or more, 2.5% or more, 3% or more, 3.5% or more, 4% or more, 4.5% or more, 5% or more, 5.5% or more, 6% or more, 6.5% or more, 7% or more, 7.5% or more, 8% or more, 8.5% or more, or 9% or more). In some examples, the foam stabilizer can be present in an amount of 10% or less by weight, based on the total weight of the aqueous foam precursor composition (e.g., 9.5% or less, 9% or less, 8.5% or less, 8% or less, 7.5% or less, 7% or less, 6.5% or less, 6% or less, 5.5% or less, 5% or less, 4.5% or less, 4% or less, 3.5% or less, 3% or less, 2.5% or less, 2% or less, 1.75% or less, 1.5% or less, 1.25% or less, 1% or less, 0.9% or less, 0.8% or less, 0.7% or less, 0.6% or less, 0.5% or less, 0.45% or less, 0.4% or less, 0.35% or less, 0.3% or less, 0.25% or less, 0.2% or less, 0.15% or less, or 0.1% or less). The amount of foam stabilizer present can range from any of the minimum values described above to any of the maximum values described above. For example, the foam stabilizer can be present in an amount of from 0.01% to 10% by weight, based on the total weight of the aqueous foam precursor composition (e.g., from 0.01% to 5%, from 5% to 10%, from 0.01% to 2%, from 2% to 4%, from 4% to 6%, from 6% to 8%, from 8% to 10%, from 0.01% to 8%, from 0.01% to 6%, from 0.01% to 4%, from 0.01% to 1%, from 0.01% to 0.5%, or from 0.01% to 0.2%).

Water

The water present in the aqueous foam precursor composition can comprise any type of water, treated or untreated, and can vary in salt content. For example, sea water, brackish water, flowback or produced water, wastewater (e.g., reclaimed or recycled), brine (e.g., reservoir or synthetic brine), fresh water (e.g., fresh water comprises <1,000 ppm TDS water), slickwater, or any combination thereof. In some embodiments, the salinity of the water can be at least 5,000 ppm TDS (e.g., at least 25,000 ppm TDS, at least 50,000 ppm TDS, at least 75,000 ppm TDS, at least 100,000 ppm TDS, at least 125,000 ppm TDS, at least 150,000 ppm TDS, at least 175,000 ppm TDS, at least 200,000 ppm TDS, at least 225,000 ppm TDS, at least 250,000 ppm TDS, or at least 275,000 ppm TDS). In some embodiments, the salinity of the water can be 300,000 ppm TDS or less (e.g., 275,000 ppm TDS or less, 250,000 ppm TDS or less, 225,000 ppm TDS or less, 200,000 ppm TDS or less, 175,000 ppm TDS or less, 150,000 ppm TDS or less, 125,000 ppm TDS or less, 100,000 ppm TDS or less, 75,000 ppm TDS or less, 50,000 ppm TDS or less, or 25,000 ppm TDS or less). The salinity of the water can range from any of the minimum values described above to any of the maximum values described above. For example; in some embodiments, the salinity of the water can be from 5,000 ppm TDS to 300,000 ppm TDS (e.g., from 100,000 ppm to 300,000 ppm TDS).

In some examples, the aqueous foam precursor composition can comprise 50% or more by weight water, based on the total weight of the aqueous foam precursor composition (e.g., 55% or more, 60% or more, 65% or more, 70% or more, 75% or more, 80% or more, 85% or more, 90% or more, or 95% or more). In some examples, the aqueous foam precursor composition can comprise less than 100% by weight water, based on the total weight of the aqueous foam precursor composition (e.g., 95% or less, 90% or less, 85% or less, 80% or less, 75% or less, 70% or less, 65% or less, 60% or less, or 55% or less).

The amount of water present can range from any of the minimum values described above to any of the maximum values described above. For example, the aqueous foam precursor composition can comprise from 50% to less than 100% by weight water based on the total weight of the aqueous foam precursor composition (e.g., from 50% to 75%, from 75% to 100%, from 50% to 60%, from 60% to 70%, from 70% to 80%, from 80% to 90%, from 90% to less than 100%, from 50% to 90%, from 60% to less than 100%, from 60% to 90%, from 65% to 85%, or from 70% to 80%).

Co-Surfactants

The aqueous foam precursor compositions can, in some examples, further comprise one or more co-surfactants, such as two or more co-surfactants. The one or more co-surfactants can, for example, comprise one or more anionic surfactants, one or more cationic surfactants, one or more non-ionic surfactants, one or more zwitterionic surfactants, or any combination thereof.

In some embodiments, the one or more co-surfactants can each be stable at reservoir conditions. In this way, foam stability at reservoir conditions can be enhanced. In some embodiments, the one or more co-surfactants can each be stable at 120° C. in the presence of H₂S, as measured by Hydrogen Sulfide Stability Test Method 1.

In some examples, the one or more co-surfactants can each be a water-soluble surfactant.

In some examples, the one or more co-surfactants can comprise one or more anionic surfactants. Examples of suitable anionic surfactants include those listed above as possible primary surfactants. The one or more anionic surfactants can, for example, be selected form the group consisting of an internal olefin sulfonate, an alcohol ethoxycarboxylate, a disulfonate, an alkylbenzene sulfonate, or any combination thereof.

In some examples, the one or more co-surfactants can comprise one or more non-ionic surfactants. Examples of suitable non-ionic surfactants include those listed above as possible primary surfactants. In some embodiments, the one or more co-surfactants can comprise an ethoxylated alcohol. For example, the one or more co-surfactants can comprise an ethoxylated C₁₂-C₁₄ alcohol, such as an ethoxylated C₁₂-C₁₄ branched alcohol. The ethoxylated C₁₂-C₁₄ alcohol can, for example, comprise from 1 to 30 ethoxy groups.

In some examples, the one or more co-surfactants can comprise one or more cationic surfactants. Example cationic surfactants include surfactant analogous to those described above, except bearing primary, secondary, or tertiary amines, or quaternary ammonium cations, as a hydrophilic head group. In some examples, the one or more co-surfactants can comprise one or more zwitterionic surfactants. “Zwitterionic” or “zwitterion” as used herein refers to a neutral molecule with a positive (or cationic) and a negative (or anionic) electrical charge at different locations within the same molecule. Example zwitterionic surfactants include betains and sultains

The one or more co-surfactants can, for example, be present in an amount of 0.01% or more by weight, based on the total weight of the aqueous foam precursor composition (e.g., 0.05% or more, 0.1% or more, 0.15% or more, 0.2% or more, 0.25% or more, 0.3% or more, 0.4% or more, 0.5% or more, 0.75% or more, 1% or more, 1.25% or more, 1.5% or more, 1.75% or more, 2% or more, 2.5% or more, 3% or more, 3.5% or more, 4% or more, 4.5% or more, 5% or more, 5.5% or more, 6% or more, 6.5% or more, 7% or more, 7.5% or more, 8% or more, 8.5% or more, or 9% or more). In some examples, the one or more co-surfactants can be present in an amount of 10% or less by weight, based on the total weight of the aqueous foam precursor composition (e.g., 9.5% or less, 9% or less, 8.5% or less, 8% or less, 7.5% or less, 7% or less, 6.5% or less, 6% or less, 5.5% or less, 5% or less, 4.5% or less, 4% or less, 3.5% or less, 3% or less, 2.5% or less, 2% or less, 1.75% or less, 1.5% or less, 1.25% or less, 1% or less, 0.75% or less, 0.5% or less, 0.4% or less, 0.3% or less, 0.25% or less, 0.2% or less, 0.15% or less, or 0.1% or less). The amount of one or more co-surfactants present can range from any of the minimum values described above to any of the maximum values described above. For example, the one or more co-surfactants can be present in an amount of from 0.01% to 10% by weight, based on the total weight of the aqueous foam precursor composition (e.g., from 0.01% to 5%, from 5% to 10%, from 0.01% to 2%, from 2% to 4%, from 4% to 6%, from 6% to 8%, from 8% to 10%, from 0.01% to 8%, from 0.01% to 6%, from 0.01% to 4%, or from 0.1% to 2%).

Co-Solvents and Additional Components

In some examples, the aqueous foam precursor compositions can further comprise a co-solvent. Examples of co-solvents include, but are not limited to alcohols, such as lower carbon chain alcohols such as isopropyl alcohol, ethanol, n-propyl alcohol, n-butyl alcohol, sec-butyl alcohol, n-amyl alcohol, sec-amyl alcohol, n-hexyl alcohol, sec-hexyl alcohol and the like; alcohol ethers, polyalkylene alcohol ethers, polyalkylene glycols, poly(oxyalkylene)glycols, poly(oxyalkylene)glycol ethers; ethoxylated phenol, or any other common organic co-solvent or combinations of any two or more co-solvents. In one embodiment, the co-solvent can comprise alkyl ethoxylate (C1-C6)-XEO X=1-30-linear or branched. In some embodiments, the co-solvent can comprise ethylene glycol butyl ether (EGBE), diethylene glycol monobutyl ether (DGBE), triethylene glycol monobutyl ether (TEGBE), ethylene glycol dibutyl ether (EGDE), polyethylene glycol monomethyl ether (mPEG), diethylene glycol, polyethylene glycol (PEG), or any combination thereof. In some embodiments, the co-solvent can comprise ethylene glycol butyl ether (EGBE) and diethylene glycol.

In some embodiments, the co-solvent can be present in the aqueous foam precursor compositions in an amount of 0.01% or more by weight, based on total weight of the foamed composition (e.g., 0.05% or more, 0.1% or more, 0.15% or more, 0.2% or more, 0.25% or more, 0.3% or more, 0.35% or more, 0.4% or more, 0.45% or more, 0.5% or more, 0.6% or more, 0.7% or more, 0.8% or more, 0.9% or more, 1% or more, 1.25% or more, 1.5% or more, 1.75% or more, 2% or more, 2.5% or more; 3% or more, 3.5% or more, 4% or more, 4.5% or more, 5% or more, 5.5% or more, 6% or more; 6.5% or more, 7% or more, 7.5% or more, 8% or more, 8.5% or more, 9% or more, 9.5% or more, 10% or more, 11% or more, 12% or more, 13% or more, 14% or more, 15% or more; 16% or more, 17% or more, 18% or more, 19% or more, 20% or more, 21% or more, 22% or more, 23% or more, or 24% or more). In some embodiments; the co-solvent can be present in the aqueous foam precursor compositions in an amount of 25% or less by weight, based on total weight of the foamed composition (e.g., 24% or less, 23% or less, 22% or less, 21% or less, 20% or less, 19% or less, 18% or less, 17% or less, 16% or less, 15% or less, 14% or less, 13% or less, 12% or less, 11% or less, 10% or less, 9.5% or less, 9% or less, 8.5% or less, 8% or less, 7.5% or less, 7% or less, 6.5% or less, 6% or less, 5.5% or less, 5% or less, 4.5% or less, 4% or less, 3.5% or less, 3% or less, 2.5% or less, 2% or less, 1.75% or less, 1.5% or less, 1.25% or less, 1% or less, 0.9% or less, 0.8% or less, 0.7% or less, 0.6% or less, 0.5% or less, 0.45% or less, 0.4% or less, 0.35% or less, 0.3% or less, 0.25% or less, 0.2% or less, 0.15% or less, or 0.1% or less).

The amount of co-solvent present can range from any of the minimum values described above to any of the maximum values described above. In some embodiments, the co-solvent can be present in the aqueous foam precursor compositions in an amount of from 0.01% to 25% by weight, based on the total weight of the foamed composition (e.g., from 0.01% to 20%, from 0.01% to 15%, from 0.01% to 10%, from 0.01% to 5%, from 0.01% to 1%, from 0.01% to 0.7%, from 0.25% to 0.7%, from 0.1% to 25%, from 0.1% to 10%, or from 0.5% to 5%).

The aqueous foam precursor compositions can further include one or more additional additives, such as an acid, an alkali agent, a chelating agent (e.g., EDTA or a salt thereof), a clay swelling inhibitor (e.g., KCl), a biocide, a scale inhibitor, a breaker, a corrosion inhibitor, a sulfide scavenger, or any combination thereof.

In some embodiments, when measured according to Hydrogen Sulfide Stability Test Method 1, less than 20 mol % of the one or more co-surfactants degrade after aging for 7 days at 120° C. in the presence of 17% H₂S.

The following standard test methods can be utilized to characterize materials and compositions described herein.

Foam Stability Test Method 1: The stability of the aqueous foams at room temperature can be measured using Foam Stability Test Method 1, which was based on the standard method detailed in ASTM D3519-88 (2002), entitled “Standard Test Method for Foam in Aqueous Media (Blender Test)”, which is incorporated by reference herein.

Briefly, 75-100 mL of an aqueous foam precursor composition was blended using a Waring Commercial Blender (model 7011HS-2) at low speed for 10 seconds to generate foam at room temperature. The generated foam was then poured into a 250 mL graduated cylinder at room temperature. The height at time zero was the maximum height the foam achieved. The total foam height was then recorded over time. The height of the foam column (h) was normalized by its initial foam height (h₀). The foam half-life was then measured as the time at which the foam height was half the maximum foam height (h/h₀=0.5).

Foam Stability Test Method 2: The stability of aqueous based foams at elevated temperatures (e.g., 40° C., 50° C., 60° C., 70° C., 80° C., 85° C., 90° C., 100° C., 110° C., or 120° C.), elevated pressures (e.g., 500 psi, 1000 psi, 1500 psi, 2000 psi, 2500 psi, 3000 psi, 3500 psi, 4000 psi, or 4500 psi), in the presence of H₂S (e.g., 10 mol % H₂S, 15 mol % H₂S, 17 mol % H₂S, 20 mol % H₂S, or 25 mol % H₂S), or any combination thereof can be assessed using Foam Stability Test Method 2.

In some embodiments, the foam stability test method 2 can be measured at elevated temperatures of more than 40° C. (e.g., 50° C. or more, 60° C. or more, 70° C. or more, 80° C. or more, 85° C. or more, 90° C. or more, 100° C. or more, 110° C. or more, or 120° C. or more). In some embodiments, the foam stability test method 2 can be measured at elevated temperatures of less than 120° C. (e.g., 110° C. or less, 100° C. or less, 90° C. or less, 85° C. or less, 80° C. or less, 70° C. or less, 60° C. or less, or 50° C. or less). The foam stability test method 2 can be measured at elevated temperatures ranging from any of the minimum values described above to any of the maximum values described above. For example, the foam stability test method 2 can be measured at elevated temperatures ranging from 40° C. to 120° C. (e.g., from 50° C. to 120° C., from 60° C. to 120° C., from 70° C. to 120° C., from 80° C. to 120° C., from 90° C. to 120° C., from 50° C. to 100° C., or from 80° C. to 100° C.).

In some embodiments, the foam stability test method 2 can be measured at elevated pressures of more than 500 psi (e.g., 1000 psi or more, 1500 psi or more, 2000 psi or more, 2500 psi or more, 3000 psi or more, 3500 psi or more, 4000 psi or more, or 4500 psi or more). In some embodiments, the foam stability test method 2 can be measured at elevated pressures of less than 4500 psi (e.g., 4000 psi or less, 3500 psi or less, 3000 psi or less, 2500 psi or less, 2000 psi or less, 1500 psi or less, 1000 psi or less, or 500 psi or less). The foam stability test method 2 can be measured at elevated pressures ranging from any of the minimum values described above to any of the maximum values described above. For example, the foam stability test method 2 can be measured at elevated temperatures ranging from 500 psi to 4500 psi (e.g., from 1000 psi to 4500 psi, from 1500 psi to 4500 psi, from 2000 psi to 4500 psi, from 2500 psi to 4500 psi, from 3000 psi to 4500 psi, from 1000 psi to 4000 psi, from 2000 psi to 4000 psi, or from 3000 psi to 4000 psi. In some embodiments, the foam stability test method 2 can be measured in the presence of H₂S of more than 10 mol % H₂S (e.g., 15 mol % H₂S, 17 mol % H₂S, 20 mol % H₂S, or 25 mol % H₂S). In some embodiments, the foam stability test method 2 can be measured in the presence of H₂S of less than 25 mol % H₂S (e.g., 20 mol % H₂S, 17 mol % H₂S, 15 mol % H₂S, or 10 mol % H₂S). The foam stability test method 2 can be measured in the presence of H₂S ranging from any of the minimum values described above to any of the maximum values described above. For example, the foam stability test method 2 can be measured in the presence of H₂S ranging from 10 mol % H₂S to 25 mol % H₂S (e.g., from 10 mol % H₂S to 20 mol % H₂S, from 10 mol % H₂S to 15 mol % H₂S, from 15 mol % H₂S to 20 mol % H₂S, or from 15 mol % H₂S to 25 mol % H₂S).

Briefly, the tests were performed using a modified PVT DRB cell. Aqueous foam precursor solutions (7-15 mL) were transferred into an inverted PVT DRB vessel (so that the blade was oriented at the bottom of the cell) at the desired pressure and temperature. Next, test gas (e.g., nitrogen) was added at a predetermined aqueous foam precursor solution/gas volume ratio (e.g., 1:4) at the desired pressure and the samples were mixed at maximum speed for 5 minutes. After 5 minutes, mixing was stopped. For stability tests in the presence of H₂S, hydrocarbon gas (e.g., CH₄) containing the desired mol % H₂S was then added to the bottom of the PVT cell. Foam height was recorded as a function of time. The stability of the foam was assessed using a visual cell to visually monitor liquid drainage and foam collapse (lamellae collapse) over time. The height at time zero was the maximum height the foam achieved. The height of the foam column (h) was normalized by its initial foam height (h₀). The foam half-life was then measured as the time at which the foam height was half the maximum foam height (h/h₀=0.5).

Hydrogen Sulfide Stability Test Method 1: Components of the aqueous foam precursor compositions described herein (and by extension the aqueous based foam) were tested for stability for 7 days with 17% H₂S at 120° C. Briefly, the component to be tested was dissolved in an aqueous brine solution having a TDS of from 5,000 ppm to 50,000 ppm and transferred into a test vessel. Next, methane (CH₄) including 17 mol % H₂S was added to the vessel at a defined surfactant/gas volume ratio (e.g., 1:4). Control samples were also prepared which were otherwise identical except for the presence of H₂S.

The samples were then aged for 7 days at the test temperature (120° C.) and pressure (1800 psi). Control samples were placed in an oven at 120° C. without H₂S at ambient pressure. After 7 days, the liquid was removed from the test vessels and visually inspected (including digital photography) for precipitation, phase separation, cloudiness, etc. Next, the test solutions were degassed under nitrogen blanket and the concentration of H₂S in the headspace gas was measured.

Degassed samples were analyzed using high performance liquid chromatography (HPLC) and compared to samples aged at temperature and pressure without H₂S present. The relative amounts of species in the sample following aging were quantified by integration of the peaks visible in the HPLC curve. Surfactants were said to be stable when less than 20 mol % of the surfactant (e.g., less than 15 mol %, less than 10 mol %, less than 5 mol %, less than 2.5 mol %, less than 1 mol %, or less than 0.5 mol %) was determined (by HPLC) to have degraded during aging.

For viscosity-modifying polymers, the viscosity of the test solutions and control solutions were measured using a conventional rheometer and the results were compared to assess degradation. Viscosity-modifying polymers were said to be stable when the test solution (including the viscosity-modifying polymer) had a viscosity within 25% (e.g., within 20%, within 15%, within 10%, or within 5%) of the control solution when viscosities were measured using the identical method.

Example Aqueous Foam Precursor Compositions

Disclosed herein are aqueous foam precursor composition can include: a primary foaming surfactant, wherein when measured according to Hydrogen Sulfide Stability Test Method 1, less than 20 mol % of the primary foaming surfactant degrades after aging for 7 days at 120° C. in the presence of 17% H₂S; a viscosity-modifying polymer; and water. In some embodiments, the composition can further include a foam stabilizer.

Also disclosed herein are aqueous foam precursor compositions comprising: a primary foaming surfactant, wherein the primary foaming surfactant is stable at 120° C. in the presence of H₂S, as measured by Hydrogen Sulfide Stability Test Method 1; a viscosity-modifying polymer, wherein the wherein the viscosity-modifying polymer is stable at 120° C. in the presence of H₂S, as measured by Hydrogen Sulfide Stability Test Method 1; a foam stabilizer (e.g., a fluorosurfactant); and water.

Also disclosed herein are aqueous foam precursor compositions comprising: a primary foaming surfactant; a viscosity-modifying polymer; and water. In some embodiments, the aqueous foam precursor composition can comprise: a primary foaming surfactant (e.g., an olefin sulfonate surfactant, such as a C14-C16 olefin sulfonate surfactant), such as from 0.25% to 1.5% by weight primary foaming surfactant (e.g., from 0.5% to 1%) based on the total weight of the aqueous foam precursor composition; a viscosity-modifying polymer (e.g., a biopolymer such as xanthan), such as from 0.01% to 1% by weight viscosity-modifying polymer (e.g. from 0.01% to 0.5%) based on the total weight of the aqueous foam precursor composition; and water (e.g., brine), such as 50% or more by weight water (e.g., from 65% to 85%) based on the total weight of the aqueous foam precursor composition. In some examples, the primary foaming surfactant can comprise an isomerized C14-C16 olefin sulfonate surfactant.

Also disclosed herein are aqueous foam precursor compositions comprising a primary foaming surfactant; a foam stabilizer; and water. In some embodiments, the aqueous foam precursor composition can comprise: a primary foaming surfactant (e.g., an olefin sulfonate surfactant, such as a C14-C16 olefin sulfonate surfactant), such as from 0.25% to 1.5% by weight primary foaming surfactant (e.g., from 0.5% to 1%) based on the total weight of the aqueous foam precursor composition; a foam stabilizer (e.g., a particulate stabilizer such as a synthetic and/or natural clay, for example attapulgite), such as from 0.01% to 5% by weight foam stabilizer (e.g., from 2% to 3%) based on the total weight of the aqueous foam precursor composition; and water (e.g., brine), such as 50% or more by weight water (e.g., from 65% to 85%) based on the total weight of the aqueous foam precursor composition. In some examples, the primary foaming surfactant can comprise an isomerized C14-C16 olefin sulfonate surfactant.

Also disclosed herein are aqueous foam precursor compositions comprising: a primary foaming surfactant; a co-solvent; and water. In some embodiments, the aqueous foam precursor composition can comprise: a primary foaming surfactant (e.g., an olefin sulfonate surfactant, such as a C14-C16 olefin sulfonate surfactant), such as from 0.25% to 1.5% by weight primary foaming surfactant (e.g., from 0.5% to 1%) based on the total weight of the aqueous foam precursor composition; a co-solvent (e.g., a glycol ether such as ethylene glycol butyl ether, a polyalkylene glycol such as diethylene glycol, or any combination thereof), such as from 0.01% to 1% by weight co-solvent (e.g., from 0.25 to 0.7%) based on the total weight of the aqueous foam precursor composition; and water (e.g., brine), such as 50% or more by weight water (e.g., from 65% to 85%) based on the total weight of the aqueous foam precursor composition. In some examples, the primary foaming surfactant can comprise an isomerized C14-C16 olefin sulfonate surfactant.

Also disclosed herein are aqueous foam precursor compositions comprising: a primary foaming surfactant; a viscosity-modifying polymer; a foam stabilizer; and water. In some embodiments, the aqueous foam precursor composition can comprise: a primary foaming surfactant (e.g., an olefin sulfonate surfactant, such as a C14-C16 olefin sulfonate surfactant), such as from 0.25% to 1.5% by weight primary foaming surfactant (e.g., from 0.5% to 1%) based on the total weight of the aqueous foam precursor composition; a viscosity-modifying polymer (e.g., a biopolymer such as xanthan), such as from 0.01% to 1% by weight viscosity-modifying polymer (e.g. from 0.01% to 0.5%) based on the total weight of the aqueous foam precursor composition; a foam stabilizer (e.g., a particulate stabilizer such as a synthetic and/or natural clay, for example attapulgite), such as from 0.01% to 5% by weight foam stabilizer (e.g., from 2% to 3%) based on the total weight of the aqueous foam precursor composition; and water (e.g., brine), such as 50% or more by weight water (e.g., from 65% to 85%) based on the total weight of the aqueous foam precursor composition. In some examples, the primary foaming surfactant can comprise an isomerized C14-C16 olefin sulfonate surfactant.

Also disclosed herein are aqueous foam precursor compositions comprising: a primary foaming surfactant; a co-solvent; a foam stabilizer; and water. In some embodiments, the aqueous foam precursor composition can comprise: a primary foaming surfactant (e.g., an olefin sulfonate surfactant, such as a C14-C16 olefin sulfonate surfactant), such as from 0.25% to 1.5% by weight primary foaming surfactant (e.g., from 0.5% to 1%) based on the total weight of the aqueous foam precursor composition: a co-solvent (e.g., a glycol ether such as ethylene glycol butyl ether, a polyalkylene glycol such as diethylene glycol, or any combination thereof), such as from 0.01% to 1% by weight co-solvent (e.g., from 0.25 to 0.7%) based on the total weight of the aqueous foam precursor composition; a foam stabilizer (e.g., a particulate stabilizer such as a synthetic and/or natural clay, for example attapulgite), such as from 0.01% to 5% by weight foam stabilizer (e.g., from 2% to 3%) based on the total weight of the aqueous foam precursor composition; and water (e.g., brine), such as 50% or more by weight water (e.g., from 65% to 85%) based on the total weight of the aqueous foam precursor composition. In some examples, the primary foaming surfactant can comprise an isomerized C14-C16 olefin sulfonate surfactant.

Also disclosed herein are aqueous foam precursor compositions comprising: a primary foaming surfactant; a co-solvent; a viscosity-modifying polymer; and water. In some embodiments, the aqueous foam precursor composition can comprise: a primary foaming surfactant (e.g., an olefin sulfonate surfactant, such as a C14-C16 olefin sulfonate surfactant), such as from 0.25% to 1.5% by weight primary foaming surfactant (e.g., from 0.5% to 1%) based on the total weight of the aqueous foam precursor composition; a co-solvent (e.g., a glycol ether such as ethylene glycol butyl ether, a polyalkylene glycol such as diethylene glycol, or any combination thereof), such as from 0.01% to 1% by weight co-solvent (e.g., from 0.25 to 0.7%) based on the total weight of the aqueous foam precursor composition; a viscosity-modifying polymer (e.g., a biopolymer such as xanthan), such as from 0.01% to 1% by weight viscosity-modifying polymer (e.g. from 0.01% to 0.5%) based on the total weight of the aqueous foam precursor composition; and water (e.g., brine), such as 50% or more by weight water (e.g., from 65% to 85%) based on the total weight of the aqueous foam precursor composition. In some examples, the primary foaming surfactant can comprise an isomerized C14-C16 olefin sulfonate surfactant.

Also disclosed herein are aqueous foam precursor compositions comprising: a primary foaming surfactant; a co-solvent; a viscosity-modifying polymer; a foam stabilizer; and water. In some embodiments, the aqueous foam precursor composition can comprise: a primary foaming surfactant (e.g., an olefin sulfonate surfactant, such as a C14-C16 olefin sulfonate surfactant), such as from 0.25% to 1.5% by weight primary foaming surfactant (e.g., from 0.5% to 1%) based on the total weight of the aqueous foam precursor composition; a co-solvent (e.g., a glycol ether such as ethylene glycol butyl ether, a polyalkylene glycol such as diethylene glycol, or any combination thereof), such as from 0.01% to 1% by weight co-solvent (e.g., from 0.25 to 0.7%) based on the total weight of the aqueous foam precursor composition; a viscosity-modifying polymer (e.g., a biopolymer such as xanthan), such as from 0.01% to 1% by weight viscosity-modifying polymer (e.g. from 0.01% to 0.5%) based on the total weight of the aqueous foam precursor composition; a foam stabilizer (e.g., a particulate stabilizer such as a synthetic and/or natural clay, for example attapulgite), such as from 0.01% to 5% by weight foam stabilizer (e.g., from 2% to 3%) based on the total weight of the aqueous foam precursor composition; and water (e.g., brine), such as 50% or more by weight water (e.g., from 65% to 85%) based on the total weight of the aqueous foam precursor composition. In some examples, the primary foaming surfactant can comprise an isomerized C14-C16 olefin sulfonate surfactant.

Aqueous Based Foams

Also disclosed herein are aqueous based foams comprising any of the aqueous foam precursor compositions described herein and an expansion gas. The expansion gas can, for example, comprise nitrogen, natural gas or a hydrocarbon component thereof, helium, CO₂, air, or any combination thereof.

In some embodiments, the aqueous based foam can comprise 30% or expansion gas (e.g., 35% or more, 40% or more, 45% or more, 50% or more, 55% or more, 60% or more, 65% or more, 70% or more, 75% or more, 80% or more, 85% or more, 90% or more, or 95% or more). In some embodiments, the aqueous based foam can comprise 98% expansion gas or less (e.g., 95% or less, 90% or less, 85% or less, 80% or less, 75% or less, 70% or less, 65% or less, 60% or less, 55% or less, 50% or less, 45% or less, or 40% or less). The amount of expansion gas in the aqueous based foam can range from any of the minimum values described above to any of the minimum values described above. In some embodiments, the aqueous based foam can comprise from 30% to 98% expansion gas (e.g., from 30% to 65%, from 65% to 98%, from 30% to 45%, from 45% to 60%, from 60% to 75%, from 75% to 98%, from 40% to 98%, from 50% to 98%, from 30% to 90%, from 40% to 90%, from 60% to 90%, or from 40% to 50%).

The aqueous based foam can, for example, exhibit a density of 2 lbs/gal or more (e.g., 2.5 lbs/gal or more, 3 lbs/gal or more, 3.5 lbs/gal or more, 4 lbs/gal or more; 4.5 lbs/gal or more, 5 lbs/gal or more, 5.5 lbs/gal or more, 6 lbs/gal or more, 6.5 lbs/gal or more, or 7 lbs/gal or more) at room temperature (e.g., ˜20° C.) and pressure (1 atm). In some examples, the aqueous based foam can exhibit a density of 8 lbs/gal or less (e.g., 7.5 lbs/gal or less, 7 lbs/gal or less, 6.5 lbs/gal or less, 6 lbs/gal or less, 5.5 lbs/gal or less, 5 lbs/gal or less, 4.5 lbs/gal or less, 4 lbs/gal or less, 3.5 lbs/gal or less, or 3 lbs/gal or less) at room temperature (e.g., ˜20° C.) and pressure (1 atm). The density exhibited by the aqueous based foam can range from any of the minimum values described above to any of the maximum values described above. For example, the aqueous based foam can exhibit a density of from 2 lbs/gal to 8 lbs/gal (e.g.; from 2 lbs/gal to 5 lbs/gal, from 5 lbs/gal to 8 lbs/gal, from 2 lbs/gal to 4 lbs/gal, from 4 lbs/gal to 6 lbs/gal, from 6 lbs/gal to 8 lbs/gal, from 2 lbs/gal to 7 lbs/gal, from 3 lbs/gal to 8 lbs/gal, or from 3 lbs/gal to 7 lbs/gal) at room temperature (e.g., ˜20° C.) and pressure (1 atm).

In some embodiments, the foamed compositions can be substantially free (e.g., can include less than 1% by weight, less than 0.5% by weight, or less than 0.1% by weight) of proppant particles. In some examples, the foamed composition can be substantially free (e.g., can include less than 5% by weight, less than 1% by weight, less than 0.5% by weight, or less than 0.1% by weight) of particles having a particle size of 5 micrometers (microns, μm) or more, 10 μm or more, 15 μm or more, 20 μm or more, 25 μm or more, 30 μm or more, 40 μm or more, 50 μm or more, 60 μm or more; 70 μm or more, 80 μm or more, 90 μm or more, 100 μm or more, 110 μm or more, 120 μm or more, 130 μm or more, 140 μm or more, 150 μm or more, 175 μm or more, 200 μm or more, 225 μm or more, 250 μm or more, 275 μm or more, 300 μm or more, 350 μm or more, 400 μm or more, or 450 μm or more).

In some embodiments, the foams can have a viscosity of at least 1.5 cP at 25° C. and 1 atm, such as a viscosity of at least 5 cP at 25° C. and 1 atm.

Systems and Methods of Use

The compositions described herein can be used to control the migration of gases from a hydrocarbon formation to the surface during drilling operations. The drilling operations can involve the formation of a wellbore stretching from the surface to a subterranean hydrocarbon-bearing formation. Generally, a wellbore is formed by advancing a drill bit disposed on the bottom of a tubular drill string through the earth to reach the hydrocarbon-bearing formation. During the drilling process, an aqueous drilling fluid is injected through the tubular drill string, where it exits the drill bit and carries cuttings away from the surface of the drill bit.

During the course of a drilling operation, reservoir pressure can fall below bubble point (BBP). Should this occur, reservoir gases (e.g., methane, hydrogen sulfide, carbon dioxide, or any combination thereof) dissolved in liquid hydrocarbons in the formation can precipitate from the liquid hydrocarbons and migrate through the annulus to the surface. The aqueous based foams described herein can be introduced into the annulus to slow or prevent the unwanted migration of gases to the surface through the annulus.

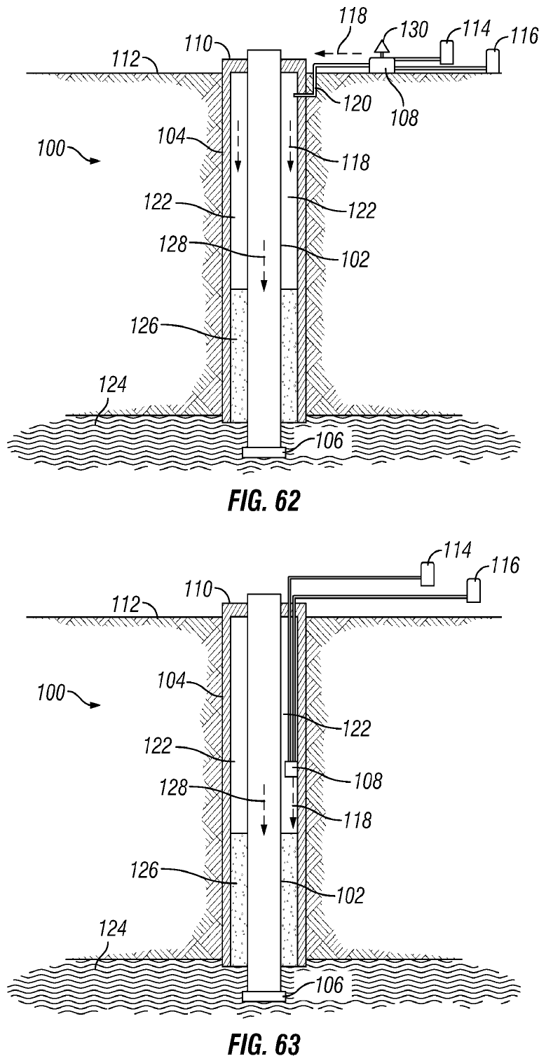

FIG. 62 illustrates an example system and method for forming a wellbore utilizing the aqueous based foam compositions described herein. As shown in FIG. 62, the drilling system (100) can include a tubular drill string (102) disposed within a wellbore (104). The drill string (102) can extend through a wellhead (110) located at the surface (112), at which point it can be operatively engaged with any suitable drilling rig (not shown for clarity). The wellhead (110) can comprise, for example, a rotating control device, a blowout preventer, or any combination thereof, so as to maintain pressure within the wellbore (104) while allowing the drill string (102) to rotate and advance within the wellbore during the course of drilling operations. A drill bit (106) is disposed on the bottom of the tubular string (102). The system can further include a foam generator (108). The foam generator (108) can be fluidly connected to a liquid phase feed source (114, which can convey an aqueous foam precursor solution to the foam generator) and an expansion gas source (116, which can convey an expansion gas to the foam generator).

In some embodiments, the foam precursor is contacted with the expansion gas. In some embodiments, contacting the foam precursor with the expansion gas can comprise shearing or mechanical agitation. The foam generator can comprise any suitable apparatus known conventionally for generating foams. In some examples, the foam generator can include an in-line mixer and a mesh screen configured in series. The in-line mixer can be, for example, a static mixer, which can receive and mix the aqueous foam precursor solution and the expansion gas, and mix the two. The mixture can then pass through one or more mesh screens positioned downstream of the fluid outlet of the in-line mixer. The resulting assembly can effectively shear the aqueous foam precursor in the presence of the expansion gas to form an aqueous based foam. If desired, the dimensions (e.g., the mesh size) of the one or more mesh screens can be varied to influence characteristics of the foam produced by the foam generator. Alternatively, the foam generator can comprise one or more nozzles or ports which inject the expansion gas into the aqueous foam precursor to form a foam. Alternatively, the foam generator can comprise a dynamic mixer to mechanically agitate (e.g., a mechanically stir, shake, vortex, sonicate, and the like) the aqueous foam precursor in the presence of the expansion gas to form a foam.

A pump (130) can be operatively coupled to the foam generator (108) in any suitable fashion to convey foam (118) produced by the foam generator through a foam injection line (120) and into the annulus (122) defined by an outer surface of the tubular string and an inner surface of the wellbore or a casing lining the wellbore. A volume of foam (126) can thus be introduced into the annulus (122), thereby mitigating the migration of reservoir gases from the formation (124) to the surface (112) through the annulus.

As illustrated in FIG. 62, methods for forming a wellbore (104) within a hydrocarbon-bearing formation (124) can comprise drilling the wellbore by injecting an aqueous drilling fluid (128) through a tubular string (102) disposed in the wellbore, the tubular string comprising a drill bit (106) disposed on a bottom thereof, wherein the drilling fluid exits the drill bit and carries cuttings from the drill bit. An aqueous based foam (118) can be introduced into at least a portion of the annulus (122) defined by an outer surface of the tubular string and an inner surface of the wellbore or a casing lining the wellbore. Thereby, a volume of foam (126) can be introduced into the annulus (122) to mitigate the migration of reservoir gases from the formation (124) to the surface (112) through the annulus.

FIG. 63 illustrates a related system and method in which the foam is generated downhole. As shown in FIG. 63, the system can include a foam generator (108) positioned downhole. The foam generator (108) can be located at any point within the annulus. The foam generator (108) can be fluidly connected to a liquid phase feed source (114, which can convey an aqueous foam precursor solution from the surface to the foam generator) and an expansion gas source (116, which can convey an expansion gas from the surface to the foam generator). The foam generator (108) can then generate an aqueous based foam (118) downhole, which subsequently feeds into the annulus (122). A volume of foam (126) can thus be introduced into the annulus (122), thereby mitigating the migration of reservoir gases from the formation (124) to the surface (112) through the annulus

As with the embodiments above, the foam generator can comprise any suitable apparatus known conventionally for generating foams. In some examples, the foam generator can include an in-line mixer and a mesh screen configured in series. The in-line mixer can be, for example, a static mixer, which can receive and mix the aqueous foam precursor solution and the expansion gas, and mix the two. The mixture can then pass through one or more mesh screens positioned downstream of the fluid outlet of the in-line mixer. The resulting assembly can effectively shear the aqueous foam precursor in the presence of the expansion gas to form an aqueous based foam. If desired, the dimensions (e.g., the mesh size) of the one or more mesh screens can be varied to influence characteristics of the foam produced by the foam generator. Alternatively, the foam generator can comprise one or more nozzles or ports which inject the expansion gas into the aqueous foam precursor to form a foam. Alternatively, the foam generator can comprise a dynamic mixer to mechanically agitate (e.g., a mechanically stir, shake, vortex, sonicate, and the like) the aqueous foam precursor in the presence of the expansion gas to form a foam.

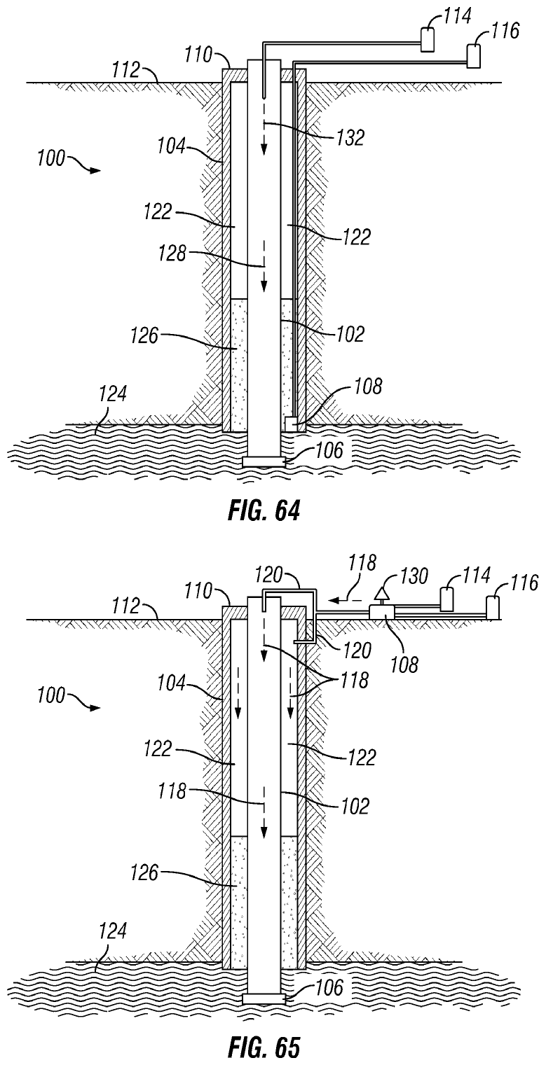

FIG. 64 illustrates a related system and method in which the foam is generated downhole. As shown in FIG. 64, the system can include a foam generator (108) positioned downhole. The foam generator (108) can be fluidly connected to an expansion gas source (116, which can convey an expansion gas from the surface to the foam generator downhole). A liquid phase feed source (114, which can convey an aqueous foam precursor solution to tubular drill string 102). During drilling operations, the aqueous foam precursor solution (132) can be injected through a tubular string (102) disposed in the wellbore, either alone (where the aqueous foam precursor solution functions as a drilling fluid) or in combination with a conventional drilling fluid. The aqueous foam precursor solution (132) exits the drill bit and flows into the formation (124) where it contacts foam generator (108). The foam generator (108) can comprise, for example, a nozzle which injects the expansion gas into the aqueous foam precursor solution to generate an aqueous based foam downhole. A volume of foam (126) can thus be introduced into the annulus (122), thereby mitigating the migration of reservoir gases from the formation (124) to the surface (112) through the annulus. Alternatively, the foam generator can comprise a dynamic mixer to mechanically agitate (e.g., a mechanically stir, shake, vortex, sonicate, and the like) the aqueous foam precursor in the presence of the expansion gas to form a foam.

FIG. 65 illustrates a related system and method for forming a wellbore utilizing the aqueous based foam compositions described herein. In these embodiments, the foam generator (108) can be fluidly connected to both the annulus (122) and the drill string (108), such that foam (118) produced by the foam generator can be injected into the annulus and/or through a tubular string (102) disposed in the wellbore, either alone (where the aqueous foam precursor solution functions as a drilling fluid) or in combination with a conventional drilling fluid. As with the embodiments above, the foam generator can comprise any suitable apparatus known conventionally for generating foams. In some examples, the foam generator can include an in-line mixer and a mesh screen configured in series. The in-line mixer can be, for example, a static mixer, which can receive and mix the aqueous foam precursor solution and the expansion gas, and mix the two. The mixture can then pass through one or more mesh screens positioned downstream of the fluid outlet of the in-line mixer. The resulting assembly can effectively shear the aqueous foam precursor in the presence of the expansion gas to form an aqueous based foam. If desired, the dimensions (e.g., the mesh size) of the one or more mesh screens can be varied to influence characteristics of the foam produced by the foam generator. Alternatively, the foam generator can comprise one or more nozzles or ports which inject the expansion gas into the aqueous foam precursor to form a foam. Alternatively, the foam generator can comprise a dynamic mixer to mechanically agitate (e.g., a mechanically stir, shake, vortex, sonicate, and the like) the aqueous foam precursor in the presence of the expansion gas to form a foam.

In some embodiments described above, the foam can be injected intermittently during the drilling process. In some embodiments, the aqueous based foam may become unstable, and without the introduction of energy, the foam may tend to separate into gas and liquid. Accordingly, when the volume of foam in the annulus becomes unstable, the supply may be replenished by pumping additional foam into the annulus. This may be done either continuously or intermittently, or otherwise as needed. In this way, hydrostatic pressure mitigating the flow of reservoir gases through the annulus can be maintained.

In some embodiments, one or more sensors may be positioned within the wellbore at any predetermined location(s) (depth). The sensor(s) may be communicably coupled (wired or wirelessly) to computer systems which control the foam generator and associated components. The sensor(s) may be configured to monitor conditions within the annulus and communicate detection signals to the computer system for processing. In one or more embodiments, for example, the sensor(s) may be configured to detect the gases (e.g., H2S) and alert the computer system when the gases have reached the sensor, reached a certain concentration, or any combination thereof. Upon detecting the presence of the gases, the computer system may be programmed to trigger operation of the foam generator to introduce (additional) foam into the annulus to suppress the gases.

In the systems and methods described above, various process parameters including the composition of the aqueous foam precursor solution, the relative ratio of aqueous foam precursor solution to expansion gas, and foam introduction rate can be varied to maintain a desired consistency of the foam and/or confine the liberated gases within the wellbore. In such embodiments, one or more pressure sensors may be configured to monitor the pressure within the annulus and send a signal to computer systems which control the foam generator and associated components. When the pressure reaches a predetermined pressure limit, the computer system may be programmed to alter the composition of the aqueous foam precursor solution, the relative ratio of aqueous foam precursor solution to expansion gas, the foam introduction rate, or any combination thereof to bring the pressure within acceptable limits.

The hydrocarbon-bearing formation can comprise any suitable formation. The formation can comprise an unrefined petroleum in contact with a natural solid material. The natural solid material can be rock or regolith. The natural solid material can be a geological formation such as clastics (e.g., sandstone) or carbonates. The natural solid material can be either consolidated or unconsolidated material or mixtures thereof. The hydrocarbon material may be trapped or confined by “bedrock” above or below the natural solid material. The hydrocarbon material may be found in fractured bedrock or porous natural solid material. In other embodiments, the regolith is soil. In other embodiments, the solid material can be, for example, oil sand or tar sands.

In some embodiments, the hydrocarbon-bearing formation can comprise a carbonate formation, a sandstone formation, or any combination thereof. The carbonate formation composed of more than 50% carbonate minerals such as calcite, aragonite (both CaCo₃), and/or dolomite (CaMg(CO₃)₂). In some embodiments, the hydrocarbon-bearing formation can comprise a conventional formation (e.g., the formation can have a permeability of from 25 milliDarcy (mD) to 40,000 mD). In some embodiments, the hydrocarbon-bearing formation can comprise an unconventional formation (e.g., the formation can have a permeability of less than 25 mD).

The hydrocarbon material present in the hydrocarbon-bearing formation can comprise unrefined petroleum. In some embodiments, the unrefined petroleum can be a light oil. A “light oil” as provided herein is an unrefined petroleum with an API gravity greater than 30. In some embodiments, the API gravity of the unrefined petroleum is greater than 30. In other embodiments, the API gravity of the unrefined petroleum is greater than 40. In some embodiments, the API gravity of the unrefined petroleum is greater than 50. In other embodiments, the API gravity of the unrefined petroleum is greater than 60. In some embodiments, the API gravity of the unrefined petroleum is greater than 70. In other embodiments, the API gravity of the unrefined petroleum is greater than 80. In some embodiments, the API gravity of the unrefined petroleum is greater than 90. In other embodiments, the API gravity of the unrefined petroleum is greater than 100. In some other embodiments, the API gravity of the unrefined petroleum is between 30 and 100. In other embodiments, the unrefined petroleum can be a heavy oil.

In some embodiments, the hydrocarbons or unrefined petroleum can comprise crude having an H₂S concentration of at least 0.5 mol % (e.g., at least 1 mol %, at least 1.5 mol %, at least 2 mol %, at least 2.5 mol %, at least 3 mol %, at least 3.5 mol %, at least 4 mol %, at least 4.5 mol %, at least 5 mol %, at least 6 mol %, at least 7 mol %, at least 8 mol %, at least 9 mol %, at least 10 mol %, at least 11 mol %, at least 12 mol %, at least 13 mol %, at least 14 mol %, at least 15 mol %, at least 16 mol %, at least 17 mol %, at least 18 mol %, at least 19 mol %, at least 20 mol %, at least 21 mol %, at least 22 mol %, at least 23 mol %, or at least 24 mol %). In some embodiments, the hydrocarbons or unrefined petroleum can comprise crude having an H₂S concentration of 25 mol % or less (e.g., 24 mol % or less, 23 mol % or less, 22 mol % or less, 21 mol % or less, 20 mol % or less, 19 mol % or less, 18 mol % or less, 17 mol % or less, 16 mol % or less, 15 mol % or less, 14 mol % or less, 13 mol % or less, 12 mol % or less, 11 mol % or less, 10 mol % or less, 9 mol % or less, 8 mol % or less, 7 mol % or less, 6 mol % or less, 5 mol % or less, 4.5 mol % or less, 4 mol % or less, 3.5% or less, 3% or less, 2.5% or less, 2% or less, 1.5% or less, or 1% or less).

The hydrocarbons or unrefined petroleum can comprise crude having an H₂S concentration ranging from any of the minimum values described above. For example, in some embodiments, the hydrocarbons or unrefined petroleum can comprise crude having an H₂S concentration of from 0.5% to 25% (e.g., from 0.5 mol % to 20 mol %, from 5 mol % to 25 mol %, from 10 mol % to 25 mol %, or from 15 mol % to 20 mol %).

In some embodiments, the formation can have a temperature of at least 75° F. (e.g., at least 80° F., at least 85° F., at least 90° F., at least 95° F., at least 100° F., at least 105° F., at least 110° F., at least 115° F., at least 120° F., at least 125° F., at least 130° F., at least 135° F., at least 140° F., at least 145° F., at least 150° F., at least 155° F., at least 160° F., at least 165° F., at least 170° F., at least 175° F., at least 180° F., at least 190° F., at least 200° F., at least 205° F., at least 210° F., at least 215° F., at least 220° F., at least 225° F., at least 230° F., at least 235° F., at least 240° F., at least 245° F., at least 250° F., at least 255° F., at least 260° F., at least 265° F., at least 270° F., at least 275° F., at least 280° F., at least 285° F., at least 290° F., at least 295° F., at least 300° F., at least 305° F., at least 310° F., at least 315° F., at least 320° F., at least 325° F., at least 330° F., at least 335° F., at least 340° F., or at least 345° F.). In some embodiments, the formation can have a temperature of 350° F. or less (e.g., 345° F. or less, 340° F. or less, 335° F. or less, 330° F. or less, 325° F. or less, 320° F. or less, 315° F. or less, 310° F. or less, 305° F. or less, 300° F. or less, 295° F. or less, 290° F. or less, 285° F. or less, 280° F. or less, 275° F. or less, 270° F. or less, 265° F. or less, 260° F. or less, 255° F. or less, 250° F. or less, 245° F. or less, 240° F. or less, 235° F. or less, 230° F. or less, 225° F. or less, 220° F. or less, 215° F. or less, 210° F. or less, 205° F. or less, 200° F. or less, 195° F. or less, 190° F. or less, 185° F. or less, 180° F. or less, 175° F. or less, 170° F. or less, 165° F. or less, 160° F. or less, 155° F. or less, 150° F. or less, 145° F. or less, 140° F. or less, 135° F. or less, 130° F. or less, 125° F. or less, 120° F. or less, 115° F. or less, 110° F. or less, 105° F. or less, 100° F. or less, 95° F. or less, 90° F. or less, 85° F. or less, or 80° F. or less).

The formation can have a temperature ranging from any of the minimum values described above to any of the maximum values described above. For example, in some embodiments, the formation can have a temperature of from 75° F. to 350° F. (approximately 24° C. to 176° C.), from 150° F. to 250° F. (approximately 66° C. to 121° C.), from 110° F. to 350° F. (approximately 43° C. to 176° C.), from 110° F. to 150° F. (approximately 43° C. to 66° C.), from 150° F. to 200° F. (approximately 66° C. to 93° C.), from 200° F. to 250° F. (approximately 93° C. to 121° C.), from 250° F. to 300° F. (approximately 121° C. to 149° C.), from 300° F. to 350° F. (approximately 149° C. to 176° C.), from 110° F. to 240° F. (approximately 43° C. to 116° C.), or from 240° F. to 350° F. (approximately 116° C. to 176° C.).

In some embodiments, the salinity of the formation can be at least 5,000 ppm TDS (e.g., at least 25,000 ppm TDS, at least 50,000 ppm TDS, at least 75,000 ppm TDS, at least 100,000 ppm TDS, at least 125,000 ppm TDS, at least 150,000 ppm TDS, at least 175,000 ppm TDS, at least 200,000 ppm TDS, at least 225,000 ppm TDS, at least 250,000 ppm TDS, or at least 275,000 ppm TDS). In some embodiments, the salinity of the formation can be 300,000 ppm TDS or less (e.g., 275,000 ppm TDS or less, 250,000 ppm TDS or less, 225,000 ppm TDS or less, 200,000 ppm TDS or less, 175,000 ppm TDS or less, 150,000 ppm TDS or less, 125,000 ppm TDS or less, 100,000 ppm TDS or less, 75,000 ppm TDS or less, 50,000 ppm TDS or less, or 25,000 ppm TDS or less).

The salinity of the formation can range from any of the minimum values described above to any of the maximum values described above. For example, in some embodiments, the salinity of the formation can be from 5,000 ppm TDS to 300,000 ppm TDS (e.g., from 100,000 ppm to 300,000 ppm TDS).

### EXAMPLE EMBODIMENTS

Embodiment 1: An aqueous foam precursor composition comprising: a primary foaming surfactant, wherein when measured according to Hydrogen Sulfide Stability Test Method 1, less than 20 mol % of the primary foaming surfactant degrades after aging for 7 days at 120° C. in the presence of 17% H₂S; a viscosity-modifying polymer; and water.

Embodiment 2: The composition can further include a foam stabilizer.

Embodiment 3: An aqueous foam precursor composition comprising: a primary foaming surfactant; a viscosity-modifying polymer; a foam stabilizer; and water; wherein the aqueous foam precursor composition forms an aqueous based foam that exhibits a foam half-life of at least 12 hours, when foamed and measured using Foam Stability Test Method 1.

Embodiment 4: An aqueous foam precursor composition comprising: a primary foaming surfactant, wherein when measured according to Hydrogen Sulfide Stability Test Method 1, less than 20 mol % of the primary foaming surfactant degrades after aging for 7 days at 120° C. in the presence of 17% H₂S; a viscosity-modifying polymer, wherein the wherein the viscosity-modifying polymer is stable at 120° C. in the presence of H₂S, as measured by Hydrogen Sulfide Stability Test Method 1; a foam stabilizer; and water.

Embodiment 5: The composition of any of Embodiments 1-4, wherein the precursor aqueous foam composition forms an aqueous based foam that exhibits a foam half life of at least 12 hours, when foamed and measured using Foam Stability Test Method 2 at 1500 psi and 85° C.

Embodiment 6: The composition of any of Embodiments 1-4, wherein the precursor aqueous foam composition forms an aqueous based foam that exhibits a foam half life of at least 12 hours, when foamed and measured using Foam Stability Test Method 2 at 1500 psi and 85° C. in the presence of 10-25% H₂S.

Embodiment 7: The composition of any of Embodiments 1-6, wherein the aqueous foam precursor composition comprises at least 50% by weight water (e.g., at least 75% by weight), based on the total weight of the aqueous foam precursor composition.

Embodiment 8: The composition of any of Embodiments 1-7, wherein the primary foaming surfactant is a water-soluble surfactant.

Embodiment 9: The composition of any of Embodiments 1-8, wherein the primary foaming surfactant comprises an anionic surfactant.

Embodiment 10: The composition of Embodiment 9, wherein the anionic surfactant is selected from the group consisting of an olefin sulfonate; an alcohol ethoxycarboxylate, a disulfonate, an alkylbenzene sulfonate, or any combination thereof.

Embodiment 11: The composition of any of Embodiments 1-10, wherein the primary foaming surfactant is present in an amount of from 0.01% to 10% by weight (e.g., from 0.01% to 5%, from 0.01% to 4%, or from 0.01% to 2%), based on the total weight of the aqueous foam precursor composition.

Embodiment 12: The composition of any of Embodiments 1-8, wherein the primary foaming surfactant comprises a non-ionic surfactant.

Embodiment 13: The composition of Embodiment 12, wherein the non-ionic surfactant comprises an ethoxylated alcohol.

Embodiment 14: The composition of Embodiment 13, wherein the ethoxylated alcohol comprises an ethoxylated C₁₂-C₁₄ alcohol, such as an ethoxylated C₁₂-C₁₄ branched alcohol.

Embodiment 15: The composition of Embodiment 14, wherein the ethoxylated C₁₂-C₁₄ alcohol comprises from 1 to 30 ethoxy groups.

Embodiment 16: The composition of any of Embodiments 1-15, wherein the composition further comprises one or more co-surfactants.

Embodiment 17: The composition of Embodiment 16, wherein the one or more co-surfactants comprise one or more anionic surfactants, one or more cationic surfactants, one or more non-ionic surfactants, one or more zwitterionic surfactants, or any combination thereof.

Embodiment 18: The composition of any of Embodiments 16-17, wherein when measured according to Hydrogen Sulfide Stability Test Method 1, less than 20 mol % of the one or more co-surfactants degrade after aging for 7 days at 120° C. in the presence of 17% H₂S.

Embodiment 19: The composition of any of Embodiments 16-18, wherein the one or more co-surfactants are each water-soluble surfactants.

Embodiment 20: The composition of any of Embodiments 16-19, wherein the composition comprises two or more co-surfactants.

Embodiment 21: The composition of any of Embodiments 16-20, wherein the one or more co-surfactants comprise one or more anionic surfactants.

Embodiment 22: The composition of Embodiment 21, wherein the one or more anionic surfactants are selected from the group consisting of an olefin sulfonate, an alcohol ethoxycarboxylate, a disulfonate, an alkylbenzene sulfonate, or any combination thereof.

Embodiment 23: The composition of any of Embodiments 16-22, wherein the one or more co-surfactants comprise one or more non-ionic surfactants.

Embodiment 24: The composition of Embodiment 23, wherein the one or more non-ionic co-surfactants comprise an ethoxylated alcohol.

Embodiment 25: The composition of Embodiment 24, wherein the ethoxylated alcohol comprises an ethoxylated C12-C14 alcohol, such as an ethoxylated C12-C14 branched alcohol.

Embodiment 26: The composition of any of Embodiments 16-25, wherein the one or more co-surfactants are present in an amount of from 0.01% to 10% by weight (e.g., from 0.01% to 5%, from 0.01% to 4%, or from 0.01% to 2%), based on the total weight of the aqueous foam precursor composition.

Embodiment 27: The composition of any of Embodiments 1-26, wherein the foam stabilizer is selected from a fluorosurfactant, a crosslinker, a particulate stabilizer, or any combination thereof.

Embodiment 28: The composition of Embodiment 27, wherein the foam stabilizer comprises a fluorosurfactant.

Embodiment 29: The composition of Embodiment 28, wherein the fluorosurfactant comprises a fluoroaliphatic sulfosuccinate, a fluoroaliphatic sulfonate, an ethoxylated fluorinated alcohol, or any combination thereof.

Embodiment 30: The composition of any of Embodiments 28-29, wherein the fluorosurfactant is present in an amount of from 0.01% to 10% by weight (e.g., from 0.01% to 4%, from 0.01% to 2%, from 0.01% to 1%, from 0.01% to 0.5%, or from 0.01% to 0.2%), based on the total weight of the aqueous foam precursor composition.

Embodiment 31: The composition of any of Embodiments 27-30, wherein the foam stabilizer comprises a crosslinker.

Embodiment 32: The composition of Embodiment 31, wherein the crosslinker comprises a borate crosslinking agent, a Zr crosslinking agent, a Ti crosslinking agent, an Al crosslinking agent, an organic crosslinker (e.g., malonate, polyethyleneimine), or any combination thereof. Embodiment 33: The composition of any of Embodiments 31-32, wherein the viscosity-modifying polymer and the crosslinker are present in a weight ratio of from 10:1 to 100:1 (e.g., from 20:1 to 100:1, from 10:1 to 50:1, or from 25:1 to 50:1).

Embodiment 34: The composition of any of Embodiments 27-33, wherein the foam stabilizer comprises nanoparticles or microparticles.

Embodiment 35: The composition of Embodiment 34, wherein the nanoparticles or microparticles comprise nickel oxide, alumina, silica (surface-modified), a silicate, iron oxide (Fe₃O₄), titanium oxide, impregnated nickel on alumina, synthetic clay, natural clay such as bentonite, iron zinc sulfide, magnetite, iron octanoate, or any combination thereof.

Embodiment 36: The composition of any of Embodiments 27-35, wherein the foam stabilizer is present in an amount of from 0.01% to 10% by weight (e.g., from 0.01% to 5%, from 0.01% to 4%, or from 0.01% to 2%), based on the total weight of the aqueous foam precursor composition.

Embodiment 37: The composition of any of Embodiments 1-36, wherein the viscosity-modifying polymer comprises a biopolymer.

Embodiment 38: The composition of any of Embodiments 1-37, wherein the viscosity-modifying polymer comprises a triple-helix forming biopolymer.

Embodiment 39: The composition of any of Embodiments 1-38, wherein the viscosity-modifying polymer comprises a polysaccharide.

Embodiment 40: The composition of any of Embodiments 1-39, wherein the viscosity-modifying polymer is selected from xanthan, guar, a scleroglucan, a schizophyllan, hydroxyethyl cellulose (HEC), or any combination thereof.

Embodiment 41: The composition of any of Embodiments 1-40, wherein the viscosity-modifying polymer comprises a synthetic polymer.

Embodiment 42: The composition of Embodiment 41, wherein the synthetic polymer is selected from the group consisting of HPAM, NVP, ATBS, AMPS, and any combination thereof.

Embodiment 43: The composition of any of Embodiments 1-42, wherein the viscosity-modifying polymer comprises a blend of a biopolymer and a synthetic polymer.

Embodiment 44: The composition of any of Embodiments 1-43, wherein the viscosity-modifying polymer is present in an amount of from 0.01% to 3% by weight, by weight (e.g., from 0.01% to 1%, from 0.01% to 0.75%, or from 0.01% to 0.5%), based on the total weight of the aqueous foam precursor composition.

Embodiment 45: The composition of any of Embodiments 1-44, wherein the composition further comprises a cosolvent.

Embodiment 46: An aqueous based foam comprising the aqueous foam precursor composition of any of Embodiments 1-45 and an expansion gas.

Embodiment 47: The foam of Embodiment 46, wherein the expansion gas comprises nitrogen, natural gas or a hydrocarbon component thereof, helium, CO₂, air, or any combination thereof.

Embodiment 48: The foam of Embodiment 46 or Embodiment 47, wherein the foam exhibits a density of from 2 lbs/gal to 8 lbs/gal.

Embodiment 49: A method of making the aqueous based-foam of any of Embodiments 46-48, the method comprising: contacting the aqueous foam precursor in the presence of the expansion gas; or injecting the expansion gas into the aqueous foam precursor.

Embodiment 50: A method for forming a wellbore within a formation, the method comprising: drilling the wellbore by injecting an aqueous drilling fluid through a tubular string disposed in the wellbore, the tubular string comprising a drill bit disposed on a bottom thereof, wherein the drilling fluid exits the drill bit, and introducing an aqueous based foam into at least a portion of an annulus defined by an outer surface of the tubular string and an inner surface of the wellbore or a casing lining the wellbore.

Embodiment 51: The method of Embodiment 50, wherein the method further comprises generating the aqueous based foam above ground and injecting the aqueous based foam into the annulus.

Embodiment 52: The method of Embodiment 50, wherein the method further comprises generating the aqueous based foam within the annulus.

Embodiment 53: The method of Embodiment 51 or 52, wherein generating the aqueous based foam comprises: contacting the aqueous foam precursor in the presence of the expansion gas; or injecting the expansion gas into the aqueous foam precursor.

Embodiment 54: The method of any one of Embodiments 50-53, wherein the aqueous based foam comprises an aqueous based foam defined by any of Embodiments 46-48.

Embodiment 55: The method of any one of Embodiments 50-54, wherein the formation comprises a carbonate formation.

Embodiment 56: The method of any one of Embodiments 50-55, wherein the formation comprises hydrocarbons and H₂S, and wherein the H₂S is present in an amount of from 0.5 mol % to 25 mol %, from 0.5 mol % to 20 mol %; or 5 mol % to 25 mol %.

Embodiment 57: The method of any one of Embodiments 50-56, wherein the formation has an in-situ temperature of from 85° C. to 150° C., such as from 110° C. to 150° C., from 110° C. to 140° C., or from 120° C. to 150° C.

Embodiment 58: The method of any one of Embodiments 50-57, wherein the formation has a permeability of from 25 milliDarcy (mD) to 40,000 mD.

Embodiment 59: The method of any one of Embodiments 50-57, wherein the formation has a permeability of less than 20 mD, such as from 0.001 milliDarcy (mD) to 10 mD or from 0.01 mD to 10 mD.

Embodiment 60: The method of any one of Embodiments 50-57, wherein the formation comprises hydrocarbons and H₂S, wherein the H₂S is present in an amount of from 0.5 mol % to 25 mol %, such as from 0.5 mol % to 20 mol %, from 5 mol % to 25 mol %, from 10 mol % to 25 mol %, or from 15 mol % to 20 mol %).

Embodiment 61: The method of any one of Embodiments 50-60, wherein the method comprises below bubble point drilling.

Embodiment 62: The method of any one of Embodiments 50-61, wherein the method further comprises injecting the aqueous based foam through the tubular string.

Embodiment 63: The composition of Embodiment 1, wherein the primary foaming surfactant is stable at 120° C. in the presence of H₂S, as measured by Hydrogen Sulfide Stability Test Method 1.

Embodiment 64: The any of Embodiments 49, or 53-62, wherein the contacting step comprises shearing the aqueous foam precursor in the presence of the expansion gas, mechanically agitating the aqueous foam precursor in the presence of the expansion gas, or any combination thereof.

The present invention is not to be limited in scope by the specific embodiments described which are intended as single illustrations of individual aspects of the invention, and functionally equivalent methods and components are within the scope of the invention. Indeed, various modifications of the invention, in addition to those shown and described herein, will become apparent to those skilled in the art from the foregoing description and accompanying drawings using no more than routine experimentation. Such modifications and equivalents are intended to fall within the scope of the appended claims.

The examples below are intended to further illustrate certain aspects of the compositions and methods described herein and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods, compositions, and results. These examples are not intended to exclude equivalents and variations of the present invention, which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures, and other reaction ranges and conditions that can be used to optimize the product purity and yield obtained from the described process. Only reasonable and routine experimentation will be required to optimize such process conditions.

### Example 1

Discussed herein are aqueous foam formulations that can be used in drilling operations at elevated temperature, at elevated pressure, and/or in the presence of H₂S.

Alpha olefin sulfonate (AOS) and betaines are surfactants that can be used to generate foams. AOS and cocoamidopropyl betaine degrade in the presence of H₂S and cannot be used to generate foam where large amounts of H₂S are present. For small amounts of H₂S, H₂S scavengers can be used to prevent H₂S from degrading the surfactants; however, for large amounts of H₂S, it is not cost effective to use H₂S scavengers. Instead, H₂S tolerant foaming surfactants need to be used.

Some surfactants, such isomerized olefin sulfonates (IOS) and ethoxylated alcohols, do not degrade after being exposed to H₂S for 7 days. However, IOS, amide ether carboxylate (AEC), and ethoxylated alcohols do not foam as readily as AOS and betaines. In order to make them foam more readily, short chain fluorinated surfactants can be added to the surfactant mixture to reduce the surface tension between the aqueous phase and gas phase.

Most drilling foams containing fluorinated surfactants are oil-based foams. In formulations where circulation loss is an issue, the drilling fluids are consumed at a much faster rate, and oil-based fluids are significantly more expensive. Aqueous drilling foams offer a more cost effective solution than oil based drilling foams.

Surfactants alone are often unable to form a stable bulk foam. Synthetic polymers, nanoparticles, and any combinations thereof can be used to stabilize foams. Synthetic polymers, such as hydrolyzed polyacrylamide (HPAM), degrade in the presence of H₂S and lose viscosity in high temperatures and high salinity. However, some polymers (e.g., biopolymers, such as guar and triple helix biopolymers) do not degrade when exposed to H₂S and maintains viscosity at high temperatures and high salinities. Most synthetic polymers make it harder for solutions to foam; triple helix biopolymers, however, do not hurt the foamability as much as synthetic polymers. Typically, guar and xanthan gum are used to thicken the drilling fluids and stabilize the foams. Triple helix biopolymers have better temperature stability and viscosity than guar and xanthan.

Oil has a destabilizing effect on the foam. The addition of fluorinated surfactants makes the foam more resistant to destabilization from oil. Fluorinated surfactants help protect the foam from oil by forming a film over the oil. In addition, the fluorinated surfactants can decrease surface tension, making it easier to form a foam.

Bentonite can also be used to stabilize the foams. Bentonite is commonly used in drilling fluids an additive to prevent the drilling fluids from entering formations. Bentonite, like nanoparticles, can accumulate at the liquid/gas interface, stabilizing the foam. The particles at the interface can provide structure to the lamella and prevent them from coalescing as quickly.

To test the foamability and stability of various formulations, 500-1500 ppm of various polymers were added to surfactant and brine solutions in sealed pipettes. Foam was generated by handshaking the pipettes. For pipettes containing HPAM and 2-acrylamido-2-methylpropane sulfonic acid (AMPS), less than 25% of the surfactant solution would generate foam. For pipettes containing biopolymer, greater than 50% of the surfactant solution was successfully foamed. Accordingly, the viability of biopolymers for foam stabilization were subsequently tested using Foam Stability Test Method 1. Without any polymer added, half of the foam column decayed in less than 30 minutes. With the addition of 1500 ppm biopolymer, half the foam decayed in 4 hours.

The combination of fluorinated surfactant and biopolymer can further improve foam stability over time. With the addition of 0.1% fluorinated surfactant and 1500 ppm of biopolymer, greater than half the foam column remained after 24 hours. Adding 0.5% bentonite with the biopolymer, but no fluorinated surfactant, also resulted in greater than half the foam column remaining after 24 hours. The addition of fluorinated surfactant, biopolymer, and 0.5% bentonite resulted in greater than half the foam column remaining after 24 hours, as well.

These formulations can, for example, be incorporated into an aqueous drilling foam used in below bubble point drilling where high H₂S content is expected through highly fractured and vuggy zones where circulation loss is immense.

### Example 2

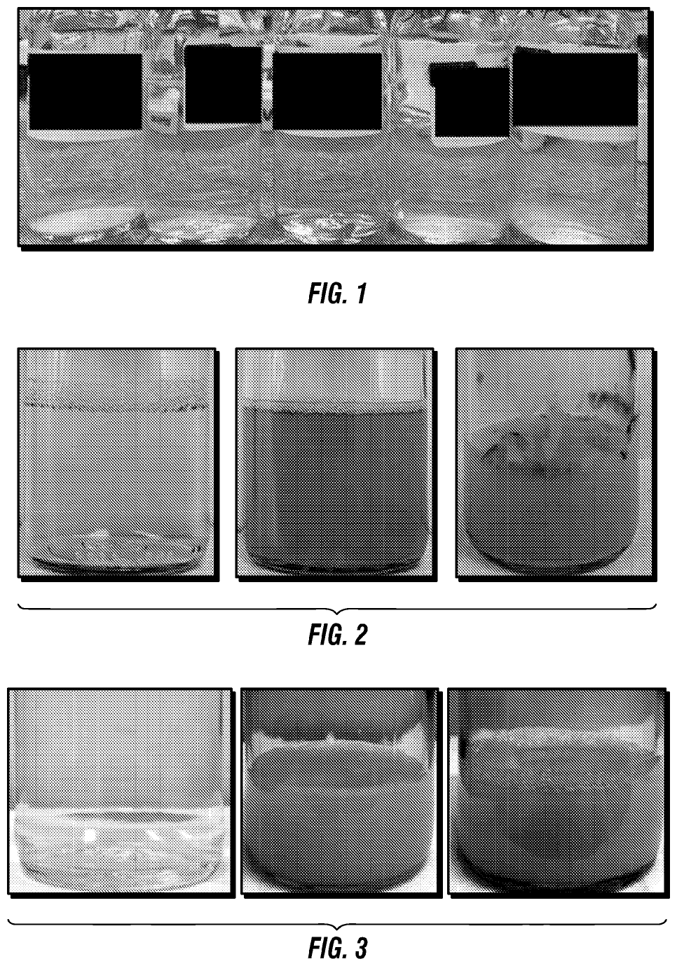

Multiple surfactants (e.g., AEC, IOS, disulfonate, linear ethoxylated alcohol, branched ethoxylated alcohol) were tested for stability using Hydrogen Sulfide Stability Test Method 1. Indicators of stability of the surfactants included the surfactant remaining clear and colorless (FIG. 1), while changes in color and/or clarity indicated instability (FIG. 2 and FIG. 3).

Under the test conditions, IOS, AEC, a branched ethoxylated alcohol, a linear ethoxylated alcohol, and disulfonate surfactants were all stable, while cocoamidopropyl betaine, cetyl betaine, and AOS degraded. Photographs of the cetyl betaine and cocoamidopropyl betaine surfactants before testing (left), after aging for 7 days with 17% H₂S at 120° C. (middle), and after degassing (right) are shown in FIG. 2 and FIG. 3, respectively, where changes in color and clarity are apparent.

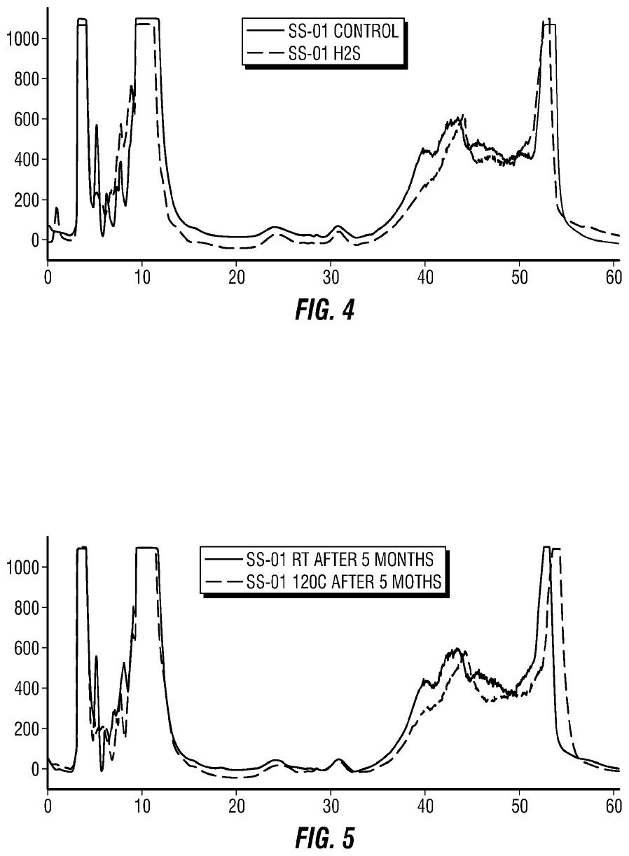

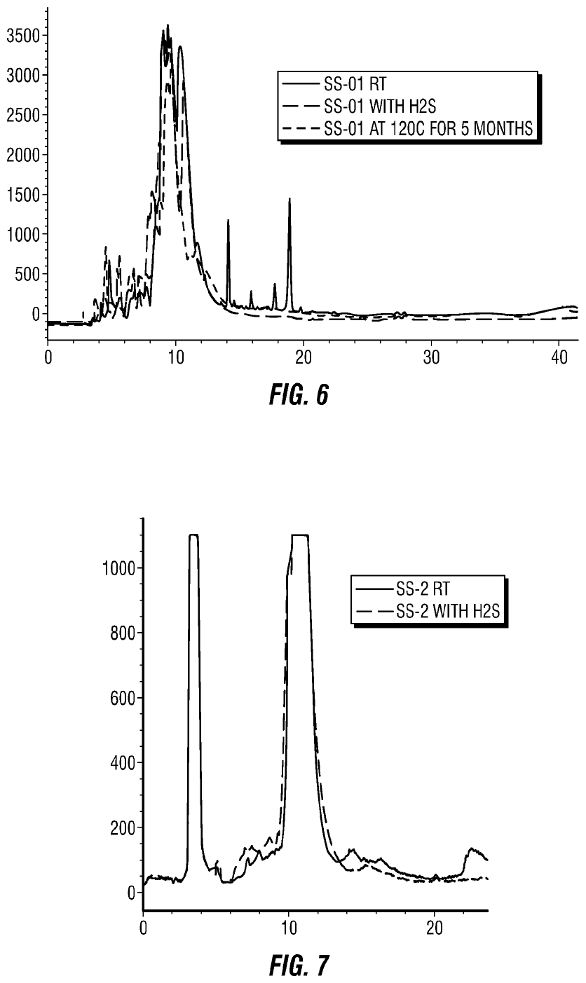

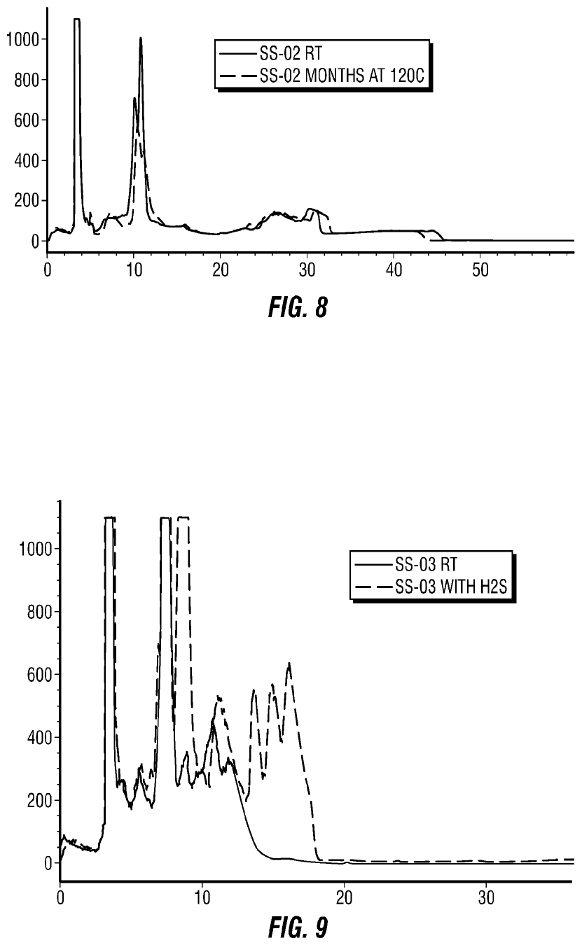

A mixture of AEC and disulfonate surfactants was stable: in the presence of H₂S at 120° C. for 7 days (FIG. 4); at room temperature for 5 months (FIG. 5); and at 120° C. for 5 months (FIG. 5), as determined by HPLC. The HPLC results for the disulfonate surfactant indicated that the disulfonate surfactant exhibited no significant degradation after H₂S exposure for 7 days at 120° C. or after 5 months at 120° C. (FIG. 6). The HPLC data for IOS indicated that there was no significant degradation after H₂S exposure for 7 days at 120° C. (FIG. 7). The HPLC data for IOS indicated that there were some changes after 5 months at 120° C. compared to the room temperature sample, but overall IOS remained relatively stable (FIG. 8).

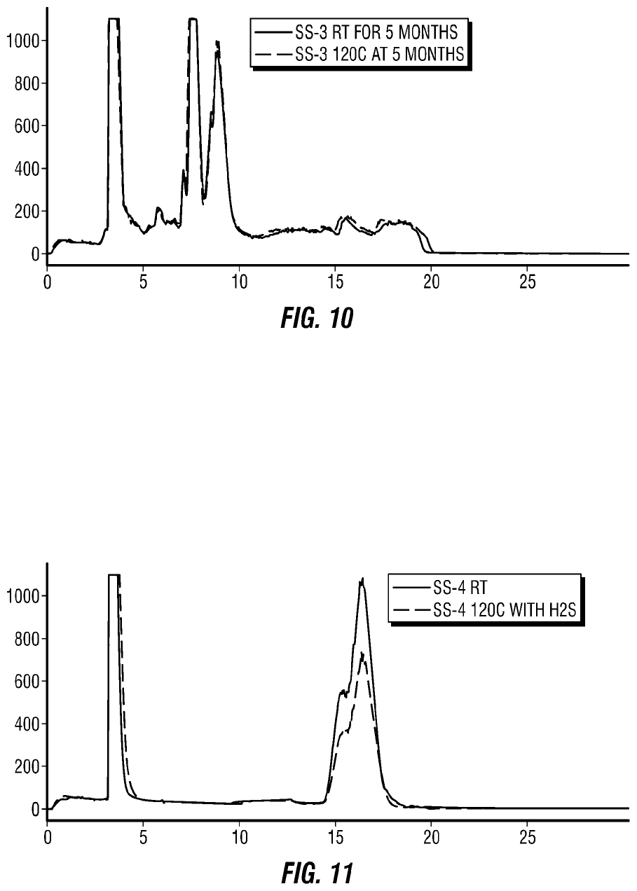

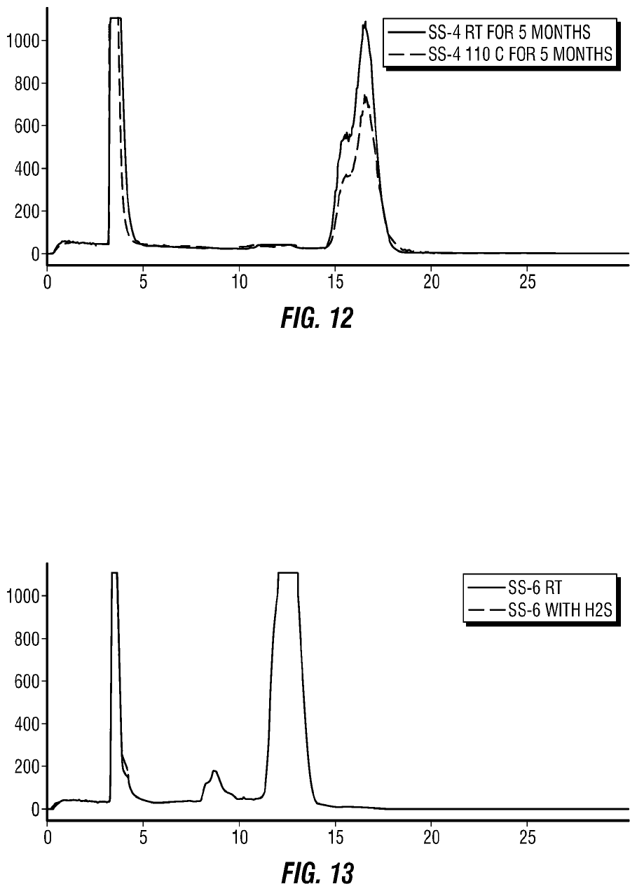

A mixture of IOS and AEC was also tested. The mixture of IOS and AEC showed no effect on aqueous stability and phase behavior. The HPLC data for AOS indicated that there was significant degradation after H₂S exposure for 7 days at 120° C. (FIG. 9). The HPLC data for AOS indicated that there was no significant degradation after 5 months at 120° C. (FIG. 10). The HPLC data for the branched ethoxylated alcohol with H₂S for 7 days at 120° C. exhibited some changes relative to the control at room temperature (FIG. 11), but these changes were similar to the samples placed at 120° C. for 5 months with no H₂S (FIG. 12). The HPLC data for the linear ethoxylated alcohol showed no significant degradation with H₂S at 120° C. for 7 days (FIG. 13).

### Example 3

Heterogeneous carbonate reservoirs containing H₂S (e.g., up to 17 mol %) are known. In these reservoirs, entire vugs and fractures can be filled with H₂S. When drilling through these vugs and fractures, fluid loss can exceed 200,000 bbl/d. Due to the large amount of H₂S that can escape once the reservoir pressure dips below bubble point and the vugs and fractures that cause excessive fluid loss, drilling new wells and workovers on existing wells can become a technical challenge. In order to address the fluid loss and other concerns, foam can be used during drilling operations to act as a barrier within the annulus, trapping reservoir gases (e.g., H₂S) and mitigating their migration to surface. Foam can also slow fluid loss through heterogenous sections of the reservoir. In these applications, foams can meet one or more of the following performance requirements: (1) maintain an annular barrier to ingress of reservoir gases to the wellbore; (2) successfully drill despite gross losses of drilling fluids; (3) provide capacity to reliably detect ingress of formation fluids; and (4) accommodate well designed parameters.

Developing a foam for drilling can present many technical challenges. Surface conditions range from below freezing to 50° C. Bottom hole conditions are up to 3700 psi at 120° C. The chemicals used to generate the foam must also be tolerant to 17% H₂S, oil impurity, and possibly high total dissolved solids (TDS) brines. Temperature and oil have a destabilizing effect on foams. In addition, H₂S degrades many commercial foaming surfactants, such as AOS and betaines, viscosity-modifying polymers, and the conventional foam stabilizers.

For these applications, foams that can maintain performance in the presence of H₂S (e.g., 10 mol % H₂S) and at high bottom hole temperatures (e.g., from 85° C., and ideally up to 120° C.) are needed. Such foams can be used to help prevent migration of reservoir gasses up the wellbore, maintain annular barrier against gas for prolonged shut ins, and provide the capacity to flush gases within annular back into the reservoir. Described herein are experiments to develop an aqueous based foam that lasts for over 24 hours at surface conditions and at bottom hole conditions. Multiple foams have been developed that show stability for over 24 hours at surface conditions, and stability has been achieved up to 85° C. at 5000 psi. Stability was considered to be achieved if more than half of the foam volume remained after 24 hours.

Multiple surfactants that did not degrade when exposed to 17% H₂S at 120° C. and 3400 psi for 7 days to 2 months were identified (Example 2). Combined with a biopolymer that yields good viscosity at high temperatures and salinity, the foam stability of all the surfactants that did not degrade in H₂S were tested starting with the anionic surfactants, and adding nonionic surfactants to supplement the anionic surfactants.

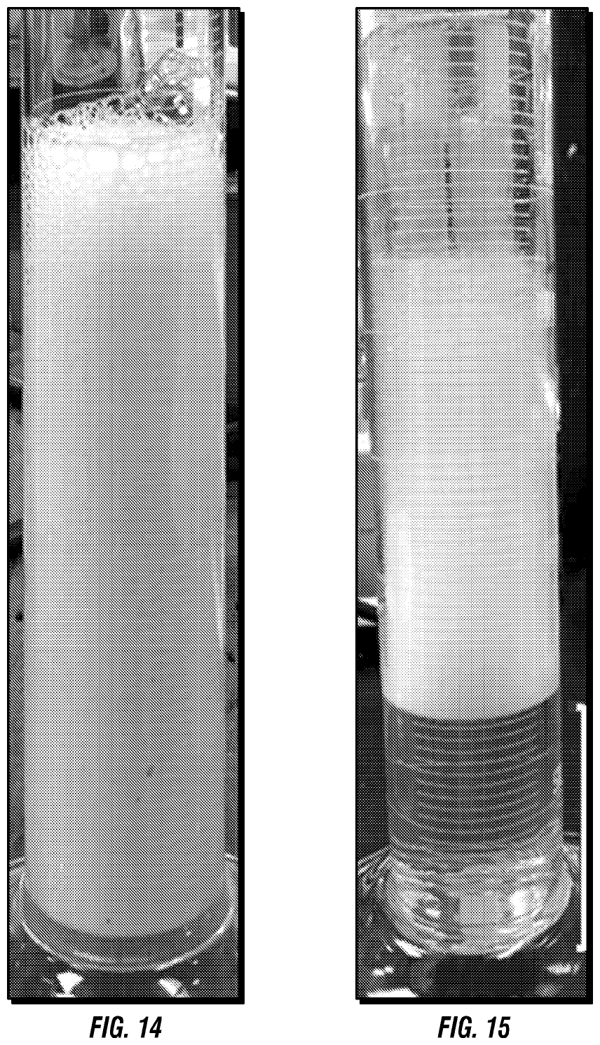

Bulk foam tests at ambient conditions were performed using Foam Stability Test Method 1. Foam decay occurs through both liquid drainage and bubble collapse. This can be slowed down by increasing liquid viscosity, for example by increasing polymer concentration. FIG. 14 shows a foam at its initial height. FIG. 15 shows a foam with liquid drainage.

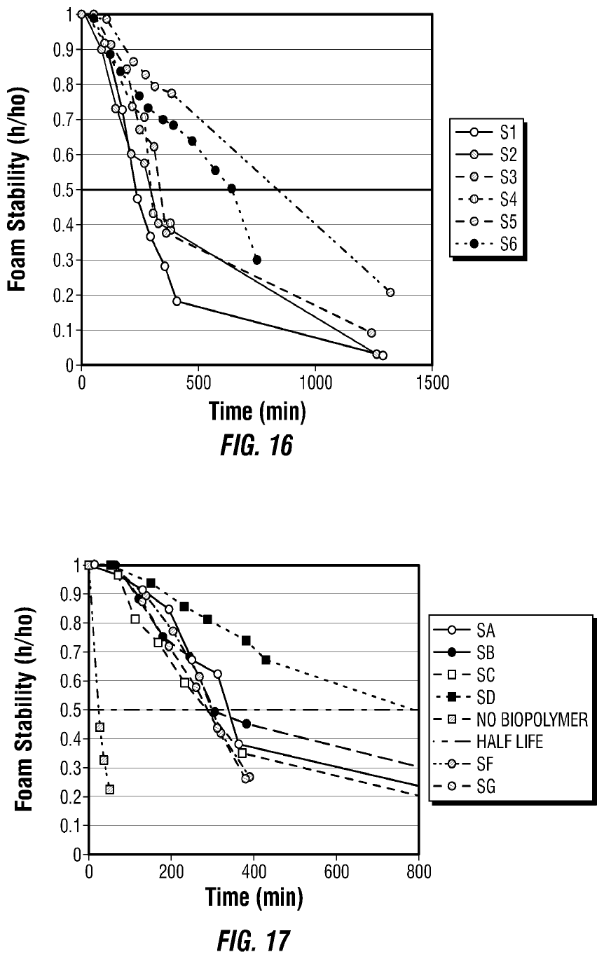

FIG. 16 shows the foam stability with various anionic surfactants (S1-S6) and 1500 ppm biopolymer. These experiments were performed at room temperature and ambient pressure. The sample was prepared by mixing 1% of a surfactant (S1-S6) with 1500 ppm of the biopolymer. The foam stability was then tested using Foam Stability Test Method 1. Stability was measured by the foam's half-life, where h/h₀=0.5 is indicated by the horizontal black line in FIG. 16; the half-life of the foams with surfactants S1-S4 ranged from ˜4 hours to 6 hours. Specifically, the half-life of the foams including anionic surfactants S1, S2, S3, and S4 were 230 min, 300 min, 335 min, and 300 min, respectively. Anionic surfactant 5 (S5) and Anionic surfactant 6 (S6), had the longest half-lives, but are not stable in the presence of H₂S.

FIG. 17 shows the foam stability with different non-ionic surfactants (SA, SB, SC, SD, SF, and SG). These experiments were performed at room temperature and ambient pressure. The sample was prepared by mixing 1% of a surfactant mixture with 1% of a varying nonionic surfactant (e.g., branched ethoxylated alcohol, linear ethoxylated alcohol, alkyl polyglucoside) with 1500 ppm biopolymer. The foam stability was measured using Foam Stability Test Method 1. Stability was measured by the foam's half-life, where h/h₀=0.5 is indicated by the horizontal black line in FIG. 17; stability up to 13 hours (780 minutes) was achieved by varying the nonionic surfactant. The half-life of the foams including SA, SB, SC, SD, and no biopolymer were 335 min, 300 min, 294 min, 780 min, and 9 min, respectively. Nonionic surfactants SA and SD were tested in additional formulations.

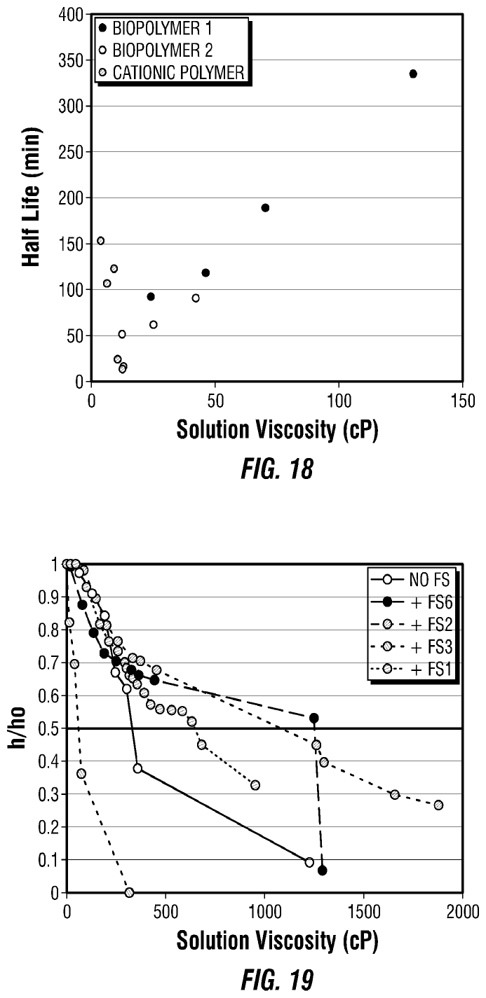

The effect of polymer viscosity on foam stability can be seen in FIG. 18. As seen in FIG. 18, foam stability can be directly correlated to solution viscosity for the two tested biopolymers, but not for the tested cationic polymer.

The effect of including a fluorinated surfactant (FS) and/or bentonite on the foam half-life was also investigated. These experiments were performed at room temperature and ambient pressure. The effect of including four different fluorinated surfactants (FS1, FS2, FS3, FS6) on the foam half-life for a composition including nonionic surfactant SA (FIG. 19). The effect of including four different fluorinated surfactants on the foam half-life for a composition including nonionic surfactant SD was also tested. As can be seen in FIG. 19, multiple formulations have a half-life exceeding 24 hours (1440 minutes). Specifically, the half-life of the foams including nonionic surfactant SA and fluorinated surfactants FS6, FS3, FS2, and FS1 were 1265 min, 60 min, 1100 min, and 655 min, respectively. The half-life of the foams for the compositions including nonionic surfactant SD and fluorinated surfactants FS6, FS3, FS2, and FS1 were 195 min, 49 min, 1309 min, and >2000 min, respectively.

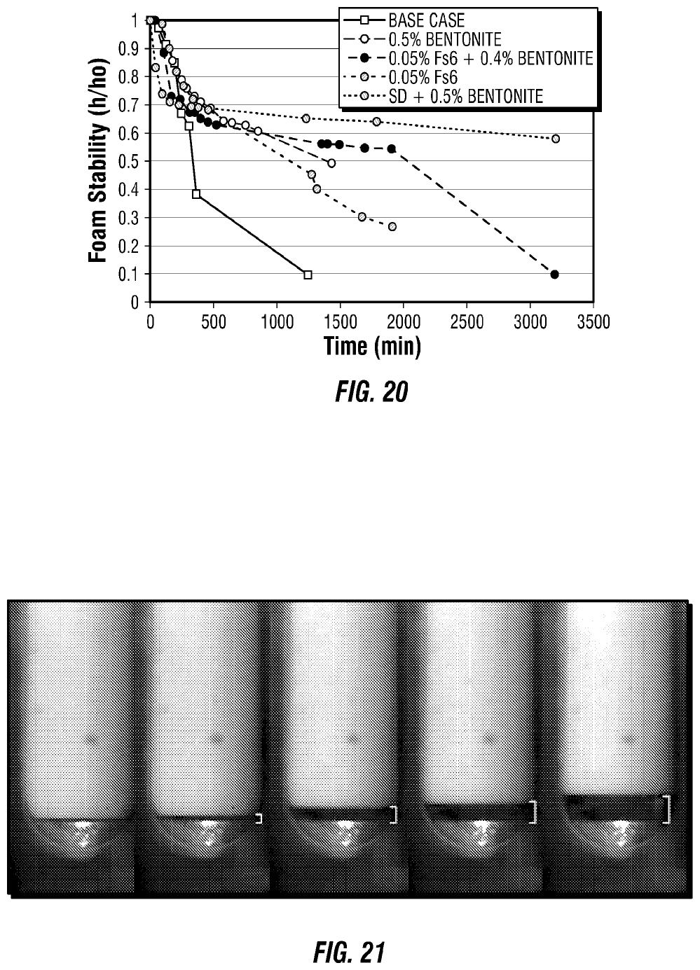

The effect of including fluorinated surfactant FS6 and/or bentonite on the foam half-life is shown in FIG. 20. As can be seen in FIG. 20, multiple formulations have a half-life exceeding 24 hours (1440 minutes). Specifically, the half-life of the base case, 0.5% bentonite, 0.05% FS6+0.4% bentonite, and SD+0.5% bentonite formulations were 335 min, 1457 min, 2022 min, and >3000 min, respectively.

The effect of including the biopolymer and bentonite on the foam half-life was investigated. These experiments were performed at room temperature and ambient pressure. The results indicated that the inclusion of 1500 ppm biopolymer improved foam stability (surfactant blend vs. surfactant blend+polymer), and the inclusion of 1% bentonite further improved foam stability (surfactant blend+polymer vs. surfactant blend+polymer+bentonite).

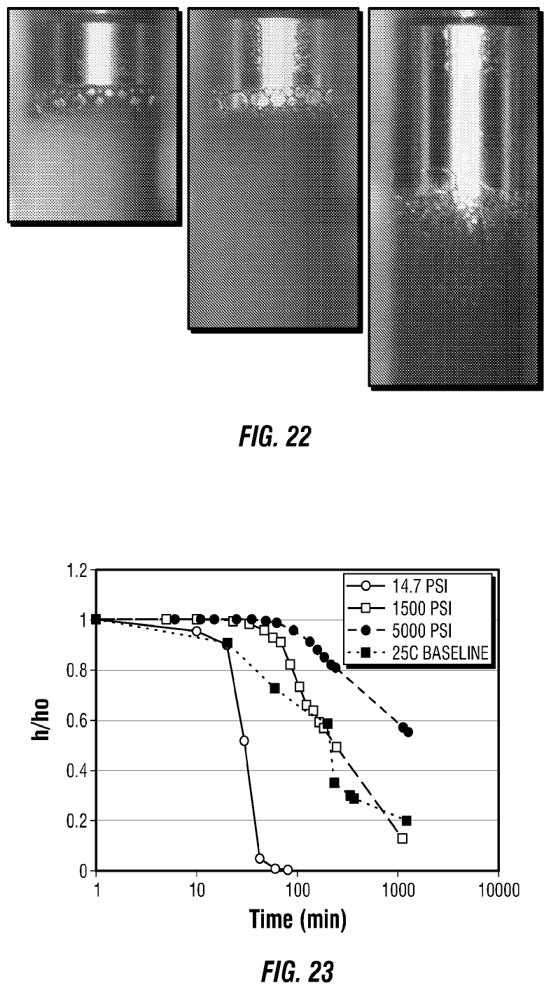

High pressure/high temperature tests were performed using Foam Stability Test Method 2. The stability of the foam was assessed using a visual cell to visually monitor liquid drainage and foam collapse (lamellae collapse) over time. Example images showing drainage and foam collapse over time are shown in FIG. 21 and FIG. 22, respectively. Lamellae drainage time can be related to fluid viscosity and change in density between liquid and gas, as shown in the equation below.

$$lamellae drainage time ∝ \frac{μ}{Δ ρ g}$$

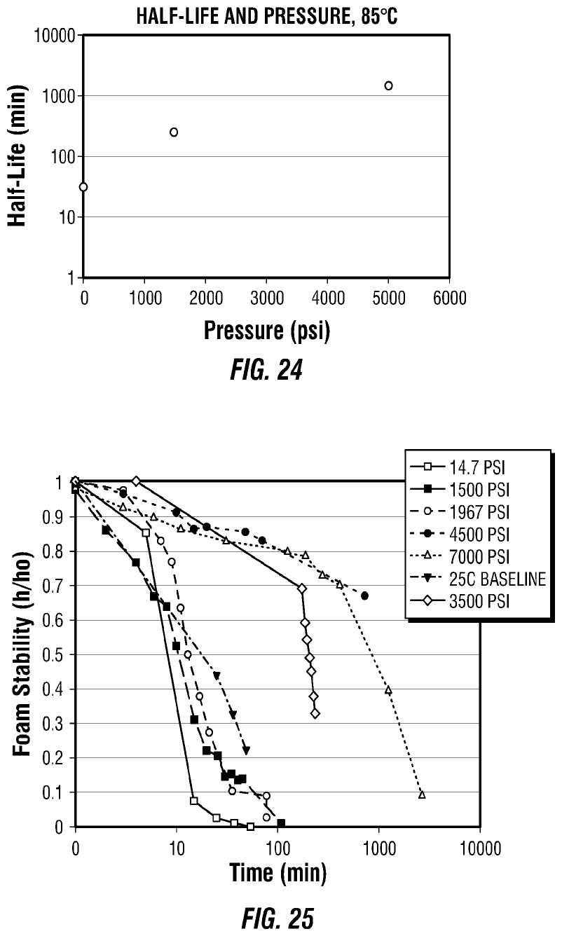

The effect of pressure on a formulation comprising 1500 ppm biopolymer and nonionic surfactant SA at 85° C. is shown in FIG. 23 and FIG. 24 (nitrogen was used in tests done at pressure and air was used in tests performed at atmospheric pressure). As seen in FIG. 23 and FIG. 24, pressure improved foam stability by an order of magnitude. Even without the addition of bentonite and/or fluorinated surfactants, the foam was stable over 24 hours (1440 minutes) at elevated temperature and pressure. The half-life of the foams were 30 min, 240 min, and >1300 min at 85° C. at pressures of 14.7 psi, 1500 psi, and 5000 psi, respectively.

The effect of pressure on the stability of a similar foam without any biopolymer was also tested (FIG. 25). Surface tension of the foam decreases, gas density increases, and bubble size decreases as the pressure increases. The foam without the biopolymer was generally less stable that the foam with biopolymer at similar pressures.

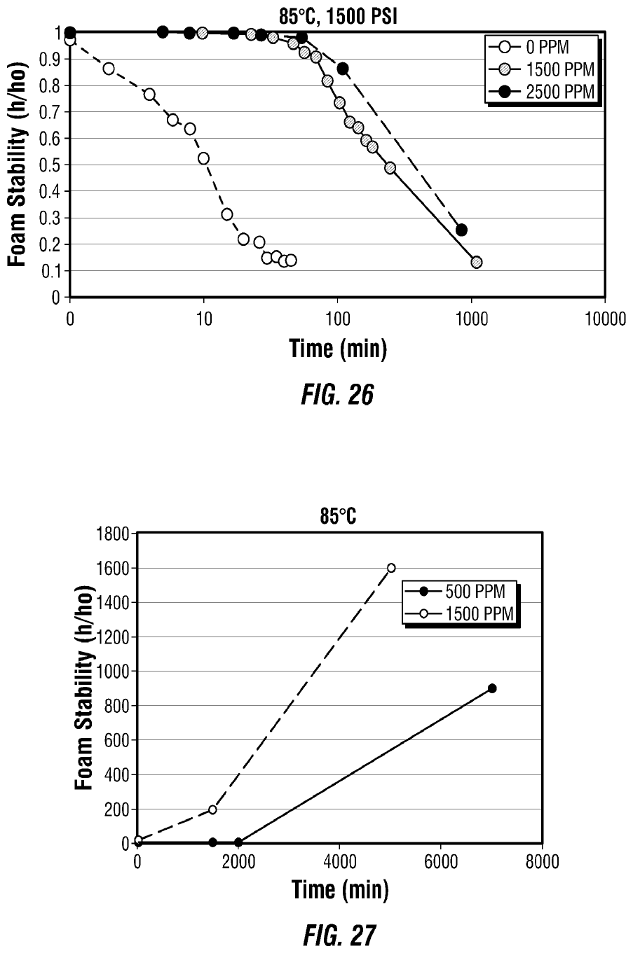

The effect of polymer viscosity on foam stability at 85° C. and atmospheric pressure was measured. The effect of polymer viscosity on foam stability at 85° C. and 1500 psi can be seen in FIG. 26. Both increase in solution viscosity and pressure cause drainage to slow down and foam stability to increase. The effects of solution viscosity are less pronounced at elevated pressure than at atmospheric pressure. As seen in FIG. 26, adding 1500 ppm biopolymer stabilizes the foam; however, increasing the polymer concentration to 2500 ppm at 1500 psi does not increase the stability as much as increasing the pressure to 5000 psi. The half-life of the foams at 85° C. and 1500 psi were 10 min, 240 min, and 400 min for 0 ppm, 1500 ppm, and 2500 ppm biopolymer, respectively. Meanwhile, the half-life of the foam with 1500 ppm biopolymer at 85° C. and 5000 psi was >1300 min. The foam stability as a function of pressure for formulations with varying biopolymer concentration at 85° C. is shown in FIG. 27.

In summary, aqueous foams can be formulated to achieve greater than 24 hour half-life at ambient conditions. Additives are needed to achieve better foam stability; additives used herein were biopolymers, fluorinated surfactants, crosslinking agents, and bentonite. Increasing temperature has a destabilizing effect on foam stability. Increasing pressure has a stability effect on foam stability.

### Example 4

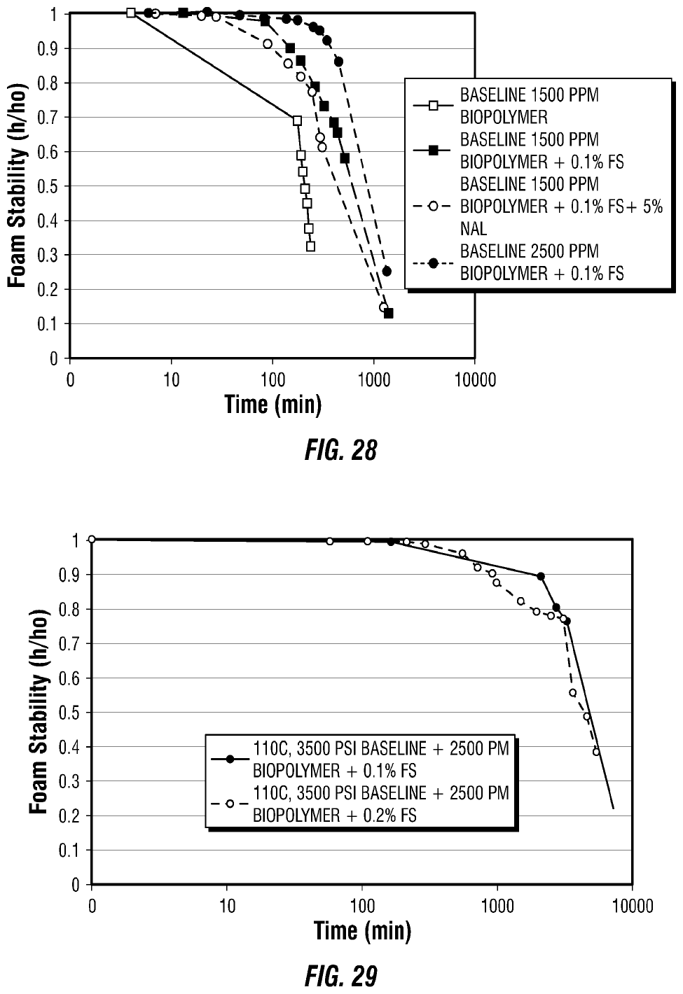

Aqueous foam stability was tested at a range of temperatures (25-110° C.) and pressures (14.7-5000 psi) for compositions using a variety of fluorinated surfactants. The foam stability as a function of time for compositions including different fluorinated surfactants (FS1, FS2, FS3, and FS6) at ambient conditions was tested. The foam stability as a function of time for compositions including fluorinated surfactants at 85° C. and 3500 psi is shown in FIG. 28.

The foam stability as a function of time for compositions including different concentrations of a fluorinated surfactant at 110° C. and 3500 psi is shown in FIG. 29; increasing the concentration of the fluorinated surfactant further displayed no additional benefit.

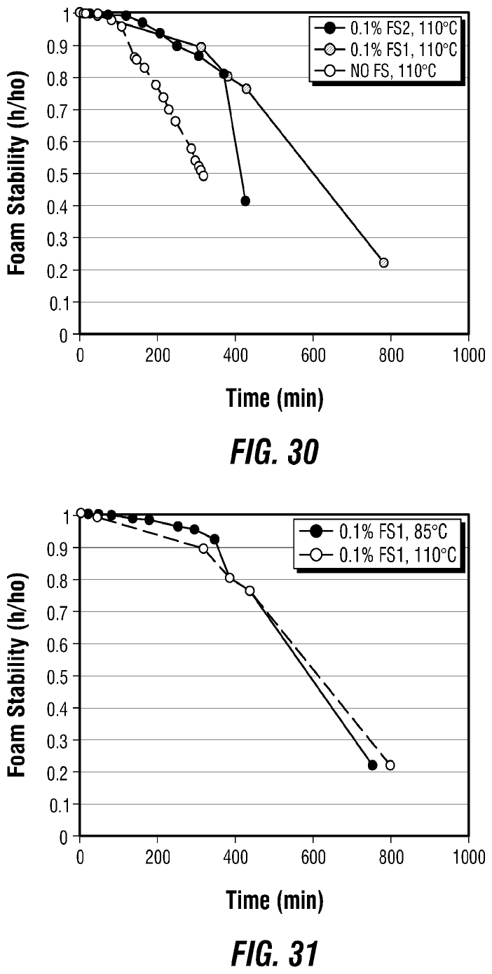

Aqueous foam stability was tested at 3500 psi and 110° C. using two different fluorinated surfactants (FS1, FS2) and in the absence of a fluorinated surfactant (FIG. 30). The compositions including either fluorinated surfactant were more stable than the composition in the absence of a fluorinated surfactant.

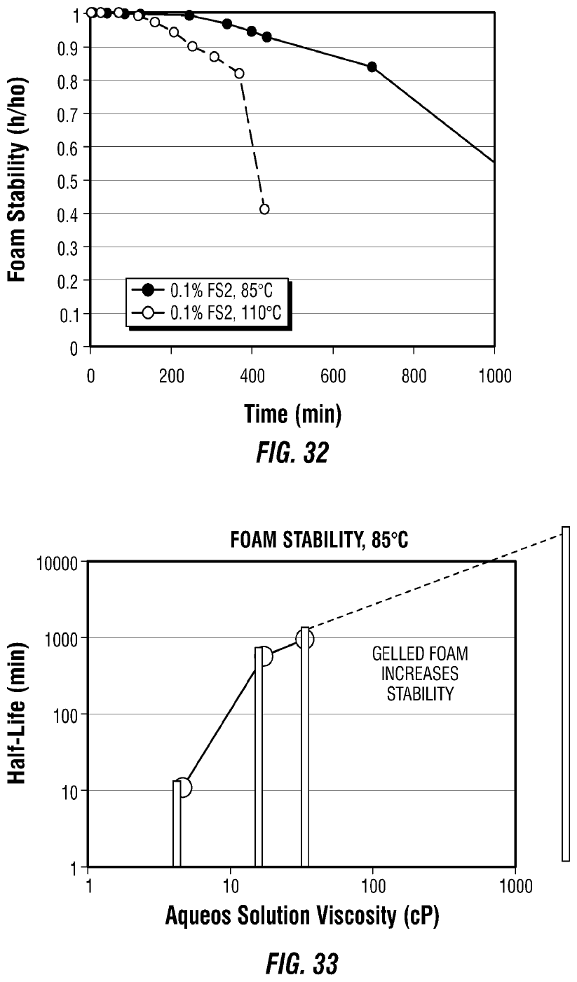

Aqueous foam stability was also tested using for compositions using fluorinated surfactant FS1 at 3500 psi and different temperatures (FIG. 31). Aqueous foam stability was also tested using for compositions using fluorinated surfactant FS2 at 3500 psi and different temperatures (FIG. 32).

The half-life results of the stability test for the compositions using the two different fluorinated surfactants and the results of testing the compositions using the two different fluorinated surfactants under varying hard water conditions at 110° C. are summarized in Table 1. The results indicated that regardless of which fluorinated surfactant was used, the viscosity of the composition needed to be increased at 110° C. to increase the foam stability to 24 hours. To this end, the effect of adding a temperature delayed crosslinker to the compositions that can viscosify the polymer solution at elevated temperatures as bottom hole is approached (bottom hole temperature (BHT) was tested.

TABLE 1
Half-life results and the results of testing
under varying hard water conditions of the
compositions using the two different fluorinated surfactants.

| Test | FS1 | FS2 |
|---|---|---|
| Half-Life (Ambient) | 18 hours | >24 hours |
| Half-Life (3500 psi, 85° C.) | ~9 hours | ~18 hours |
| Half-Life (3500 psi, 110° C.) | ~8.5 hours | ~7 hours |
| Hard Water Tolerance | 1100 < FS1 < | 786 < FS2 < |
| (110° C.) | 1500 ppm | 1100 ppm |

The effect of temperature and shear rate on solution viscosity were tested. Crosslinking will change this profile to show an increase of viscosity with an increase of temperature (FIG. 33).

The stability of the aqueous foams were also tested using three different aqueous solutions as the water component for forming the aqueous foams: aqueous solution 1, aqueous solution 2, and aqueous solution 3. The three aqueous phases had varying TDS, hardness, and pH.

Aqueous solution 1 mimicked recycled water from a previous extraction and had a pH of ˜11.2; a total dissolved solids (TDS) content of at least 5200 mg/L including calcium, magnesium, sodium, potassium, and chloride ions; an co-solvent content of 180 mg/L; and a total petroleum hydrocarbons (TPH) content of 175 mg/L.

Aqueous solution 2 had a pH of ˜8; a TDS of at least 120 mg/L including calcium, magnesium, sodium, potassium, and chloride ions; an co-solvent content of less than 0.09 mg/L; and a TPH content of ˜0.03 mg/L.

Aqueous solution 3 mimicked available environmental water and had a pH of ˜7.8; a TDS of at least 640 mg/L including calcium, magnesium, sodium, potassium, and chloride ions; a co-solvent content of less than 0.09 mg/L; and a TPH content of ˜0.04 mg/L.

No significant difference was observed in foam performance using aqueous solution 2 and aqueous solution 3 at ambient conditions.

The stability of the surfactants and polymers used to form the aqueous foams were further tested with for salinity tolerances at 110° C. by varying the concentration of monovalent (NaI; 0%, 2%, 4%, 6%, 8%, and 10%) and divalent ions (Ca²⁺ and Mg²⁺; 393 ppm, 785 ppm, 1177 ppm and 1569 ppm).

The compositions were stable using aqueous solution 2 at all tested concentration of monovalent ion (0%-10%). The composition was stable using aqueous solution 3 at 0% concentration of monovalent ions, but unstable at concentrations from 2%-10%.

Compositions comprising surfactant, polymer, and FS1 were stable at all tested concentrations of divalent cations (393 ppm-1569 ppm). Compositions comprising surfactant, polymer, and FS2 were stable at 393 ppm and 785 ppm of divalent cations, but unstable at concentrations of 1177 ppm and 1569 ppm.

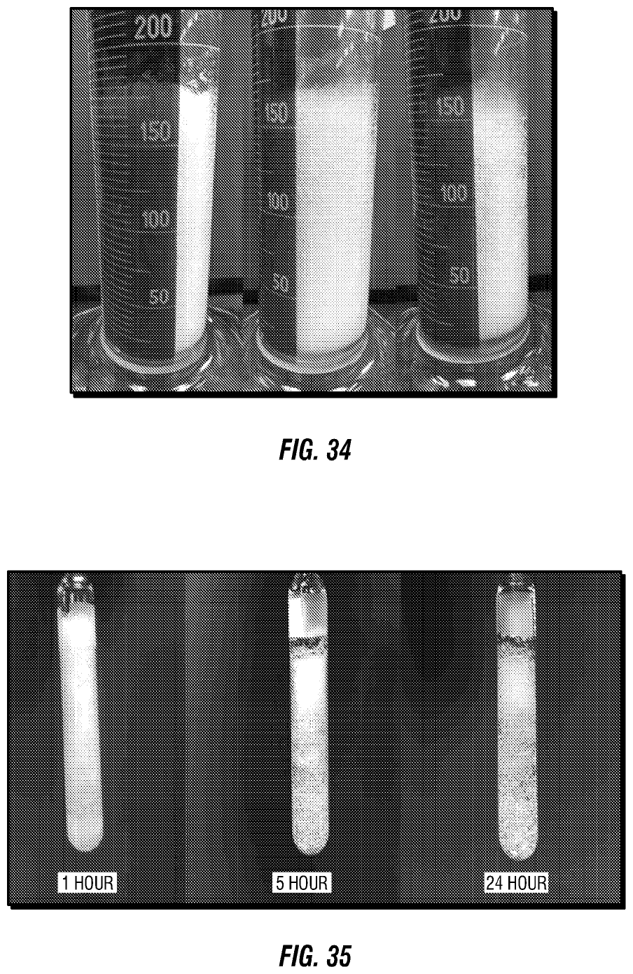

The effect of various crosslinkers (e.g., borate, zirconium borate, zirconium lactate, chromium acetate, chromium (III) propionate, titanium (III) chloride, delayed borate crosslinker, polyethyleneimine) on foam stability at 110° C. was tested. Initial foamed gels were formed by crosslinking the biopolymer with borate. As seen in FIG. 34, over 75% of the foam remains after 3 days when the foam is crosslinked at ambient conditions.

The effect of the various crosslinkers (borate, zirconium borate, zirconium lactate, chromium acetate, titanium (III) chloride) on foam stability at various temperatures (25° C., 65° C., 85° C., and 110° C.) were tested. The polymer and crosslinker were combined at a predetermined ratio (e.g., 25:1) and the mixture was sealed in an ampoule. The gel grades were then assessed at different times at the various temperatures. The gel grades used in these experiments were: A or 1—no detectible continuous gel formed, B or 2—highly flowing gel, C or 3—flowing gel, D or 4—moderately flowing gel, E or 5—barely flowing gel, F or 6—highly deformable non-flowing gel, G or 7—moderately deformable non-flowing gel, H or 8—slightly deformable non-flowing gel, and I or 9—rigid gel.

The gel strengths assessed ˜1 hour, 3 days, and 6 days after combining the polymer and crosslinker at a ratio of 25:1 are shown in Table 2, Table 3, and Table 4, respectively. The gel strengths after 3 days indicated that the titanium gel broke down over three days at 110° C.

TABLE 2
Gel strengths determined~1 hour after adding crosslinker.

| Crosslinker | 25° C. | 65° C. | 85° C. | 110° C. |
|---|---|---|---|---|
| Borate | G | G | A | A |
| Zirconium Borate | C | G | F | G |
| Zirconium Lactate | C | C | E | G |
| Chromium (III) Acetate | B | B | C | C |
| Titanium (III) chloride | B | H | H | H |

TABLE 3
Gel strengths determined 3 days after adding crosslinker.

| Crosslinker | 25° C. | 65° C. | 85° C. | 110° C. |
|---|---|---|---|---|
| Borate | G | G | A | A |
| Zirconium Borate | G | G | F | G |
| Zirconium Lactate | C | G | E | G |
| Chromium (III) Acetate | B | B | C | C |
| Titanium (III) chloride | B | H | H | A |

TABLE 4
Gel strengths determined 3 days after adding crosslinker.

| Crosslinker | 25° C. | 65° C. | 85° C. | 110° C. |
|---|---|---|---|---|
| Borate | G | G | A | A |
| Zirconium Borate | H | G | E | E |
| Zirconium Lactate | C | F | E | E |
| Chromium (III) Acetate | B | B | B | B |
| Titanium (III) chloride | C | H | H | A |

The zirconium borate and zirconium lactate crosslinkers resulted in barely flowing or non-flowing gels (ranking of E or above) at temperatures of 85° C. or more which remained stable for at least 6 days. Accordingly, these crosslinkers were selected for additional tests for formulations which also included surfactants. The order of addition for these tests was: surfactant, polymer, and brine were combined, then the reducing agent was added, and finally the crosslinker was added. The gel strengths after 1 hour and 1 day are summarized in Table 5 and Table 6, respectively.

TABLE 5
Gel strengths determined 1 hour after adding crosslinker

| Crosslinker | 25° C. | 65° C. | 85° C. | 110° C. |
|---|---|---|---|---|
| Zirconium borate (25:1) | B | C | D | E |
| Zirconium borate (25:1) + | B + foam | B | B + foam | C |
| surfactant | | | | |
| Zirconium borate (50:1) | B | B | B | B |
| Zirconium lactate (25:1) | C | C | G | F |
| Zirconium lactate (25:1) + | C | E + foam | G + foam | F + foam |
| surfactant | | | | |
| Zirconium lactate (50:1) | B | C | D | D |

TABLE 6
Gel strengths determined 1 day after adding crosslinker

| Crosslinker | 25° C. | 65° C. | 85° C. | 110° C. |
|---|---|---|---|---|
| Zirconium borate (25:1) | B | B | D | E |
| Zirconium borate (25:1) + | B | B | B | B |
| surfactant | | | | |
| Zirconium borate (50:1) | B | B | B | B |
| Zirconium lactate (25:1) | C | C | D | E |
| Zirconium lactate (25:1) + | D | C | G + foam | Half foam |
| surfactant | | | | |
| Zirconium lactate (50:1) | B | B | B | B |

The results in Table 5 and Table 6 indicated that zirconium lactate is better for crosslinking polymer and surfactant as a foam (for this particular combination of polymer and surfactants). Accordingly, additional tests were performed using zirconium lactate as the crosslinker in various weight ratios with the polymer and in the presence of various surfactants. The order of addition for these tests was: polymer and brine were combined, then the reducing agent was added, then the surfactant was added, and finally the crosslinker was added. The gel strength after 1 hour and 1 day are summarized in Table 7 and Table 8, respectively. Adding the reducing agent before the surfactant activated more binding sites, which resulted in an almost instantaneous crosslinked foam. Photographs of a crosslinked foam at 110° C. over time (from 1 hour to 24 hours) are shown in FIG. 35; a little bit of the foam stability was lost over time, but greater than 50% of the foam is still foamed at 24 hours.

TABLE 7
Gel strengths determined 1 hour after adding crosslinker

| Crosslinker | 25° C. | 65° C. | 85° C. | 110° C. |
|---|---|---|---|---|
| Zirconium lactate (30:1) + | E + foam | H + foam | E + foam | F + foam |
| surfactant 1 | | | | |
| Zirconium lactate (35:1) + | D + foam | I + foam | H + foam | G + foam |
| surfactant 1 | | | | |
| Zirconium lactate (40:1) + | F + foam | E + foam | G + foam | G + foam |
| surfactant 1 | | | | |
| Zirconium lactate (35:1) + | G + foam | H + foam | — | F + foam |
| surfactant 2 | | | | |
| Zirconium lactate (35:1) + | F + foam | H + foam | — | G + foam |
| surfactant 3 | | | | |
| Zirconium lactate (35:1) + | E + foam | H + foam | — | H + foam |
| surfactant 4 | | | | |

TABLE 8
Gel strengths determined 1 day after adding crosslinker

| Crosslinker | 25° C. | 65° C. | 85° C. | 110° C. |
|---|---|---|---|---|
| Zirconium lactate (30:1) + | F + foam | H + foam | E + foam* | E + foam* |
| surfactant 1 | | | | |
| Zirconium lactate (35:1) + | E | H + foam | G + foam* | F + foam* |
| surfactant 1 | barely | | | |
| | foamed | | | |
| Zirconium lactate (40:1) + | F + foam | H + foam | G + foam* | D + ½ |
| surfactant 1 | | | | foam* |
| Zirconium lactate (35:1) + | F + foam | G + foam | — | F + foam* |
| surfactant 2 | | | | |
| Zirconium lactate (35:1) + | G + foam | G + foam | — | F + foam* |
| surfactant 3 | | | | |
| Zirconium lactate (35:1) + | D | H + foam | — | G + foam* |
| surfactant 4 | no foam | | | |

*some syneresis

Further crosslinking tests were performed to delay crosslinking long enough to avoid a gel at ambient conditions while also crosslinking fast enough at an elevated temperature to have >50% foam after 24 hours.

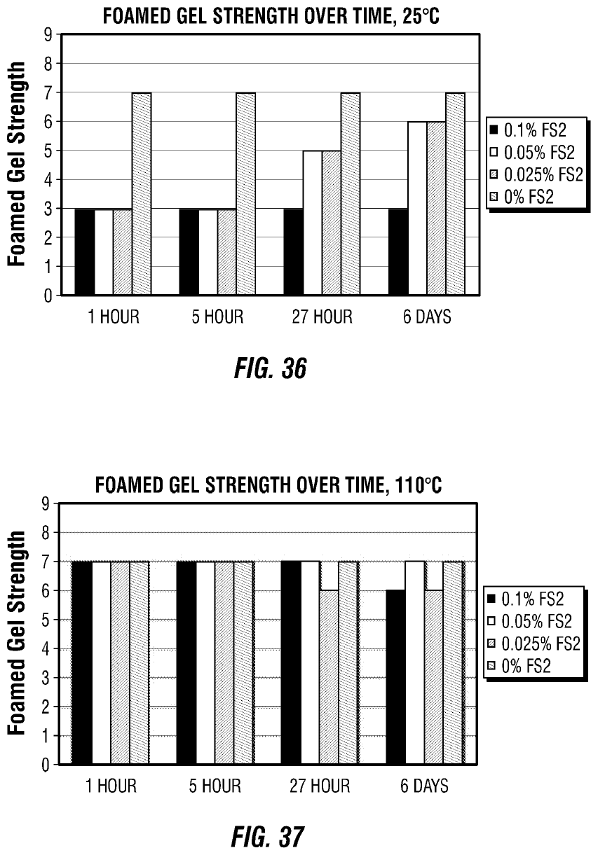

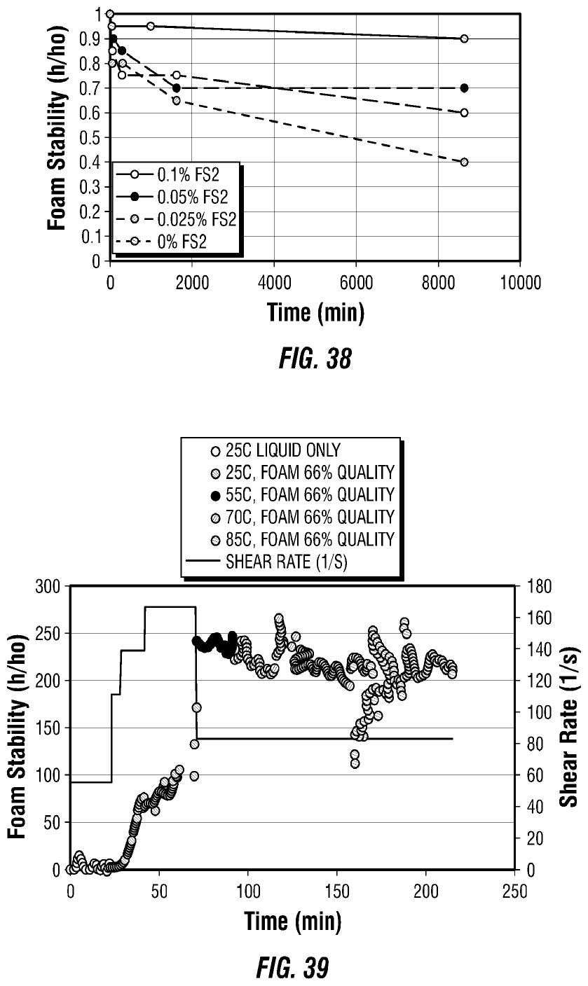

The foamed gel strength over time for crosslinked compositions including varying amount of fluorinated surfactant FS2 was tested at 25° C. (FIG. 36) and at 110° C. (FIG. 37). The stability of the foam for crosslinked compositions including varying amount of fluorinated surfactant FS2 at 110° C. as a function of time is shown in FIG. 38. As shown in FIG. 38, the fluorinated surfactant delays crosslinking.

Dynamic experiments and foam generation were performed on various aqueous foam formulations to assess their rheology. The foam viscosity was 2-8 times the polymer viscosity at high shear rates, depending on the quality of the foam (e.g., gas/liquid ratio).

Dynamic experiments were also performed on crosslinked foams to assess their rheology. The results indicated that the foam viscosity stayed between 200 and 250 cP when the temperature was increased (FIG. 39).

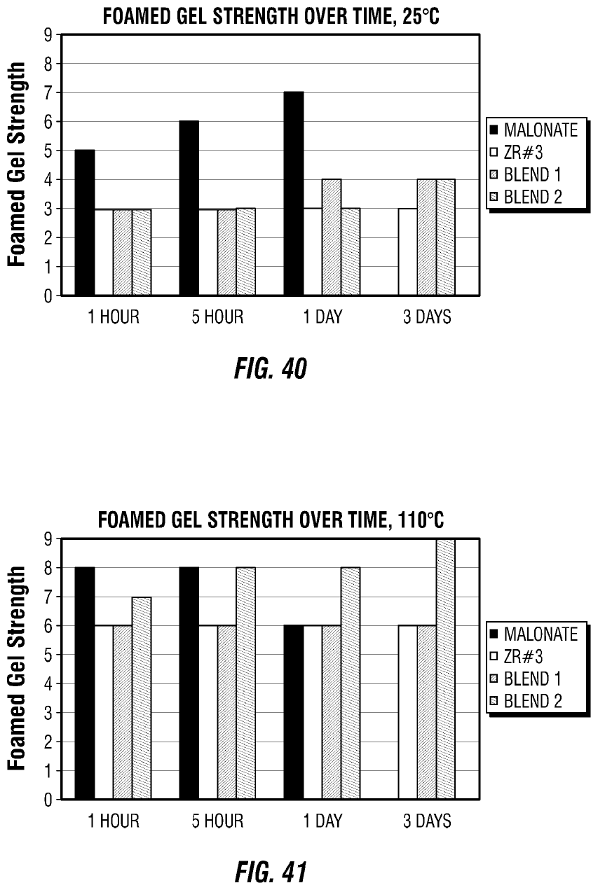

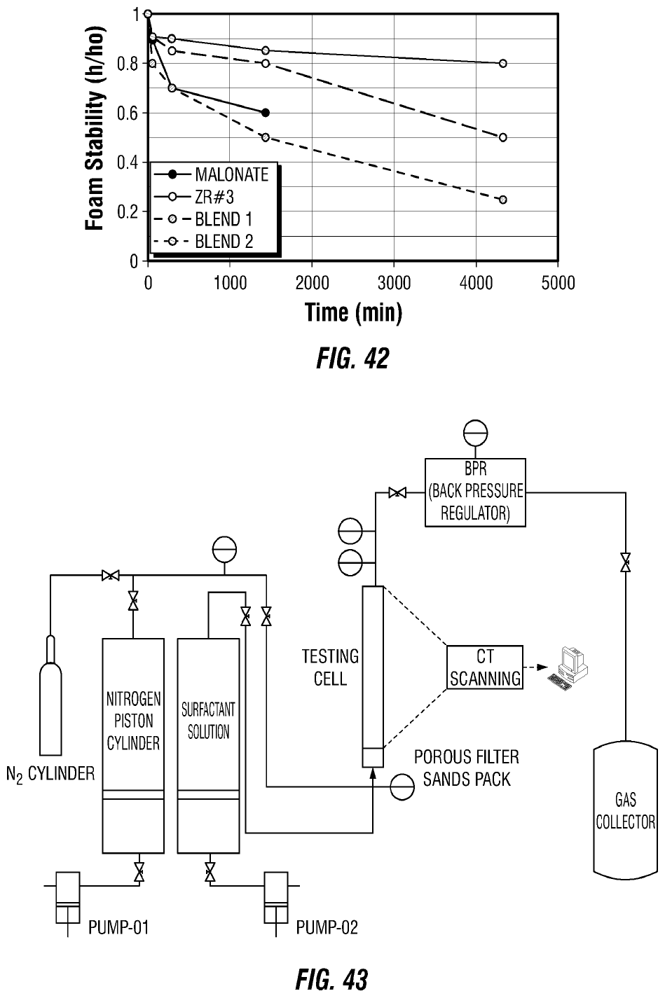

Formulations were prepared without fluorinated surfactants for static foam tests at 25° C.-110° C. The foamed gel strength over time for various formulations without fluorinated surfactants at 25° C. and at 110° C. are shown in FIG. 40 and FIG. 41, respectively. The foam stability over time for various formulations without fluorinated surfactants at 110° C. is shown in FIG. 42.

Additional tests to investigate foam stability over time were performed using CT scanning of the foam. A schematic of the experimental setup for the foam stability testing is shown in FIG. 43. The experimental setup includes an aluminum cell, with a length of 20 cm (14 inches) and a 2.54 cm×15 cm inner cross-section, one surfactant solution piston cylinder, one nitrogen gas cylinder, one water bath, and two pumps. The aluminum testing cell is installed vertically on the CT scanning bed, with a circulating hot water system attached to the outside of the cell to provide heating and control the target temperature.

The testing procedure involved preparing the desired surfactant solution and transferring 0.5 L or 1 L of the surfactant solution to the surfactant solution cylinder. The nitrogen piston cylinder was then pressurized to the desired operation pressure (e.g., 3500 psi; 24.1 MPa). A back pressure regulator (BPR) is installed at the top of the testing cell, which is used to maintain constant pressure in the testing cell while allowing excess gas to flow out to a downstream gas collector. The system was then pressurized to the desired pressure (e.g., 3500 psi) by nitrogen gas. The system, including the cylinders and testing cells, was then heated to the desired temperature (e.g., 85° C.). The foam was then generated through a 20 μm filter at various nitrogen/surfactant solution qualities (e.g., 40%, 60%, and 80% gas/liquid ratio). For example, 80% gas/liquid quality means to inject nitrogen gas:surfactant at a ratio of 4:1 (e.g., 200 mL/hr N2 injection rate and 50 mL/hr of surfactant injection rate). The two pumps were used to control constant flow rates and keep constant pressure in the system. The nitrogen gas and surfactant solution were injected until homogeneous and steady state foam is developed in the testing cell. Scout CT scanning was taken at a frequency of 5-10 minutes per scanning in this stage to determine when a steady state foam developed. Upon achieving the steady state foam, gas/liquid injection was stopped, and the foam was monitored by Scout CT scanning scans for 12 hours at a frequency of every 10 minutes for the first 2 hours and then every 20 minutes for the remaining time.

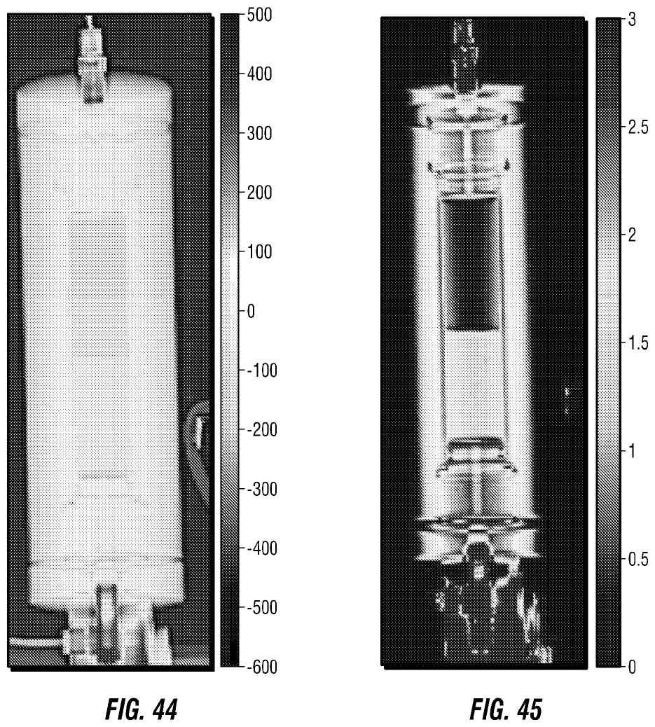

The foam stability was investigated by an X-ray computed tomography (CT) technique. CT measurements provide a measure of density of the system over different stages of foam development, steady state, and foam decay. There are two types of X-ray CT scanning: 1) Scout scanning, longitudinal 1D; and 2) Axial scanning (CAT, Computerized axial tomography), cross-sectional 2D. A CT image of the testing cell in CT number is shown in FIG. 44 while the corresponding density profile is shown in FIG. 45 for a surfactant/polymer solution and N2 at 3500 psi and ambient temperature. As shown in FIG. 44 and FIG. 45, the scout CT image has high enough resolution to distinguish gaseous phase, foam phase, and liquid phase.

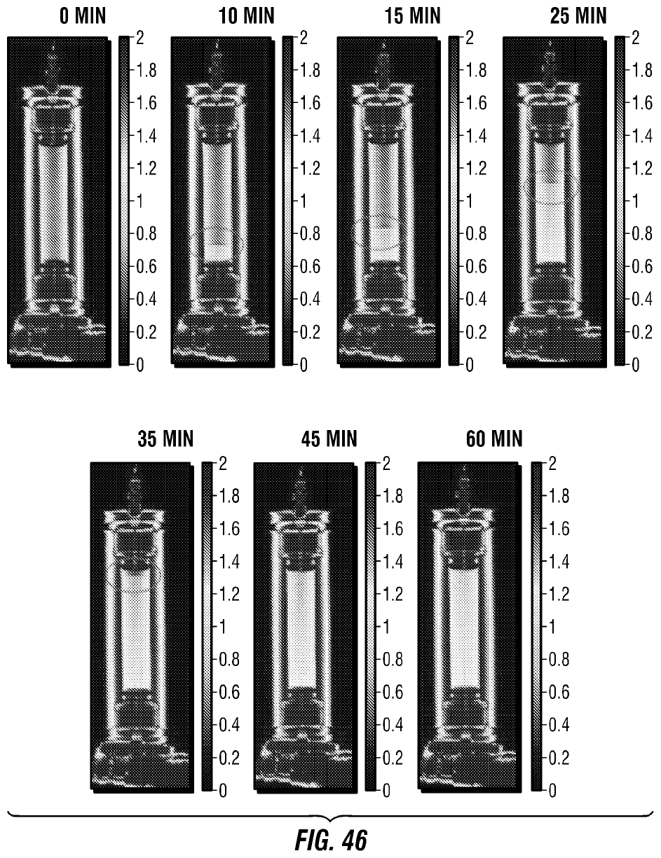

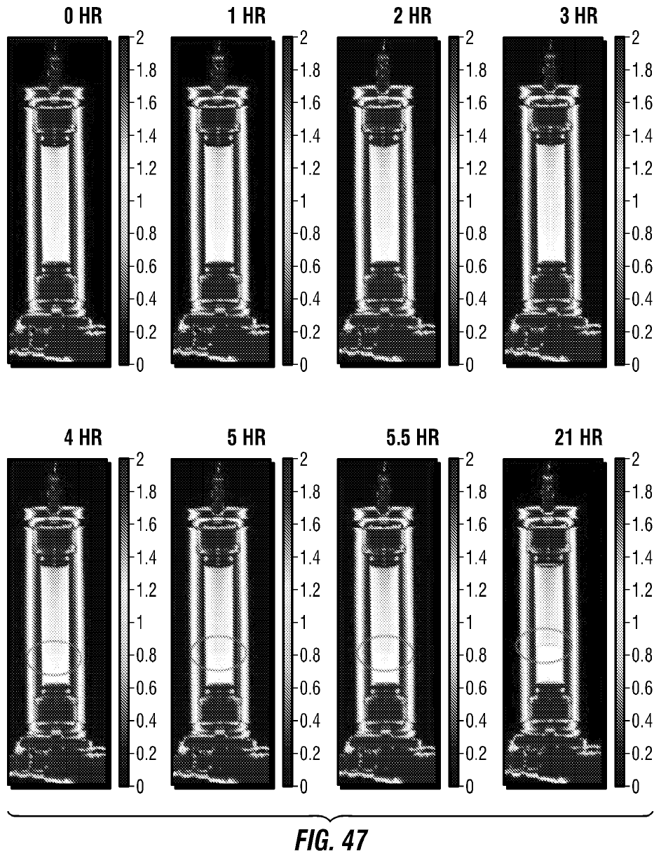

A 60% quality foam was generated as measured by Scout CT scanning at 3500 psi and ambient temperature (FIG. 46). The stability of the 60% quality foam was measured by Scout CT scanning at 3500 psi and ambient temperature (FIG. 47).

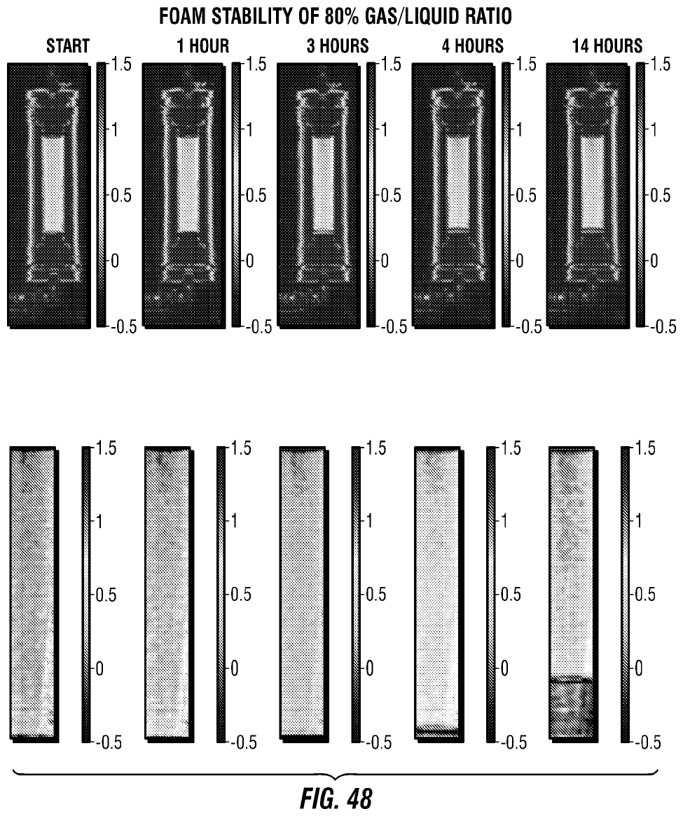

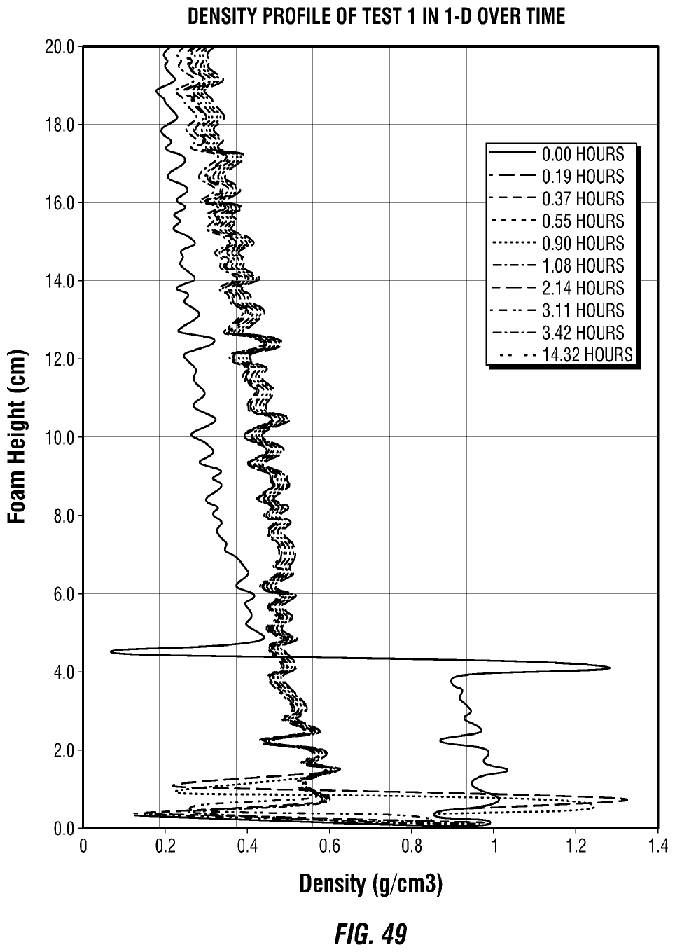

An 80% quality foam was generated at 85° C. and the stability of the foam was measured by Scout CT scanning (FIG. 48); lower panels being enlarged views of the sample window in the upper panels), with the corresponding density profile of the foam over time being shown in FIG. 49.

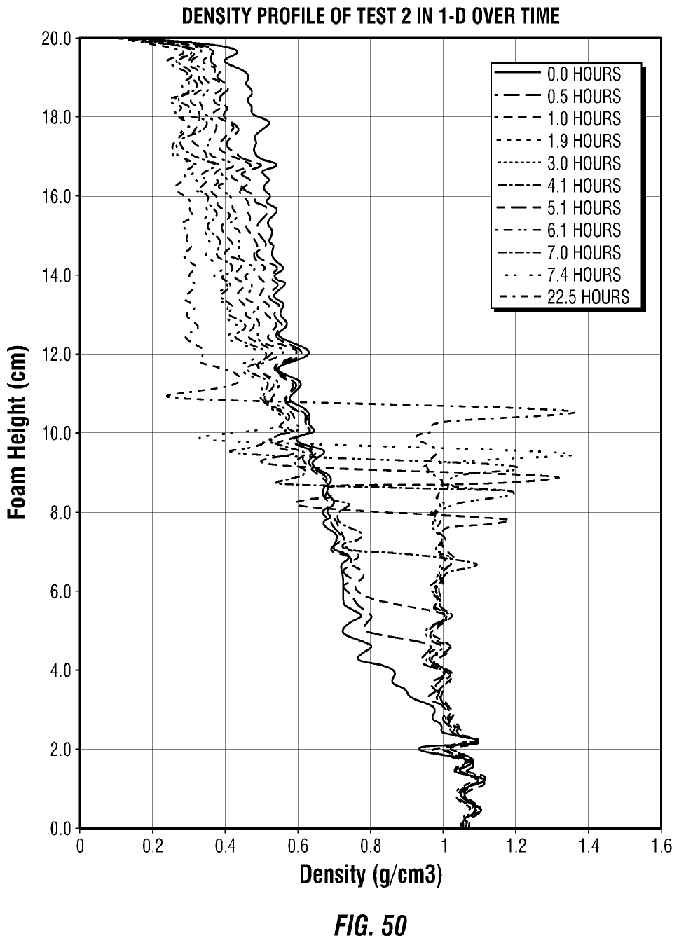

The density profile extracted from Scout CT scans for a foam with a 60% quality is shown in FIG. 50. The 60% quality foam (FIG. 50) was less stable than the 80% quality foam (FIG. 49).

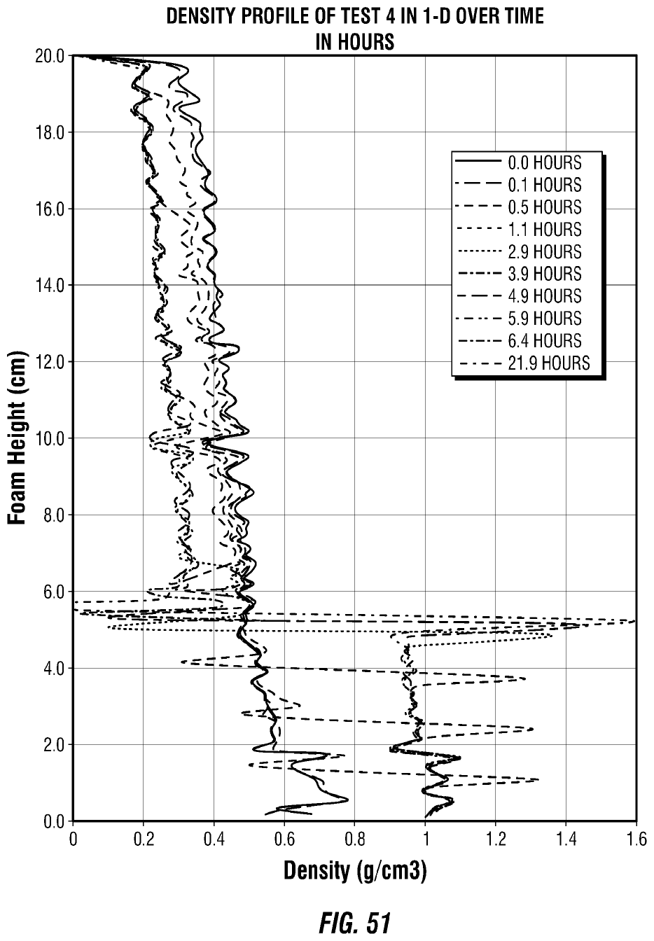

An 80% quality foam was generated and the stability of the foam was measured by Scout CT scanning at 120° C. The density profile extracted from Scout CT images for the foam with 80% quality at 120° C. is shown in FIG. 51. The 80% quality foam was less stable at 120° C. (FIG. 51) than at 85° C. (FIG. 49).

In summary, aqueous foam stability was tested at a range of temperatures (25-110° C.) and pressures (14.7-5000 psi). Aqueous foam stability was also tested using a variety of fluorinated surfactants. The results of the experiments indicated that aqueous foam stability was improved using a fluorinated surfactant. Dynamic experiments and foam generation were performed on various aqueous foam formulations. Crosslinking was used to boost foam stability at 110° C. from half a day to 3+ days. Dynamic experiments were performed on crosslinked foams. Base case foam density measurements at 85° C. and 120° C. with no fluorinated surfactants or crosslinking were completed. Formulations were prepared without fluorinated surfactants for static foam tests at 25° C.-110° C.

### Example 5

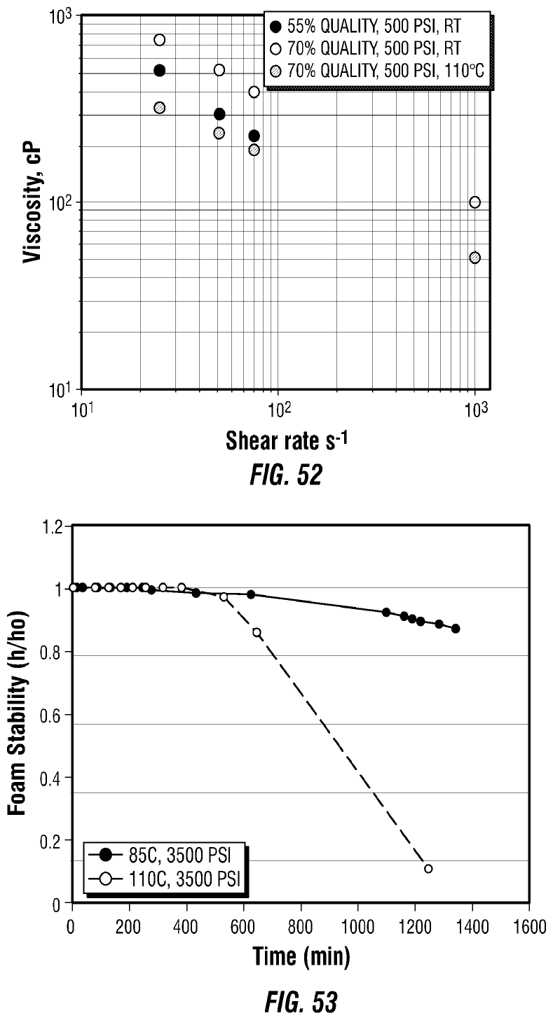

The rheology of aqueous foam formulations comprising surfactants, biopolymer, and a fluorinated surfactant were tested using a customized Chandler foam rheometer. The viscosity of a formulation at various foam qualities at room temperature and at 120° C., 500 psi as a function of time and shear rate was tested. The viscosity of a formulation at various foam qualities at a shear rate of 100 s⁻¹ and 500 psi as a function of time and temperature was also tested. The viscosity of two different formulations with different surfactants as a function of time at room temperature and 500 psi was also tested. The viscosity of a foam formulation of various qualities at 500 psi and various temperatures as a function of shear rate is shown in FIG. 52.

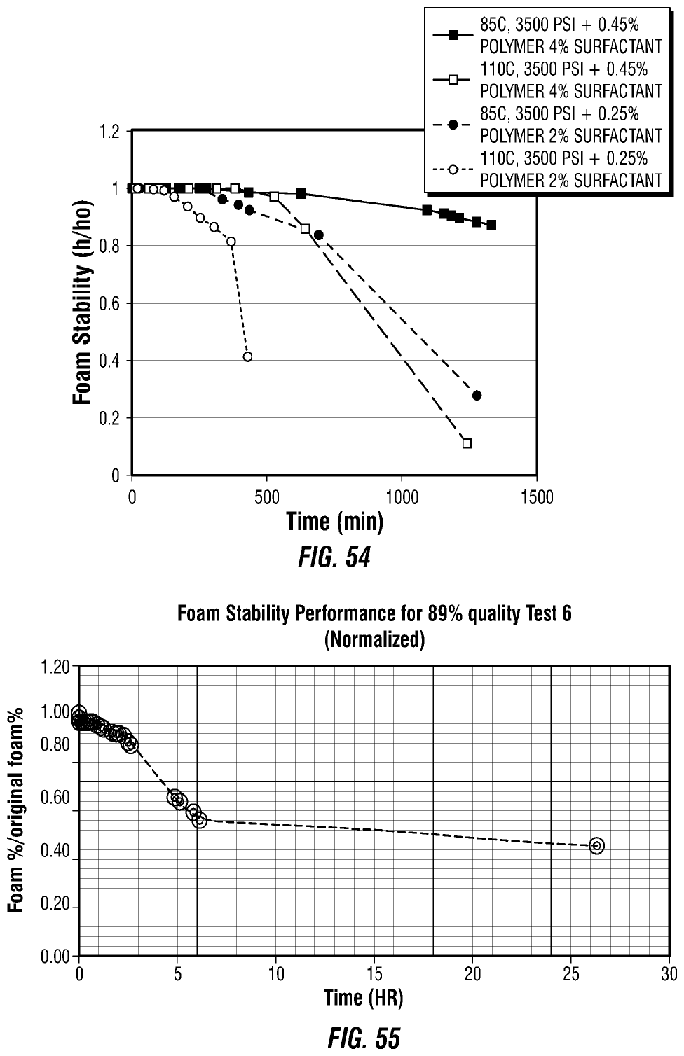

The stability of various aqueous foam formulations were also tested using Foam Stability Test Method 2. The foam stability measured using Foam Stability Test Method 2 for a formulation including a fluorinated surfactant and biopolymer at various temperatures and 3500 psi as a function of time is shown in FIG. 53. The foam stability measured using Foam Stability Test Method 2 for two different formulations at two different temperatures and 3500 psi as function of time is shown in FIG. 54.

The foam stability of various aqueous foam formulations were also tested using CT scanning according to the following method.

A schematic of the experimental setup for the foam stability testing is shown in FIG. 43. The experimental setup includes an aluminum cell, with a length of 20 cm (14 inches) and a 2.54 cm×15 cm inner cross-section, one surfactant solution piston cylinder, one nitrogen gas cylinder, one water bath, and two pumps. The aluminum testing cell is installed vertically on the CT scanning bed, with a circulating hot water system attached to the outside of the cell to provide heating and control the target temperature.

The testing procedure involved preparing the desired surfactant solution and transferring 0.5 L or 1 L of the surfactant solution to the surfactant solution cylinder. The nitrogen piston cylinder was then pressurized to the desired operation pressure (e.g., 3500 psi; 24.1 MPa). A back pressure regulator (BPR) is installed at the top of the testing cell, which is used to maintain constant pressure in the testing cell while allowing excess gas to flow out to a downstream gas collector. The system was then pressurized to the desired pressure (e.g., 3500 psi) by nitrogen gas. The system, including the cylinders and testing cells, was then heated to the desired temperature (e.g., 85° C.). The foam was then generated through a 20 μm filter at various nitrogen/surfactant solution qualities (e.g., 40%, 60%, and 80% gas/liquid ratio). For example, 80% gas/liquid quality means to inject nitrogen gas: surfactant at a ratio of 4:1 (e.g., 200 mL/hr N2 injection rate and 50 mL/hr of surfactant injection rate). The two pumps were used to control constant flow rates and keep constant pressure in the system. The nitrogen gas and surfactant solution were injected until homogeneous and steady state foam is developed in the testing cell. Scout CT scanning was taken at a frequency of 5-10 minutes per scanning in this stage to determine when a steady state foam developed. Upon achieving the steady state foam, gas/liquid injection was stopped, and the foam was monitored by Scout CT scanning scans for 12 hours at a frequency of every 10 minutes for the first 2 hours and then every 20 minutes for the remaining time. The foam stability was investigated by an X-ray computed tomography (CT) technique. CT measurements provide a measure of density of the system over different stages of foam development, steady state, and foam decay.

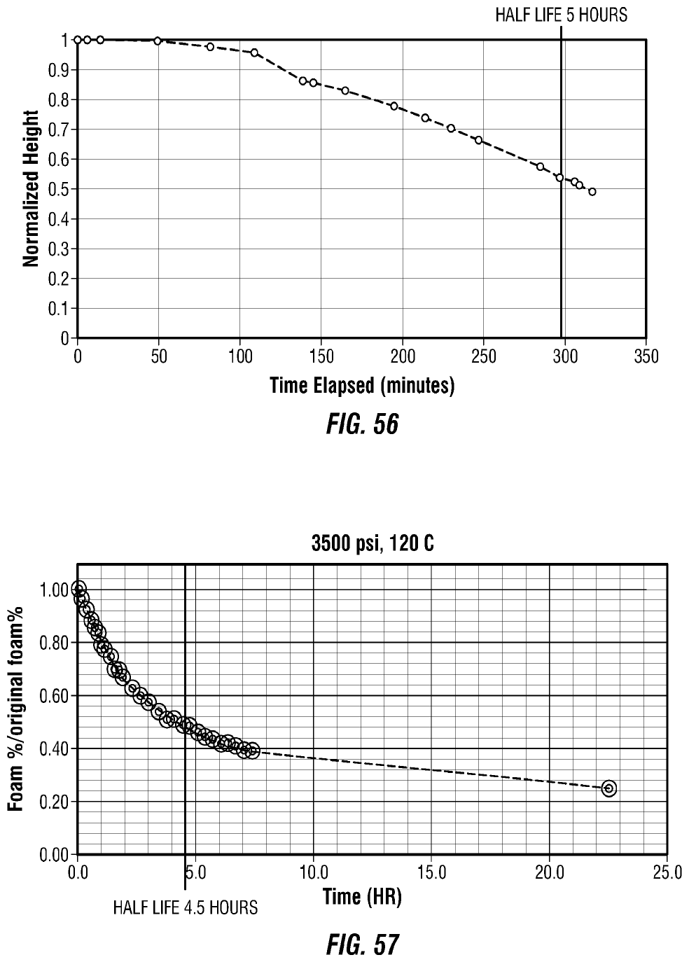

The foam stability of an 80% quality foam at 120° C. and 3500 psi measured using the CT scanning method is shown in FIG. 55. The foam stability of a 67% quality foam measured using Foam Stability Test Method 2 at 3500 psi and 110° C. is shown in FIG. 56; the results indicated the foam had a half-life of 5 hours. The foam stability of a 60% quality foam measured using the CT scanning method at 3500 psi and 110° C. is shown in FIG. 57; the results indicated the foam had a half-life of 4.5 hours. The results in FIG. 56 and FIG. 57 indicate that Foam Stability Test Method 2 and the CT scanning method provide comparable results for foam stability.

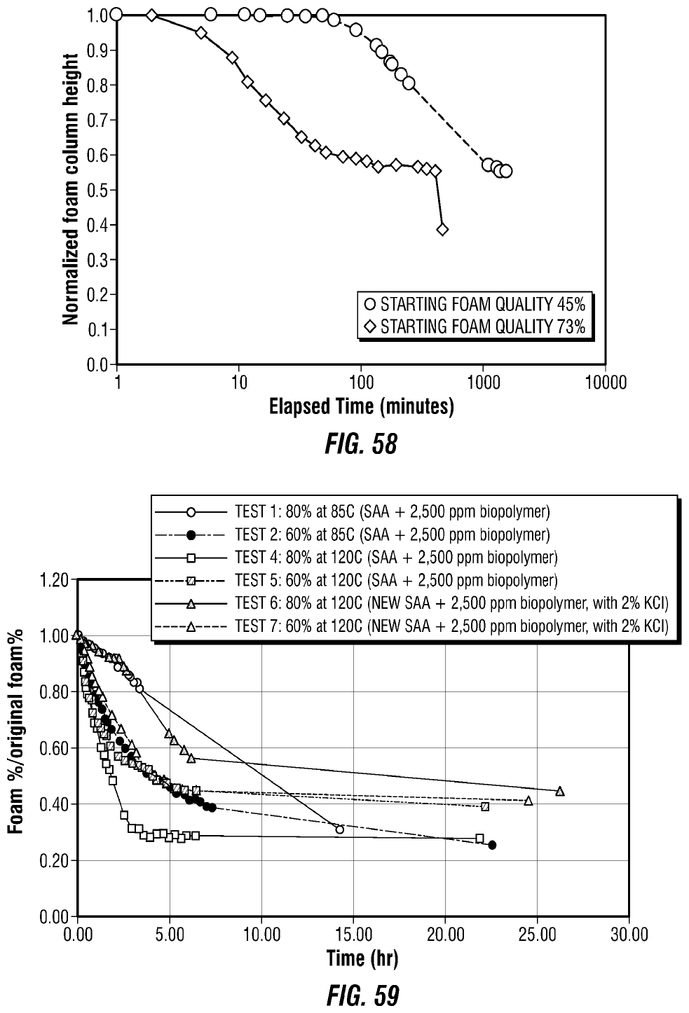

In addition, a decrease in half-life would be expected from increasing the temperature from 110° C. to 120° C. Suggesting including a foam stabilizer (e.g., a crosslinker) to stabilize the foams for operations at temperatures greater than 100° C. The effect of foam quality on foam stability as a function of time is shown in FIG. 58 and FIG. 59.

### Example 6

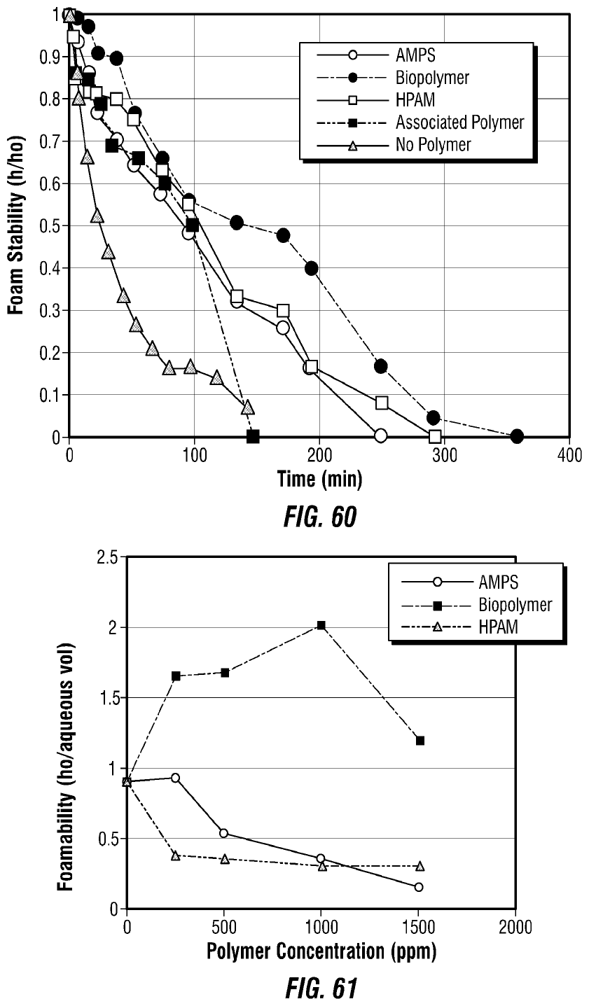

Bottle foam stability tests were performed with 0.5% anionic surfactant (e.g., an IOS) and 0.5% nonionic surfactant SA (both stable in the presence of H₂S as determined above) in brine with 1500 ppm of varying polymer: AMPS, biopolymer, HPAM, and an associative polymer (AP). Tests measured foamability, which is the initial height formed normalized by the aqueous volume in the tube, and decay of foam over time, which is foam height normalized by initial foam height. The tubes were placed in a 167° F. (75° C.) oven, The foamability results are summarized in Table 9 and the foam stability results are shown in FIG. 60. The addition of all polymers increases foam stability, while only the biopolymer increased the foamability.

TABLE 9
Foamability of formulations including different polymers.

| Polymer | Foamability |
|---|---|
| No polymer | 0.905 |
| AMPS | 0.155 |
| Biopolymer | 1.2 |
| HPAM | 0.3 |
| AP | 0.695 |

Foamability, initial foam height normalized by aqueous volume, was measured as a function of polymer concentration for formulations including either HPAM, AMPS, or biopolymer and the results are shown in FIG. 61. For each concentration the biopolymer was the only polymer to have a foamability greater than 1. The biopolymer had more than double the foamability of HPAM and AMPS for almost all polymer concentrations. Without any polymer added, the foamability of this surfactant solution at 167° F. was less than 1. Adding 250 ppm, 500 ppm, 1000 ppm, and 1500 ppm of biopolymer increased foamability of the surfactant solution.

The compositions and methods of the appended claims are not limited in scope by the specific compositions and methods described herein, which are intended as illustrations of a few aspects of the claims and any compositions and methods that are functionally equivalent are within the scope of this disclosure. Various modifications of the compositions and methods in addition to those shown and described herein are intended to fall within the scope of the appended claims. Further, while only certain representative compositions and methods, and aspects of these compositions and methods are specifically described, other compositions and methods and any combinations of various features of the compositions and methods are intended to fall within the scope of the appended claims, even if not specifically recited. Thus, a combination of steps, elements, components, or constituents can be explicitly mentioned herein; however, all other combinations of steps, elements, components, and constituents are included, even though not explicitly stated.

### Example 7: Foam Stability Measurements Using Chandler Engineering Foam Rheometer and High-Pressure View Cell

A Chandler Engineering Foam rheometer was used to evaluate foam stability. This was done by taking pictures of foam bubbles versus time and qualitatively assessing bubble texture (size). If a foam was present in the Foam Rheometer View Cell at a specified time, the foam was deemed stable at the time the picture was taken. Using this method, several foam formulations were compared to the foam including: a primary foaming surfactant, a viscosity modifying polymer, a foam stabilizer, and water.

A Chandler Engineering foam rheometer was used to evaluate the stability of different foam formulations. Foams are generated and trapped in a view cell and bubble size is monitored versus time. Foams that are stable have foam in the view cell.

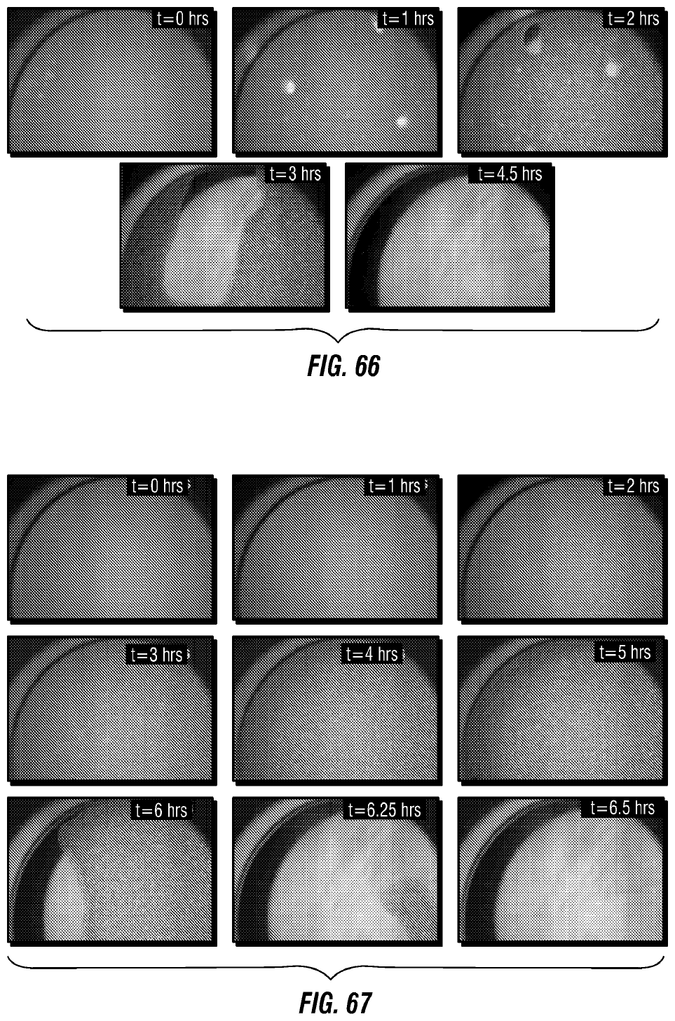

FIG. 66 and FIG. 67 show foam formulations that include a primary foaming surfactant (only). The foams were tested at 3,600 psi and 116° C. The samples were 80% volume by gas. The foam in Figure showed signs of degrading after 3 hours and was completely destabilized after 4.25 hours whereas the foam in FIG. 67 began to degrade at 6 hours and was completely destabilized after 6.5 hours.

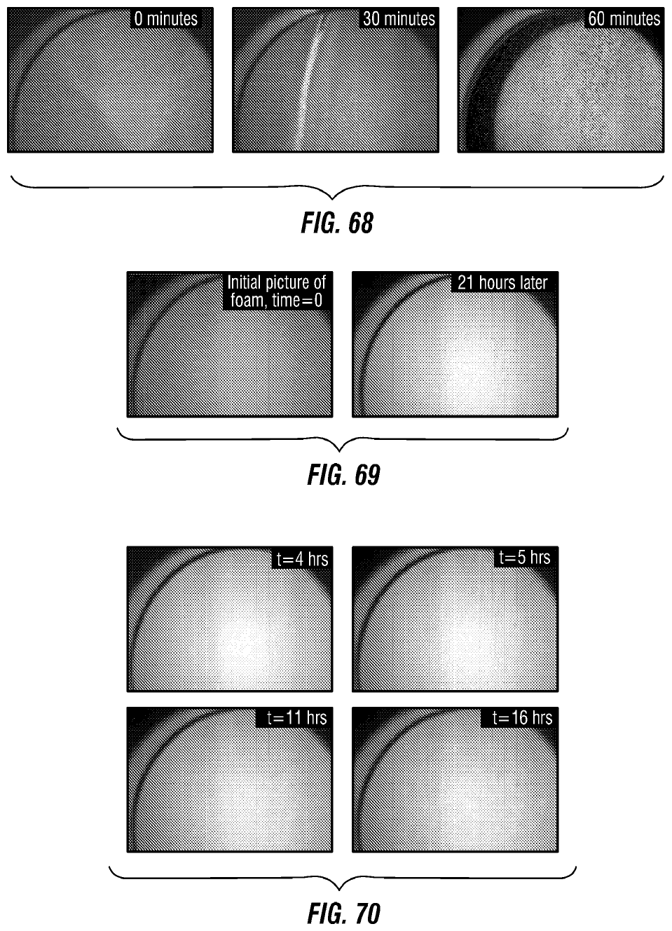

FIG. 68 shows a foam that includes a surfactant package (primary surfactant and stabilizer) and a viscosifying agent (biopolymer). The foam was tested at 2,500 psi and 60° C. The foam had 30% gas by volume and the foam destabilized after 60 minutes.

FIG. 69 and FIG. 70 show foams that are stabilized with a surfactant package (primary foaming surfactant and stabilizer) and a viscosifying polymer (biopolymer). The foam in FIG. 69 was tested at 2,500 psi and 85° C. The foam was 55% gas by volume. After inspection of the initial foam and the foam after 21 hours, the foam showed little degradation at the tested conditions.

The foam in FIG. 70 was tested at 3,600 psi and 120° C. The foam was 55% gas by volume. The foam was monitored for 16 hours total. The images show that after 16 hours of monitoring, the foam remained stable at the tested conditions.

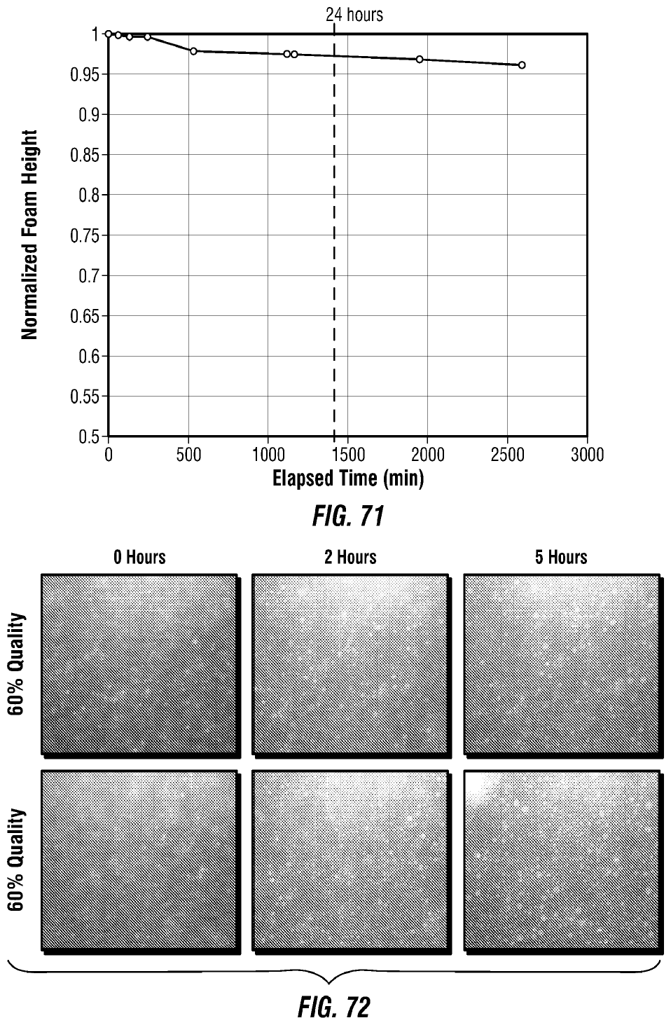

FIG. 71 includes data from a high-pressure foam half-life test. Foam half-life is an indication of foam stability. Foam half-life can be measured at ambient conditions or at elevated temperature and pressure. Typically, a foam is placed in a vessel with known volume and is then monitored for some period of time. When half of the foam column decays, the time is recorded, and this is defined as foam half-life.

FIG. 71 shows results from a foam half-life test that was done at 1,900 psi and 140° F. The foam was made using a surfactant package (primary foaming surfactant and foam stabilizer) and a viscosifying polymer (biopolymer). The foam was 55% gas by volume. FIG. 71 plots normalized foam height versus time. After 24 hours of monitoring (green dashed vertical line) there was approximately a reduction in the foam column by 3%.

Pilot scale testing of foam: A general description of the facility is provided (below) in the section titled “Description of Test Facility.” Data included from pilot scale testing was on foam stability using a 6″×4″ test article and on bubble texture versus time (foam stability).

FIG. 72 shows foam texture versus time. The foam was generated at pilot scale. The foam was made using surfactant package (primary foaming surfactant and foam stabilizerf) and 1.5 wt % viscosifying polymer (biopolymer). The test conditions were 2,500 psi and 180° F. The gas fraction in the foams was either 60% or 70%. The results from the images show little change in foam bubble size with time.

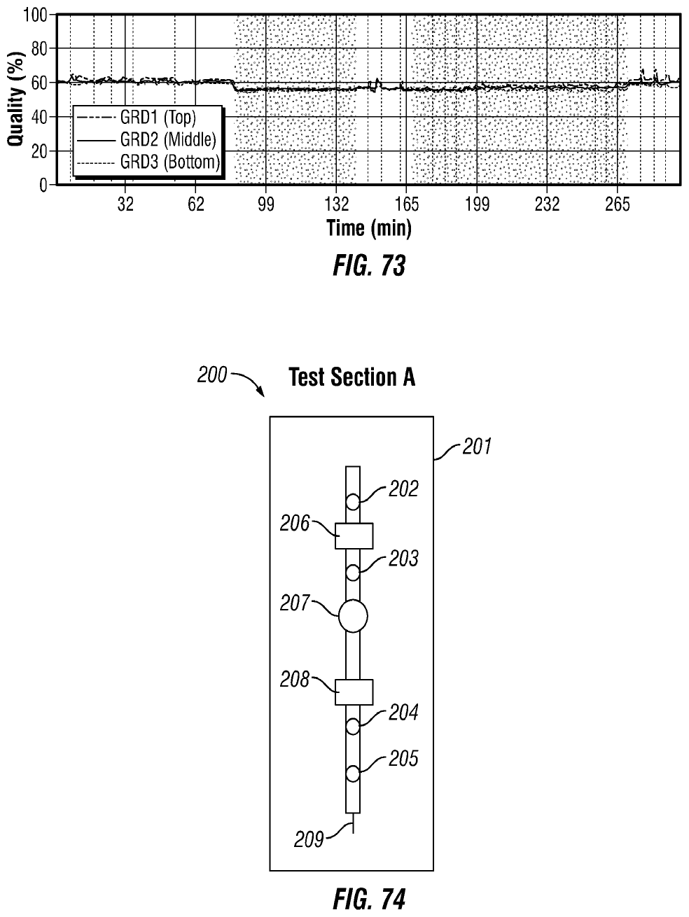

FIG. 73 shows large scale foam stability versus time. Foam was trapped in a 10 ft pipe with dimensions 6″ outer pipe and 4″ inner pipe. The foam was in the pipe for over 265 minutes. White regions in the plot indicate when the foam was ‘static’, and the shaded regions indicate when the 4″ inner pipe was rotated. The test conditions were 2,500 psi and 180° F. The foam was stabilized with a surfactant package (primary foaming surfactant and foam stabilizer) and a viscosifying polymer. The gas fraction of the foam was 60%. During the test, the foam showed little change in stability which is measured by the change in foam quality with time. The foam quality was within ˜5% during the test.

Description of test facility: A pilot flow test facility (PFTF) was used to generate, test, and evaluate the rheological properties of natural gas-based foams was modified to aqueous based foams at operating conditions (pressure, temperature, flow rates, etc.). This facility included functionality to characterize foam formulations at field conditions. It also included two simulated wellbore test sections that enabled measurement of bubble rise velocity in a column of foam. The mechanism for foam generation was expected to be a main area of experimentation during the test plan. Therefore, it was modified several times throughout the testing program. The liquid source and gas source meet at a configurable foam generation area. The piping at the facility can be adjusted with a variety of nozzles, sand packs, and orifices in order to generate foams using varying foam generation methods.

A total of three test sections were used to measure bubble rise velocity through the foam. The test sections were named the “testing apparatus,” the “test section B,” and the “test section C.” The test section A had a 3-inch diameter with no inner pipe. The test section B had a 6-inch outer diameter and a 4-inch annular pipe. The test section C had a 6-inch outer diameter and no inner pipe. Test sections B and C rotate.

FIG. 74 shows the test section A (200) as configured for the current foam research. The test section was equipped with a full-bore sight glass (207) to provide a visual indication of gas migration and gas sweeping efficiency. The test section mounted on an inclinable frame (201) was capable of changing the inclination from vertical (0°) to 45° from vertical. Due to limitations on the rotating pipe seals, the steepest inclination for the annular section with eccentric rotating pipe was determined during the tests. Nevertheless, it was anticipated that this type of test section can be inclined up to 30° from vertical.

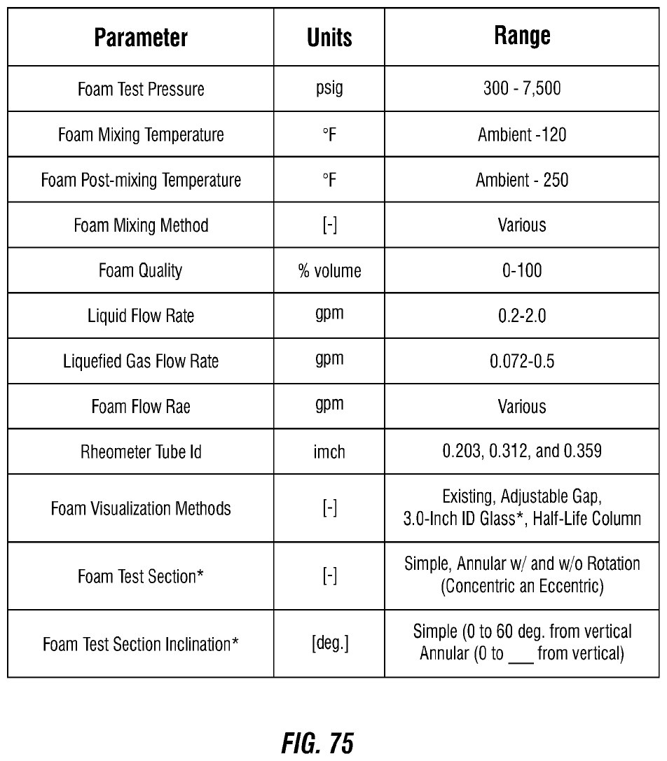

The PFTF was capable of operating over a range of pressures, temperatures, and multiphase flow rates, as indicated in FIG. 75. Although the PFTF was capable of varying the foam qualities over the entire range, the experiments were performed with foam quality in the range of 20% to 90%. Pressure transmissibility through the foam is also a parameter of interest. Therefore, the PFTF was modified to include a gas pressure pulse generator near the end of the single-pass system. This gas pressure pulse was used for the foam characterization process to measure the rate of pressure transmission through the foam in the PFTF under flowing and static conditions.

The compositions and methods of the appended claims are not limited in scope by the specific compositions and methods described herein, which are intended as illustrations of a few aspects of the claims. Any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

What is claimed is:

1. An aqueous foam precursor composition comprising:
(a) a primary foaming surfactant, wherein when measured according to Hydrogen Sulfide Stability Test Method 1, less than 20 mol % of the primary foaming surfactant degrades after aging for 7 days at 120° C. in the presence of 17% H₂S,
(b) a viscosity-modifying polymer; and
(c) water.

2. The composition of claim 1, wherein the composition further comprises a foam stabilizer.

3. An aqueous foam precursor composition comprising:
(a) a primary foaming surfactant;
(b) a viscosity-modifying polymer;
(e) a foam stabilizer; and
(d) water;
wherein the aqueous foam precursor composition forms an aqueous based foam that exhibits a foam half-life of at least 12 hours, when foamed and measured using Foam Stability Test Method 1.

4. The composition of any of claims 1-3, wherein the aqueous foam precursor composition forms an aqueous based foam that exhibits a foam half-life of at least 12 hours, when foamed and measured using Foam Stability Test Method 2 at a pressure of 1500 psi and a temperature of 85° C.

5. The composition of any of claims 1-3, wherein the aqueous foam precursor composition forms an aqueous based foam that exhibits a foam half-life of at least 12 hours, when foamed and measured using Foam Stability Test Method 2 at a pressure of 1500 psi and a temperature of 85° C. in the presence of 17 mol % H₂S.

6. The composition of any of claims 1-5, wherein the aqueous foam precursor composition comprises at least 50% by weight water, based on the total weight of the aqueous foam precursor composition.

7. The composition of any of claims 3-6, wherein when measured according to Hydrogen Sulfide Stability Test Method 1, less than 20 mol % of the primary foaming surfactant degrades after aging for 7 days at 120° C. in the presence of 17% H₂S;
optionally the primary foaming surfactant is a water-soluble surfactant, optionally wherein the primary foaming surfactant comprises an anionic surfactant selected from an olefin sulfonate, an alcohol ethoxycarboxylate, a disulfonate, an alkylbenzene sulfonate, or any combination thereof,
optionally wherein the primary foaming surfactant comprises a non-ionic surfactant comprising an ethoxylated alcohol, optionally wherein the primary foaming surfactant is present in an amount of from 0.01% to 10% by weight, based on the total weight of the aqueous foam precursor composition.

8. The composition of any of claims 1-7, wherein the composition further comprises one or more co-surfactants;
optionally wherein when measured according to Hydrogen Sulfide Stability Test Method 1, less than 20 mol % of the one or more co-surfactants degrade after aging for 7 days at 120° C. in the presence of 17% H₂S;
optionally wherein the one or more co-surfactants are each water-soluble surfactants;
optionally wherein the one or more co-surfactants comprise one or more anionic surfactants selected from an olefin sulfonate, an alcohol ethoxycarboxylate, a disulfonate, an alkylbenzene sulfonate, or any combination thereof; or one or more non-ionic surfactants such as an ethoxylated alcohol; or any combination thereof; and/or
optionally wherein the one or more co-surfactants are present in an amount of from 0.01% to 10% by weight, based on the total weight of the aqueous foam precursor composition.

9. The composition of any of claims 2-8, wherein the foam stabilizer is selected from a fluorosurfactant, a crosslinker, a particulate stabilizer, or any combination thereof.

10. The composition of claim 9, wherein the foam stabilizer comprises a fluorosurfactant, optionally wherein the fluorosurfactant is present in an amount of from 0.01% to 10% by weight, based on the total weight of the aqueous foam precursor composition.

11. The composition of any of claims 9-10, wherein the foam stabilizer comprises a crosslinker selected from a borate crosslinking agent, a Zr crosslinking agent, a Ti crosslinking agent, an Al crosslinking agent, an organic crosslinker (e.g., malonate, polyethyleneimine), or any combination thereof.

12. The composition of claim 11, wherein the viscosity-modifying polymer and the crosslinker are present in a weight ratio of from 10:1 to 100:1.

13. The composition of any of claims 9-12, wherein the foam stabilizer is present in an amount of from 0.01% to 10% by weight, based on the total weight of the aqueous foam precursor composition.

14. The composition of any of claims 1-13, wherein the viscosity-modifying polymer is stable at 120° C. in the presence of H₂S, as measured by Hydrogen Sulfide Stability Test Method 1.

15. The composition of any of claims 1-14, wherein the viscosity-modifying polymer comprises a biopolymer, optionally wherein the viscosity-modifying polymer comprises a triple-helix forming biopolymer, a polysaccharide, or any combination thereof;
optionally wherein the viscosity-modifying polymer is selected from xanthan, guar, a scleroglucan, a schizophyllan, hydroxyethyl cellulose (HEC), or any combination thereof; and/or
optionally wherein the viscosity-modifying polymer is present in an amount of from 0.01% to 3% by weight, based on the total weight of the aqueous foam precursor composition.

16. An aqueous based foam comprising the aqueous foam precursor composition of any of claims 1-15 and an expansion gas;
optionally wherein the expansion gas comprises nitrogen, natural gas or a hydrocarbon component thereof, helium, CO₂, air, or any combination thereof; and/or
optionally wherein the foam exhibits a density of from 2 lbs/gal to 8 lbs/gal.

17. A method of making the aqueous based foam of claim 16, the method comprising:
contacting the aqueous foam precursor with the expansion gas, injecting the expansion gas into the aqueous foam precursor, or any combination thereof, thereby forming the aqueous based foam.

18. A method for forming a wellbore within a formation, the method comprising:
drilling the wellbore by injecting an aqueous drilling fluid through a tubular string disposed in the wellbore, the tubular string comprising a drill bit disposed on a bottom thereof, wherein the drilling fluid exits the drill bit, and
introducing an aqueous based foam into at least a portion of an annulus defined by an outer surface of the tubular string and an inner surface of the wellbore or a casing lining the wellbore.

19. The method of claim 18, wherein the method further comprises generating the aqueous based foam above ground and injecting the aqueous based foam into the annulus.

20. The method of claim 18, wherein the method further comprises generating the aqueous based foam within the annulus.

21. The method of any of claims 19-20, wherein generating the aqueous based foam comprises:
contacting the aqueous foam precursor with the expansion gas, injecting the expansion gas into the aqueous foam precursor, or any combination thereof, thereby forming the aqueous based foam.

22. The method of any one of claims 18-21, wherein the aqueous based foam comprises an aqueous based foam defined by claim 16.

23. The method of any one of claims 18-22, wherein the formation comprises a carbonate formation.

24. The method of any one of claims 18-23, wherein the formation comprises hydrocarbons and H₂S, and wherein the H₂S is present in an amount of from 0.5 mol % to 25 mol %, from 0.5 mol % to 20 mol %, 5 mol % to 25 mol %, 15 mol % to 25 mol %, or 17 mol % to 25 mol %.

25. The method of any one of claims 18-24, wherein the formation has an in-situ temperature of from 100° C. to 150° C.

26. The method of any one of claims 18-25, wherein the method further comprises injecting an aqueous based foam through a tubular string.

27. The method of any of claim 17, or 21-26, wherein contacting the aqueous foam precursor with the expansion gas the contacting step comprises shearing the aqueous foam precursor in the presence of the expansion gas.
